(19) United States
(12) Patent Application Publication
(10) Pub. No.: US 2024/0040461 A1
(43) Pub. Date: Feb. 1, 2024

(54) UE, NETWORK NODE AND METHODS FOR HANDLING MOBILITY INFORMATION IN A COMMUNICATIONS NETWORK

(71) Applicant: Telefonaktiebolaget LM Ericsson (publ), Stockholm (SE)

(72) Inventors: Icaro L. J. DA SILVA, Solna (SE); Victor Farias MONTEIRO, Fortaleza (BR)

(21) Appl. No.: 18/003,810

(22) PCT Filed: Jul. 3, 2020
(86) PCT No.: PCT/SE2020/050709

§ 371 Date: Dec. 29, 2022

(51) Int. Cl. H04W 36/30; H04W 36/00

(52) U.S. Cl. CPC H04W 36/30; H04W 36/0058

(57) ABSTRACT

The present disclosure relates to a method performed by a UE for handling mobility information in a communications network. The UE predicts mobility information related to the UE's predicted mobility in the communications network. The UE determines whether one or multiple conditions are fulfilled for one or multiple cells. At least part of the predicted mobility information is used as input to the one or multiple conditions. The UE transmits a message to a network node when it has been determined that the one or multiple conditions are fulfilled.

### TECHNICAL FIELD

The present disclosure relate generally to a User Equipment (UE), a method performed by the UE, a network node and a method performed by the network node. The present disclosure relate to handling mobility information in a communications network.

### BACKGROUND

Mobility in RRC_CONNECTED in LTE and NR

In Long Term Evolution (LTE) and New Radio (NR), an RRC_CONNECTED UE may be configured by the network to perform measurements and, upon triggering measurement reports the network may send a HandOver (HO) command to the UE. RRC is short for Radio Resource Control. In LTE, the HO command is an RRConnectionReconfiguration with a field called mobilityControlInfo In NR, the HO command is an RRCReconfiguration with a reconfigurationWithSync field.

These reconfigurations are prepared by the target cell upon a request from the source node, and over the X2 interface in case of EUTRA-EPC or the Xn interface in case of EUTRA-5GC or NR. These reconfigurations take into account the existing RRC configuration the UE has with source cell, which are provided in the inter-node request. EUTRA or E-UTRA is short for Evolved-UMTS Terrestrial Radio Access, UMTS is short for Universal Mobile Telecommunications System, EPC is short for Evolved Packet Core and 5GC is short for Fifth Generation Core. The X2 interface is an interface between two radio access nodes, e.g. evolved Node B (eNB), in case of EUTRA-EPC, and the Xn interface is an interface between two radio access nodes, e.g. gNodeB (gNB), in case of EUTRA-5GC or NR. Among other parameters, the reconfiguration provided by the target cell comprises all information the UE needs to access the target cell, e.g., random access configuration, a new Cell-Radio Network Temporary Identifier (C-RNTI) assigned by the target cell and security parameters enabling the UE to calculate new security keys associated to the target cell so the UE may send a handover complete message on Signaling Radio Bearer 1 (SRB1), encrypted and integrity protected, based on new security keys upon accessing the target cell.

Herein, the terms source, serving, old and first may be used interchangeably when referring to the node, e.g. gNB, eNB, which the UE is currently served by and will be handed over from. The terms target, new and second may be used interchangeably when referring to the node, e.g. gNB, eNB, which the UE will be served by after the handover.

FIG. 1a and FIG. 1b illustrates the flow signaling between the UE, the source node and the target node during a HO procedure. The source node is exemplified with a source gNB and the target node is exemplified with a target gNB. FIG. 1a illustrates steps 101-114 and FIG. 1b illustrates steps 115-123. FIG. 1b is a continuation of FIG. 1a. The following nodes are comprised in the method shown in FIGS. 1a and 1b: UE 401, source gNB 403a, target gNB 403b, Access and Mobility Management Function (AMF) node 405 and one or more User Plane Function (UPF) node(s) 408. User data is indicated with dotted arrows in FIGS. 1a and 1b.

FIGS. 1a and 1b comprise least one of the following steps, which steps may be performed in any suitable order than described below:

Step 101

This step is seen in FIG. 1a. User data is transmitted between the UE 401 and the source gNB 403a, and between the source gNB 403a and the UPF(s) 408. User data may also be referred to as User Plane (UP) data.

Step 102

This step is seen in FIG. 1a. Mobility control information is provided by AMF node 405 to the source gNB 403a and the target gNB 403b.

Step 103

This step is seen in FIG. 1a. The UE 401 and the source gNB 403a perform measurement control and provide reports to each other about this.

Step 104

This step is seen in FIG. 1a. The source gNB 403a takes a HO decision, i.e. a decision to handover the UE 401 from the source gNB 403a to the target gNB 403b.

Step 105

This step is seen in FIG. 1a. The source gNB 403a sends a handover request message to the target gNB 403b. The target gNB 403b receives the handover request message from the source gNB 403a.

Step 106

This step is seen in FIG. 1a. The target gNB 403b performs admission control related to the handover request message.

Step 107

This step is seen in FIG. 1a. The target gNB 403b sends a handover request acknowledgement message to the source gNB 403a. The handover request acknowledgement message indicates acknowledgement of the handover request message form step 105.

Steps 101-107 described above may be comprised in a handover preparation procedure.

Step 108

This step is seen in FIG. 1a. The source gNB 403b triggers Uu handover of the UE 401.

Step 109

This step is seen in FIG. 1a. The source gNB 403a transmits a Sequence Number (SN) status transfer message to the target gNB 403b. The target gNB 403b receives the SN status transfer message from the source gNB 403a.

Step 110

This step is seen in FIG. 1a. The UE 401 detaches from the old cell, i.e. the source gNB 403a, and synchronizes to the new cell, i.e. the target gNB 403b.

Step 111

This step is seen in FIG. 1a. The source gNB 403a delivers buffered and in transit user data to the target gNB 403b.

Step 112

This step is seen in FIG. 1a. The source gNB 403a forwards user data to the target gNB 403b. The target gNB 403b receives user data from the source gNB 403a.

Step 113

This step is seen in FIG. 1a. The target gNB 403b buffers the user data received from the source gNB 403a.

Step 114

This step is seen in FIG. 1a. The UE 401 synchronizes to the new cell, i.e. the target gNB 403b, and completes the RRC handover procedure.

Steps 108-114 described above may be comprised in a handover execution procedure.

Step 115

This step is seen in FIG. 1b. User data is transmitted between the UE 401 and the target gNB 403b. User data may also be referred to as UP data.

Step 116

This step is seen in FIG. 1b. User data is transmitted between the target gNB 403b and the UPF node(s) 408.

Step 117

This step is seen in FIG. 1b. The target gNB 403b transmits a path switch request message to the AMF node 405. The AMF node 405 receives the path switch request message from the target gNB 403b.

Step 118

This step is seen in FIG. 1b. The AMF node 405 performs path switch related 5G CN internal signaling and actual DL path switch in the UPF node(s) 4.

Step 119

This step is seen in FIG. 1b. The AMF node 405 sends an end marker to the source gNB 403a. The source gNB 403a receives the end marker from the AMF node 405.

Step 120

This step is seen in FIG. 1b. The source gNB 403a sends the end marker to the target gNB 403b. The target gNB 403b receives the end marker from the source gNB 403a.

Step 121

This step is seen in FIG. 1b. User data is transmitted between the target gNB 403b and the UPF node(s) 408.

Step 122

This step is seen in FIG. 1b. The AMF node 405 sends a path switch request acknowledgement message to the target gNB 403b. The path switch request acknowledgement message indicates acknowledgement of the path switch request message from step 117.

Step 123

This step is seen in FIG. 1b. The target gNB 403b sends a UE context release message to the source gNB 403a. The source gNB 403a receives the UE context release message from the target gNB 403b. The source gNB 403a releases the UE context, as indicated in the UE context release message.

Steps 115-123 in FIG. 1b are comprised in a handover completion procedure.

Both in LTE and NR, some principles exist for handovers, or in more general terms, mobility in RRC_CONNECTED:
Mobility in RRC_CONNECTED is network based as the network has best or most information regarding the current situation such as load conditions, resources in different nodes, available frequencies, etc. The network may also take into account the situation of many UEs 401 in the network from a resource allocation perspective.
The network prepares a target cell before the UE 401 accesses that cell. The source gNB 403a provides the UE 401 with the RRC configuration to be used in the target cell, comprising SRB1 configuration to send handover complete message.
The UE 401 is provided by target with a target C-RNTI, i.e. the target cell identifies the UE 401 from message 3 (MSG.3) on the Medium Access Control (MAC) level for the handover complete message. Hence, there is no context fetching, unless a failure occurs.
To speed up the handover, the network provides needed information on how to access the target e.g. Random Access Channel (RACH) configuration, so the UE 401 does not have to acquire System Information (SI) prior to the handover.
The UE 401 may be provided with Contention Free RACH (CFRA) resources, i.e. in that case target identifies the UE 401 from the preamble, e.g. message 1 (MSG.1). The principle behind this is that the procedure may always be optimized with dedicated resources. In Conditional handover (CHO) that might be a bit tricky as there is uncertainty about the final target but also the timing.
Security is prepared before the UE 401 accesses the target cell i.e. keys must be refreshed before sending RRC Connection Reconfiguration Complete message, based on new keys and encrypted and integrity protected so UE 401 may be verified in the target cell.

Both full and delta reconfiguration are supported so that the handover command may be minimized.

Mobility Prediction and Artificial Intelligence/Machine Learning Applied to Radio Access Networks

Recently, many works have been dedicated to study mobility prediction. By mobility prediction it may be referred to the technique to predict that a given UE 401 is going to leave the coverage of a source cell and is going to enter the coverage of a neighbor cell before it does, i.e. even the UE 401 reports a measurement report to the network associated to an A3 like event, neighbor offset better than source cell, the network figures out that the event is going to happen before it happens with a certain likelihood, of course. Some of the applications and scenarios addressed by the studies of mobility prediction works are:
Handover anticipation: in small and densified mmWave cellular networks, frequent HOs and the resultant high switching latency degrade the system performance, which is further exacerbated by the fact that an mmWave channel is vulnerable to the line-of-sight (LOS) blockage, leading to sudden drops or outage of the signal. In this type of scenario, mobility prediction could be used to alleviate the mentioned problems by starting handover process ahead of time. In the baseline process without predictions, the UE 401 sends a measurement report, the source cell prepares the target cell possibly in a target node 403b, the target node 403b gives the source the reconfiguration, e.g. in a container, the source node 403a gives the reconfiguration to the UE 401, e.g. an RRCReconfiguration with a reconfiguration with synchronization, the UE 401 receives the RRCReconfiguration properly and the UE 401 accesses the target cell in target node 403b. Notice that the inter-node messages exchange and the processing time in both source and target nodes 403a, 403b may take some time, so that it may be a significant delay from the time the UE 401 sends the measurement report, i.e. from the time the A3 condition for HO is fulfilled, to the time the UE 401 gets the RRCReconfiguration with target configuration.
Keeping users' continuous connection: this type of application is usually addressed by works considering delay sensitive services, where, based on the prediction of a moving UE's next position, the network proactively pre-fetches the UE content to edge catching base stations, guaranteeing data delivery performance with near-zero delay, e.g. seamless handover. Compared to the previous discussion, this benefit is more related to the user plane data delivery.
Load balancing: works considering mobility prediction and the expected growth of mobile traffic in 5G networks have used the prior knowledge of user mobility to predict time-varying traffic load and offload part of the traffic to small cells, e.g. turn on/off, for preventing the network from congesting.
Location based services (LBSs): LBSs aims to enhance UE's experience through services related to the UE's specific location, e.g., sending target advertisements, local traffic information, instant communication with people nearby and merchant recommendation. However, real time geographical location is a critical issue, e.g., Global Positioning System (GPS) is unsuitable for indoor location estimation. In this context, works related to LBSs and mobility prediction usually benefit of foreknowing where the users will be in the future.

An A3 event is mentioned above. The A3 event is one of a plurality of events which may trigger a measurement report. The measurement report is triggered by whether the measured value crosses, goes higher or goes lower, a certain target value. Below is a non-exhaustive list of events that may trigger a measurement report:
Event A1: Serving becomes better than absolute threshold;
Event A2: Serving becomes worse than absolute threshold;
Event A3: Neighbor becomes amount of offset better than PCell/PSCell;
Event A4: Neighbor becomes better than absolute threshold;
Event A5: PCell/PSCell becomes worse than absolute threshold1 and Neighbor/SCell becomes better than another absolute threshold2;
Event A6: Neighbor becomes amount of offset better than SCell;
Event B1: Inter RAT neighbor becomes better than threshold;
Event B1-NR: NR neighbor becomes better than threshold;
Event B2: Serving becomes worse than threshold1 and inter RAT neighbor becomes better than threshold2;
Event B2-NR Serving becomes worse than threshold1 and NR neighbor becomes better than threshold2;
Event C1: A Channel State Information-Reference Signal (CSI-RS) resource becomes better than an absolute threshold;
Event C2: A CSI-RS resource becomes amount of offset better than a reference CSI-RS resource;
Event W1: WLAN becomes better than a threshold
Event W2: All WLAN inside WLAN mobility set becomes worse than threshold1 and a WLAN outside WLAN mobility set becomes better than threshold2
Event W3: All WLAN inside WLAN mobility set becomes worse than a threshold
Event V1: Channel Busy Ratio (CBR) becomes larger than an absolute threshold;
Event V2: Channel Busy Ratio (CBR) becomes smaller than an absolute threshold.
Event H1: Aerial UE height becomes higher than an absolute threshold;
Event H2: Aerial UE height becomes lower than an absolute threshold.

Despite considering different approaches, the frameworks for mobility prediction are usually structured as illustrated in FIG. 2. In summary, a central node, e.g., the serving node, aggregates UE periodically reported data, such as location history and received signal strength, and uses this data as input for prediction algorithms. The prediction outputs represent what the central node desire to acquire through prediction, e.g. transition probability or future location.

In more detail, FIG. 2 shows three categories of applications: handover management 201, resource management 202 and location-based services 203. FIG. 2 shows the following performance matrices: prediction accuracy 204, deviation error 205, handover dropping probability 206 and new call blocking probability 207. Procedures of mobility prediction are input from the applications to the performance matrices. Evaluating results from prediction outputs such as moving direction 208, transition probability 209, future location 210, user trajectory 211 and the next cell ID 212 are provided to the performance matrices. FIG. 2 shows prediction algorithms such as Markov chain 213, Hidden Markov model 214, artificial neural network 215, Bayesian network 216 and data mining 217, which provides prediction outputs. FIG. 2 shows the following required information: location information 218, cell transition history 219, road topology information 220, user behavior 221 and received signal strength 222, which provides extracted knowledge to the prediction algorithms. Data is collected from the UE 401, the network node 403, data server 250, the satellite 260 and the sensor 270.

Regarding specifically the prediction algorithms, the recent ones are mostly based on Machine Learning (ML). Although the terms Artificial Intelligence (AI) and ML are sometimes interchangeably used, this is a misconception. ML is a sub-field of A1, as well as game theory and control theory. In general, ML encompasses methods that learn from data.

The most common ML techniques may be classified in at least three broad categories:
Supervised learning: Methods that learn a model/function based on training sets assembling examples of inputs and their expected outputs. Neural Networks (NNs) illustrate this category. In NNs, nodes, using activation functions to perform nonlinear computation, are connected to each other by variable link weights. A training set is used to adjust the weights in order to map inputs into outputs.
Unsupervised learning: Methods that try to find hidden patterns without having any prior knowledge, e.g., training sets, of the output that they should come up with for each input. K-means is a well-known algorithm used in this category. It tries to find clusters only based on unlabelled input and a predefined number of clusters.
Reinforcement Learning (RL): Methods that learn based on trial and error. Their objective is to find a policy, i.e., sequence of actions to be taken by an agent that maximizes the expected reward in the long term. For this, the agent takes actions in order to learn the reward associated to each action from a specific system state. RL is neither supervised, since it does not rely on training sets, nor unsupervised, since it uses actions and rewards to sense the environment. Q-learning is one of the most famous RL techniques.

Measurement Prediction Based on ML and A1.

Existing solutions for mobility prediction, e.g. to improve handover performance, rely on the following aspects:
Periodic measurement reports and/or;
Event trigger measurement reports but using an early trigger, e.g. trigger condition more conservative than the condition closer to a handover, i.e. source is still good enough;
Predictions are performed at the network side having the measurements above as input.

This approach has several drawbacks/limitations. In the case the prediction on the network side relies on periodic reports, the UEs need to constantly send measurement reports to their serving Base Stations (BS) in order of the serving BS to be able to perform the predictions. This increases the Uplink (UL) signaling and also increases UE power consumption since the UE 401 needs to constantly perform measurements and periodically report them. In the case of an early event triggered report signaling is reduced, but the amount of input for the prediction model is also limited, which may affect the performance of the prediction algorithm at the network side. A third limitation is that in principle the network is not aware of many other local parameters at the UE 401, such as positioning, rotation of the UE 401, speed, applications that are running that may be related to a UE's route, e.g. mapping/GPS/navigation applications, etc. Besides, depending on the delay between the measurement performed at the UE 401 and the use of this measurement by the serving BS, the predictions might be based on out-of-date data, e.g. due to the delay between the time when the UE 401 performs the measurement and the time this measurement is used by the BS, like queueing delay, transmission delay, processing, etc.

Inclusion of Mobility Predictions in Measurement Reports

Current systems like LTE and NR only covers the report of current and real measurements. This is illustrated in FIG. 3a. Besides, the UE 401 either sent measurement reports 305 periodically or after an Ax event or a Bx event is triggered 303 based on measurements 301. However, periodic measurement reports 305 increase transmissions in control plane, preventing the UE 401 from transmitting and receiving data in the user plane, thus reducing UE data throughput. Decisions based on measurement reports 305 sent after a triggered event 303 may be taken way too late, considering that, especially in higher frequencies, like NR Frequency Range 2—(FR2), the channel conditions may change fast.

FIG. 3b illustrates a method where the UE 401 performs mobility predictions, such as measurement predictions 308 for Reference Signals Received Power (RSRP), Reference Signal Received Quality (RSRQ), or Signal to Interference plus Noise Ratio (SINR). And, when a measurement report 305 is triggered, e.g. a measurement identity (measId) associated to a reporting configuration, e.g. reportConfig with an A3 event, and a measurement object (measObject), related to a frequency where reference signals to be measured are transmitted, the UE 401 includes measurement predictions 308 on it, so that they are made available at the network. Measurement predictions 308 are comprised in measurement reports 305, which are reported, as in LTE/NR, either periodically or based on an event trigger 303 such as e.g. Ax events or Bx events. Reporting predictions can help the network to anticipate decisions and avoid the problem of fast radio channel conditions change. The method in FIG. 3b have benefits such as enabling the network to get better insights about triggering cells, i.e. cells triggering the events, when a report is anyway being transmitted. In other words, instead of only getting a list of cells that trigger the report and their current conditions, the network also receives predicted values for these measurements so it can take more educated decisions, not only taking into account the current state but possibly future state.

However, the predictions are only reported when and if a current measurement 301 triggers an event 303, for the event triggered reports. In this case, if the thresholds for triggering an event 303 are not properly set, even the measurement predictions 308 may not arrive soon enough for avoiding taking decision too late. And, something that may occur relates to the assumption that the threshold for measurement report triggering is properly set i.e. that when that is triggered, radio conditions are still good enough so the UE 401 is able to transmit a measurement report 305 and/or the network is able to respond to it if needed. What may happen, is that the UE 401 perform these predictions, and even before triggering a measurement report 305, a Radio Link Failure (RLF) can happen and the UE 401 is not able to send the reports with measurements and predictions.

Therefore, there is a need to at least mitigate or solve this issue.

### SUMMARY

An objective of embodiments herein is therefore to obviate at least one of the above disadvantages and to reduce the amount of signalling in a communications network.

According to a first aspect, the object is achieved by a method performed by a UE for handling mobility information in a communications network. The UE predicts mobility information related to the UE's predicted mobility in the communications network. The UE determines whether one or multiple conditions are fulfilled or not for one or multiple cells. At least part of the predicted mobility information is used as input to the one or multiple conditions. The UE transmits a message to a network node when it has been determined that the one or multiple conditions are fulfilled.

According to a second aspect, the object is achieved by a method performed by a network node for handling mobility information in a communications network. The network node receives a message from a UE, and takes mobility decisions for the UE based on the message.

According to a third aspect, the object is achieved by a UE for handling mobility information in a communications network. The UE is adapted to predict mobility information related to the UE's predicted mobility in the communications network. The UE is adapted to determine whether one or multiple conditions are fulfilled or not for one or multiple cells. At least part of the predicted mobility information is used as input to the one or multiple conditions. The UE is adapted to transmit a message to a network node when it has been determined that the one or multiple conditions are fulfilled.

According to a fourth aspect, the object is achieved by a network node for handling mobility information in a communications network. The network node is adapted to receive a message from a UE, and to take mobility decisions for the UE based on the message.

Since the UE predicts the mobility information by using locally available information and up-to-date measurements in the prediction, the amount of signalling in a communications network is reduced, as compared to when the network node performs the prediction, which would involve the need for the UE to transmit its local information to the network node. Furthermore, since it is the UE that predicts the mobility information, as compared to the network node, it reduces the computational load of the network node.

The present disclosure herein affords many advantages, of which a non-exhaustive list of examples follows:

One advantage of the present disclosure comes from the fact that the predictions of mobility related information are performed by the UE, which allows the use of more locally available information and more up-to-date measurements, without the need of increasing the frequency of periodic reports for the network node, as it is necessary in solutions where the prediction is performed by the network node, e.g. in a gNB or any other network node. Even if a prediction model is run by the UE, decentralized or distributed, the prediction model may benefit of the knowledge of a centralized solution, since the prediction model could be learnt by the network node and later provided to the UE, e.g. via programmability, downloaded, configuration of model parameters, etc.

Another advantage of the present disclosure is that, when it is used for predicting target candidate cell(s), base station(s) or network node(s) to be used in conditional handover, it allows configuration of a smaller set of candidate target cells, when compared to solutions based on legacy handover and different threshold for earlier measurement report.

A further advantage of the present disclosure is that triggering the transmission of the message based on the predictions of mobility related information, like predictions of measurements, predictions of RSRP, rather than actual or real measurements, enables the network node to figure out earlier that a handover or conditional handover, Secondary Cell Group (SCG) addition, release or reconfiguration, Release with redirect, or other mobility management related actions, may need to be performed i.e. when the message is triggered, there is a higher likelihood that regardless how aggressive the setting of the triggering thresholds are the radio quality of the serving cell(s) would not be that low, since the triggering would be based on predictions. That has also the potential to improve the radio link robustness as the measurement report is being transmitted much earlier than the point in time where the serving cell quality would significantly drop.

The present disclosure is not limited to the features and advantages mentioned above. A person skilled in the art will recognize additional features and advantages upon reading the following detailed description.

### BRIEF DESCRIPTION OF THE DRAWINGS

The present disclosure will now be described in more detail by way of example only in the following detailed description by reference to the appended drawings illustrating the embodiments and in which:

FIG. 1a is a signaling diagram illustrating a handover procedure.

FIG. 1b is a signaling diagram illustrating a handover procedure.

FIG. 2 is a schematic block diagram illustrating mobility prediction.

FIG. 3a is a schematic block diagram illustrating measurement reports.

FIG. 3b is a schematic block diagram illustrating measurement reports.

FIG. 4 is a schematic block diagram illustrating a communications network.

FIG. 5 is a signaling diagram illustrating a method.

FIG. 6 is a schematic block diagram illustrating a method.

FIG. 7 is a graph illustrating event A1 and example 1.

FIG. 8 is a graph illustrating event A1 and example 2.

FIG. 9 is a graph illustrating event A2 and example 1.

FIG. 10 is a graph illustrating event A2 and example 2.

FIG. 11 is a graph illustrating event A3 and example 1.

FIG. 12 is a graph illustrating event A3 and example 2.

FIG. 13 is a graph illustrating event A4 and example 1.

FIG. 14 is a graph illustrating event A4 and example 2.

FIG. 15 is a graph illustrating event A5 and example 1.

FIG. 16 is a graph illustrating event A5 and example 2.

FIG. 17 is a graph illustrating event A6 and example 1.

FIG. 18 is a graph illustrating event A6 and example 2.

FIG. 19 is a signaling diagram illustrating a method.

FIG. 20 is a schematic drawing illustrating update of a prediction model.

FIG. 21 is a flow chart illustrating a method performed by a UE.

FIG. 22 is a flow chart illustrating a method performed by a network node.

FIG. 23a is a schematic drawing illustrating a UE.

FIG. 23b is a schematic drawing illustrating a UE.

FIG. 24a is a schematic drawing illustrating a network node.

FIG. 24b is a schematic drawing illustrating a network node.

FIG. 25 is a schematic block diagram illustrating a telecommunication network connected via an intermediate network to a host computer.

FIG. 26 is a schematic block diagram of a host computer communicating via a base station with a UE over a partially wireless connection.

FIG. 27 is a flowchart depicting a method in a communications system comprising a host computer, a base station and a UE.

FIG. 28 is a flowchart depicting a method in a communications system comprising a host computer, a base station and a UE.

FIG. 29 is a flowchart depicting a method in a communications system comprising a host computer, a base station and a UE.

FIG. 30 is a flowchart depicting a method in a communications system comprising a host computer, a base station and a UE.

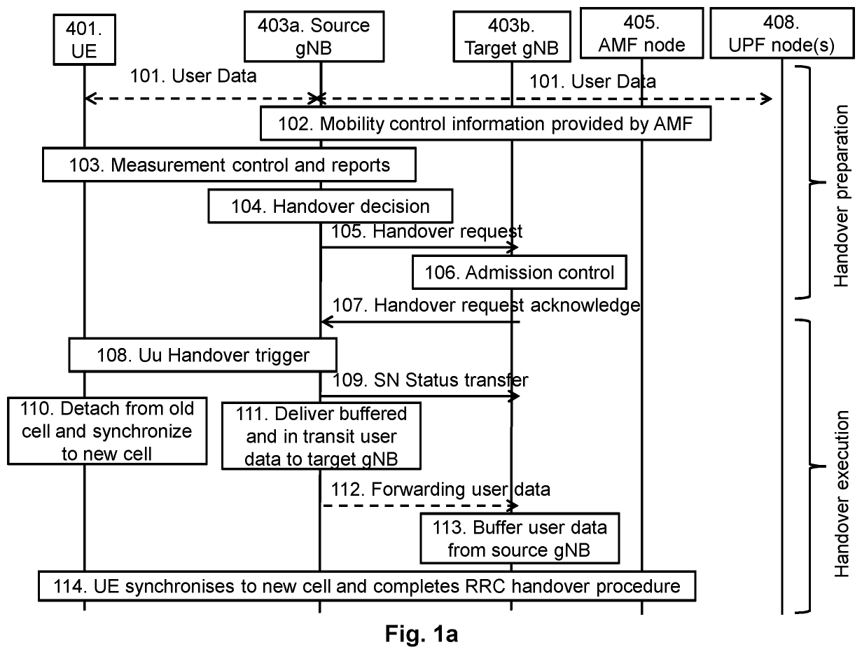

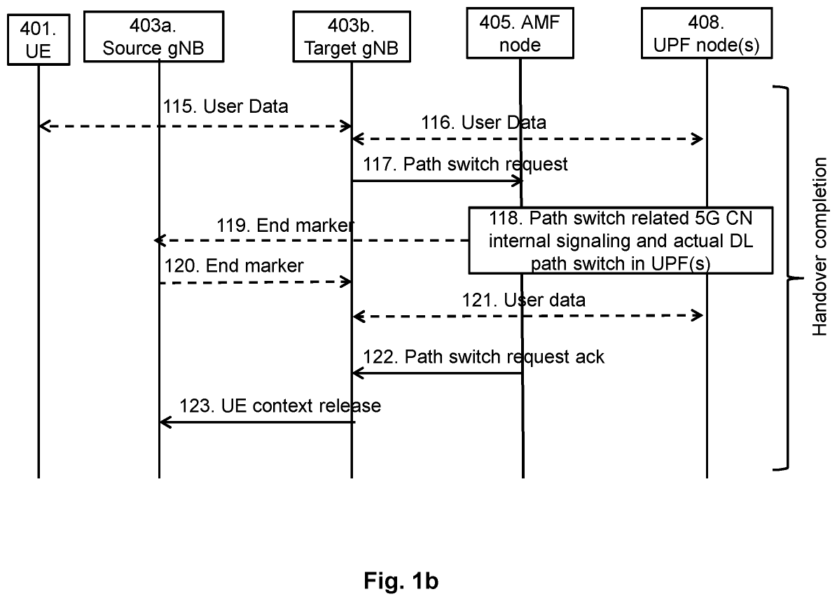

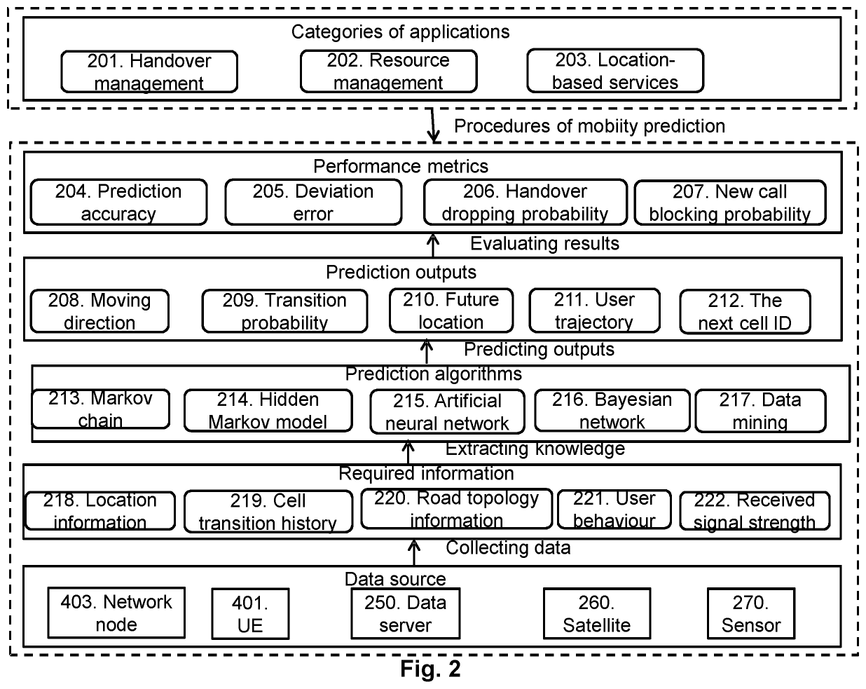

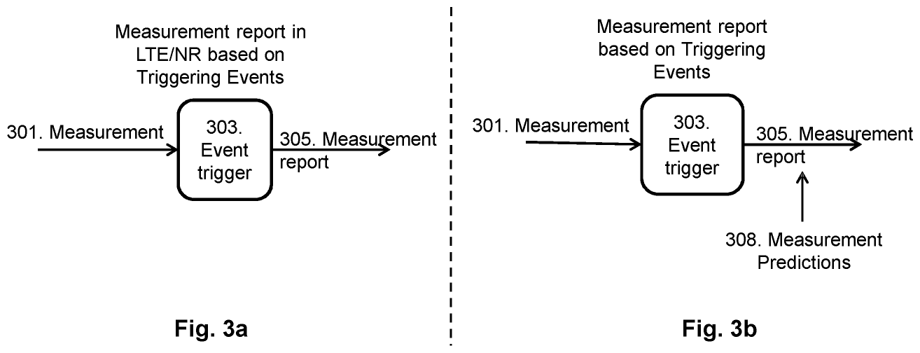

The drawings are not necessarily to scale and the dimensions of certain features may have been exaggerated for the sake of clarity. Emphasis is instead placed upon illustrating the principle.

### DETAILED DESCRIPTION

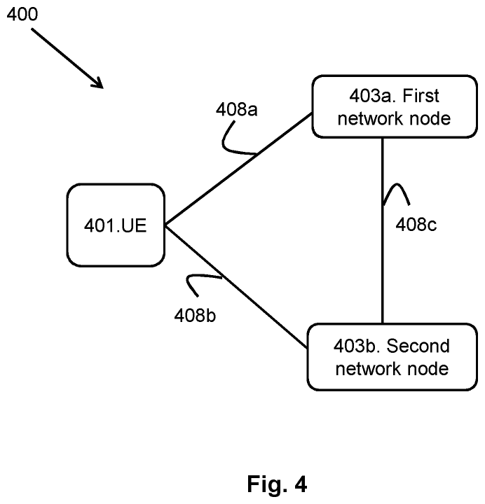

FIG. 4 depicts a communications network 400, which may be a wireless communications system, sometimes also referred to as a wireless communications network, cellular radio system, or cellular network. The communications network 400 may be a Fifth Generation (5G) system, 5G network, New Radio-Unlicensed (NR-U) or Next Gen system or network. The communications network 400 may alternatively be a younger or older system than a 5G system such as e.g. a Second Generation (2G) system, a Third Generation (3G) system, a Fourth Generation (4G) system, a Sixth Generation (6G) system etc. The communications network 400 may support other technologies such as, for example LTE, LTE-Advanced/LTE-Advanced Pro, e.g. LTE Frequency Division Duplex (FDD), LTE Time Division Duplex (TDD), LTE Half-Duplex Frequency Division Duplex (HD-FDD), LTE operating in an unlicensed band, Narrow Band-Internet of Things (NB-IoT). Thus, although terminology from 5G, NR and LTE may be used in this disclosure, this should not be seen as limiting to only the aforementioned systems.

The communications network 400 comprises one or a plurality of network nodes, whereof a first network node 403a and a second network node 403b are depicted in FIG. 4. Any of the first network node 403a and the second network node 403b may be a core network node or a radio network node, such as a radio base station, or any other network node with similar features capable of serving a UE 401, such as a wireless device or a machine type communication device, in the communications network 400. The first network node 403a may be an eNB and the second network node 403b may be a gNB. The first network node 403a may be a first eNB, and the second network node 403b may be a second eNB. The first network node 403a may be a first gNB, and the second network node 403b may be a second gNB. The first network node 1403a may be a MeNB and the second network node 403b may be a gNB. Any of the first network node 403a and the second network node 403b may be co-localized, or be part of the same network node. The first network node 403a may be referred to as a source node or source network node, whereas the second network node 403b may be referred to as a target node or target network node. When the reference number 403 is used herein without the letters a or b, it refers to a network node in general, i.e. it refers to any of the first network node 403a or second network node 403b.

The communications network 400 covers a geographical area which may be divided into cell areas, wherein each cell area may be served by a network node 403, although, one network node may serve one or several cells. In FIG. 4, the communications network 400 comprises a first cell and a second cell. Note that any n number of cells may be comprised in the communication network 400, where n is any positive integer. A cell is a geographical area where radio coverage is provided by the network node at a network node site. Each cell is identified by an identity within the local network node area, which is broadcast in the cell. In FIG. 4, first network node 403a serves the first cell, and the second network node 403b serves the second cell. Any of the first network node 403a and the second network node 403b may be of different classes, such as, e.g., macro BS, home BS or pico BS, based on transmission power and thereby also cell size. Any of the first network node 403a and the second network node 403b may be directly connected to one or more core networks, which are not depicted in FIG. 4 for the sake of simplicity. Any of the first network node 403a and the second network node 403b may be a distributed node, such as a virtual node in the cloud, and it may perform its functions entirely on the cloud, or partially, in collaboration with another network node. The first cell may be referred to as a source cell, whereas the second cell may be referred to as a target cell.

One or a plurality of UEs 401 is located in the communication network 400. Only one UE 401 is exemplified in FIG. 4 for the sake of simplicity. A UE 401 may also be referred to simply as a device. The UE 401, e.g. a LTE UE or a 5G/NR UE, may be a wireless communication device which may also be known as e.g., a wireless device, a mobile terminal, wireless terminal and/or mobile station, a mobile telephone, cellular telephone, or laptop with wireless capability, etc. The UE 401 may be a device by which a subscriber may access services offered by an operator's network and services outside operator's network to which the operator's radio access network and core network provide access, e.g. access to the Internet. The UE 401 may be any device, mobile or stationary, enabled to communicate over a radio channel in the communications network, for instance but not limited to e.g. user equipment, mobile phone, smart phone, sensors, meters, vehicles, household appliances, medical appliances, media players, cameras, Machine to Machine (M2M) device, Internet of Things (IoT) device, terminal device, communication device or any type of consumer electronic, for instance but not limited to television, radio, lighting arrangements, tablet computer, laptop or Personal Computer (PC). The UE 401 may be portable, pocket storable, hand held, computer comprised, or vehicle mounted devices, enabled to communicate voice and/or data, via the radio access network, with another entity, such as another UE, a server, a laptop, a Personal Digital Assistant (PDA), or a tablet, Machine-to-Machine (M2M) device, device equipped with a wireless interface, such as a printer or a file storage device, modem, or any other radio network unit capable of communicating over a radio link in the communications network 400.

The UE 401 is enabled to communicate wirelessly within the communications network 400. The communication may be performed e.g. between two UEs 401, between a UE 401 and a regular telephone, between the UE 401 and a network node, between network nodes, and/or between the UEs 401 and a server via the radio access network and possibly one or more core networks and possibly the internet.

The first network node 403a may be configured to communicate in the communications network 400 with the UE 401 over a first communication link 408a, e.g., a radio link. The second network node 403b may be configured to communicate in the communications network 400 with the UE 401 over a second communication link 408b, e.g., a radio link. The first network node 403a may be configured to communicate in the communications network 400 with the second network node 403b over a third communication link 408c, e.g., a radio link or a wired link, although communication over more links may be possible.

It should be noted that the communication links in the communications network may be of any suitable kind comprising either a wired or wireless link. The link may use any suitable protocol depending on type and level of layer, e.g. as indicated by the Open Systems Interconnection (OSI) model, as understood by the person skilled in the art.

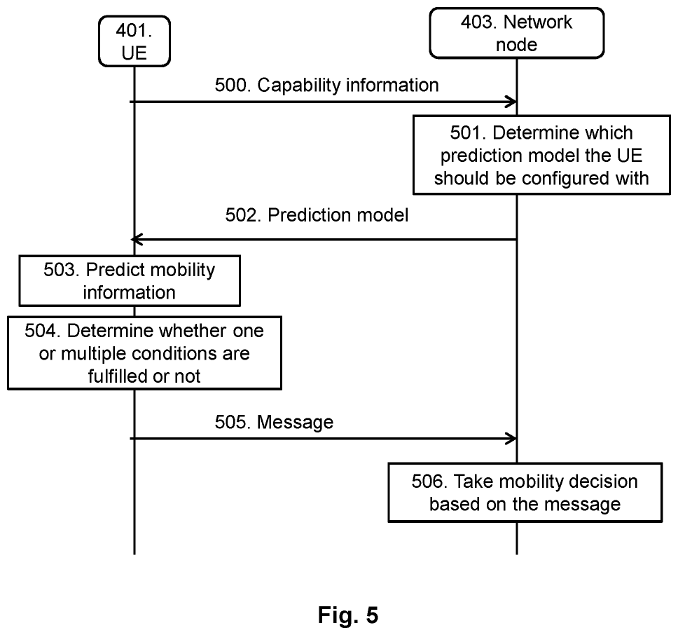

The method for handling mobility information in a communications network 400 will now be described with reference to the signalling diagram depicted in FIG. 5. The method comprises the following steps, which steps may as well be carried out in another suitable order than described below:

Step 500

The UE 401 may provide capability information to the network node 403. The capability information may indicate the UE's 401 capability to receiving a prediction model from the network node 403, to transmit a message to the network node etc. The information may be provided by direct transmission from the UE 401 to the network node 403, it may be provided via some other unit, e.g. a cloud memory, a network memory, another network node, another UE 401 etc., it may be provided upon request, on a regular basis, continuously etc.

The network node 401 may obtain the capability information from the UE 401.

Step 501

The network node 403 may determine which prediction model the UE 401 should be configured with. The UE 401 may be configured with one or multiple prediction models.

Step 502

The network node 403 may provide information indicating the determined prediction model to the UE 401. This step may also be described as the network node 403 configures the UE 401 with one or multiple prediction models, i.e. the one or multiple prediction models determined by the network node 403 in step 501. The information may be provided by direct transmission from the network node 403 to the UE 401, it may be provided via some other unit, e.g. a cloud memory, a network memory, another network node etc., it may be provided upon request, on a regular basis, continuously etc.

The UE 401 may obtain the information indicating the determined prediction model form the network node 403.

Step 503

The UE 401 predicts mobility information. The predicted mobility information indicates a prediction of the UE's mobility in the communications network 400 for a future time, i.e. a time ahead of the current time. The predicted mobility information may also be described as predicted mobility related information. The mobility information may be predicted using the prediction model from step 502.

This step may also comprise that the UE 401 determines the current mobility information, i.e. its' mobility information for the UE's current location. For example, currently, the UE 401 is in cell A, and this may be described as the current mobility information. In X seconds, the UE 401 may have moved to cell B, which may be described as the predicted mobility information

Step 504

The UE 401 determines whether one or multiple conditions are fulfilled or not. At least part of the predicted mobility information from step is used as input to the one or multiple conditions.

Step 505

The UE 401 transmits message to the network node 403 when it has been determined in step 504 that the one or multiple conditions are fulfilled. In other words, the trigger for transmitting the message to the network node 403 is that the one or multiple conditions are fulfilled. The network node 403 receives the message form the UE 401. If the one or multiple conditions are not fulfilled, then the message may not be transmitted by the UE 401 to the network node 403.

The message may be transmitted by direct transmission from the UE 401 to the network node 403, it may be provided via some other unit, e.g. a cloud memory, a network memory, another network node etc., it may be provided upon request, on a regular basis, continuously etc.

The message may comprise the predicted mobility information or current mobility information, or both the predicted mobility information and the current mobility information. The message may be divided in to sub messages, transmitted at different time instances or at the same time. For example, a first sub message may comprise the current mobility information and a second sub message may comprise the predicted mobility information. The first sub message may be transmitted for example directly after step 500 or directly after step 502. The second sub message may be transmitted directly after step 504. The first sub message and the second sub message may be transmitted directly after step 504, as illustrated in FIG. 5.

The network node 403 receives the message from the UE 401.

Step 506

The network node 403 takes a mobility decision based on the message from step 505.

During the steps of FIG. 5, the UE 401 may be in connected state.

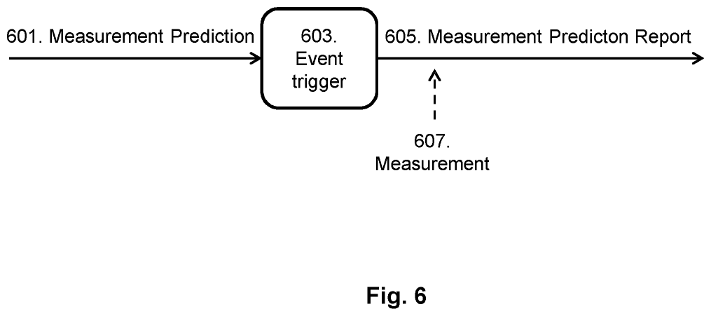

FIG. 6 is a different way of illustrating the method in FIG. 5. FIG. 6 shows the transmission of the message based on triggering events 603, i.e. based on the fulfillment of the conditions. Input to the triggering event is the measurement prediction 601, which corresponds to the predicted mobility information in step 503 of FIG. 5. The output of the event trigger 603 is the measurement prediction report 605 transmitted from the UE 401 to the network node 403, which corresponds to the message in step 505. Measurements 607, i.e. current mobility information, may also be transmitted together with the measurement prediction. The steps performed by the UE 401 in FIG. 6 may be at least one of the following:
Performing predictions of mobility related information—corresponds to step 503 in FIG. 5 and step 601 in FIG. 6;
Evaluating reporting criteria according to one or multiple conditions, e.g. an entry condition or combination of entry conditions, whose input is based on predictions of mobility related information, as performed in the previous step—corresponds to step 504 in FIG. 5 and step 603 in FIG. 6;
Upon the fulfilment of an entry condition, whose input is based on predictions of mobility related information, trigger a reporting procedure—corresponds to step 505 in FIG. 5 and step 605 in FIG. 6.
Reporting predictions of mobility related information—corresponds to step 505 in FIG. 5 and step 605 in FIG. 6.

Seen from the perspective of the network node 403, the network node 403 may perform at least one of the following steps:
Configuring the UE 401 to perform predictions of mobility related information, such as predictions of radio quality such as RSRP, RSRQ, SINR in a given frequency, e.g. per cell, per beam, per RS type like SSB and/or CSI-RS, etc.—corresponds to step 501 and 502 in FIG. 5;
Configuring the UE 401 to evaluate reporting criteria according to a configured condition (entry condition) whose input is based on predictions of mobility related information, as performed in previous step—corresponds to step 502 and 503 in FIG. 5;
Receiving a message including predictions of mobility related information performed by a UE 401, where the message indicates the fulfilment of a first condition whose input is based on predictions of mobility related information—corresponds to step 505 in FIG. 5 and step 605 in FIG. 6,
Triggering a reporting procedure—corresponds to step 506 in FIG. 5.

UE Aspects

The present disclosure seen from the UE aspect will now be described in more detail. Later, the network node aspect will be described.

The UE 401 predicts mobility information such as radio conditions of serving and/or neighbor cells in serving and/or neighbor frequencies, list of cells and/or beams the UE 401 is moving to, and the usage of these predictions as input to triggering conditions for triggering transmission of the message. This may be described as the UE assists mobility management for example by one or more of the following:
Performing predictions of mobility information;
Evaluating reporting criteria according to one or multiple conditions, e.g. an entry condition or combination of entry conditions, whose input is based on predictions of mobility related information (as performed in previous step);
Upon the fulfilment of an entry condition, whose input is based on predictions of mobility related information), trigger a reporting procedure;
Reporting predictions of mobility information to the network node 403.

The UE 401 performs predictions of mobility information, which may corresponds to at least one of the following: predictions of measurements, such as predictions of RSRP, RSRQ, SINR and/or any other predicted mobility related information such as next cell/beam, e.g. coverage of a given reference signal represented by an identifier or index) the UE 401 is most likely to enter, be covered by according to criteria, a list of cells/beams the UE is likely to move towards, etc. Other examples of predicted mobility information are provided below. Predictions of mobility information or simply mobility predictions) may be performed by the UE 401 according to configurations, i.e. fields and associated IEs containing further fields/parameters, comprised in a measConfig of IE MeasConfig or according to a new field e.g. called predConfig of IE PredConfig containing the configurations of predictions to be performed and possibly comprising the event configurations whose input for triggering is based on the predictions.

The UE 401 may be configured by the network node 403 to perform predictions of mobility information. The UE 401 may receive prediction reporting configuration(s), e.g., new configuration in ReportConfigNR or a new IE for that PredictionReportConfig). Based on the prediction reporting configurations, the UE 401 may performs predictions of mobility information and evaluates a reporting criteria based on predictions of mobility information. Once these conditions are fulfilled a message possibly comprising the predictions is transmitted to the network node 403.

Related to the reporting configuration of predictions of mobility related information, there may be different manners to define what is included in the prediction reports, e.g., only predicted values that triggered the events, current/real measurements for the same entities that are being predicted, etc., possibly in addition to the predictions. The UE 401 may be configured to comprise measurements associated to the predictions. For example, if cell A triggers an event and leads to the transmission of a message, the UE 401 may comprise measurements for cell A e.g. for the same quantity the UE 401 is reporting prediction, or additional quantities. For example, the UE 401 may be configured to trigger a message when the predicted RSRP is above a threshold for a neighbor cell and configuration may comprise an indication that in addition the UE 401 needs to comprise RSRP measurements and/or RSRQ measurements and/or SINR measurements. I.e. the message may not only include predictions for cell A, but also current measurements.

The UE 401 may receive and process an RRC message comprising configurations for predictions of mobility information even if security has not been activated.

The message may be called “prediction reports” due to the reason that predictions of mobility information are comprised, and/or predictions of mobility information is used as input to trigger the message, which may comprise information derived from the prediction of mobility information. However, “prediction reports” may be a generic term that may correspond to, for example, an RRCMeasurementReport that is triggered according to the method and/or comprise information according to the rules disclosed by the method. Similarly, “prediction reports” may correspond to, for example, a new RRC message defined for reporting predictions e.g. RRCPredictionReport that is triggered and/or comprises information as described herein. That new message may have properties such as being transmitted on SRB1 and only after security has been activated.

The prediction may be performed in different ways by the UE 401. Details are provided below. Different prediction models may be used, based on different set of parameters locally known at the UE 401 but not necessarily known at the network node 403.

Mobility Information

As mentioned above, the UE predicts mobility information related to the UE's predicted mobility in the communications network 100 in step 501. The mobility information may also be described as mobility prediction information, mobility related information, radio quality related information etc.

The prediction of mobility information may comprise at one or multiple of the following: predictions of measurements, such as predictions of RSRP, RSRQ, SINR and/or any other predicted mobility information such as next cell, next beam, e.g. coverage of a given reference signal represented by an identifier or index, the UE 401 is most likely to enter, be covered by according to a criteria, a list of cells/beams the UE 401 is likely to move towards, etc.

RSRP, RSRQ, SINR

The mobility information may comprise RSRP, RSRQ, SINR. The mobility information may be per different levels of granularities such as per frequency/carrier/ARFCN, per cell, per beam, per Reference Signal (RS) type like SSB and/or CSI-RS, per serving cell, per neighbor cell, for best neighbor cells in a serving frequency, for a list of beams and/or list of RS type coverage, like SSB identifier coverage or CSI-RS identifier coverage, the UE 401 is moving to, etc.

Predicting the mobility information may comprise that the UE 401 performs RSRP measurements for a serving cell A, e.g. the UE's SpCell associated to an MCG, and, at a given instant in time t0 predicting the RSRP values of that SpCell in one or multiple time instants such as t0+T, t0+2*T, t0+3*T, . . . , t0+K*T. T, K and the interval between predictions may be configured by the network node 403 and/or defined in the standard. In other words, predicting the mobility information may lead to a time series of RSRP predictions for the SpCell at time t0, leading to [RSRP(t0+T), RSRP(t0+2*T), RSRP(t0+3*T), . . . , RSRP(t0+K*T)] as an outcome. At least this time series may be used as input to the entry condition for an event like A1-A6.

A variant of the predicted mobility information, like predicted RSRP, RSRQ or SINR, may be prediction related to whether a condition triggering the event, e.g. A3 event. is to remain or not after X* seconds, for example for the triggered cells, as shown below in the case of triggered cells Cell-1, Cell2, Cell-3: [indication=TRUE i.e. prediction indicates that Cell-1 after X seconds still fulfils A3 condition, indication=TRUE i.e. prediction indicates that Cell-1 after 2*X seconds still fulfils A3 condition, . . . , indication=FALSE i.e. prediction indicates that Cell-1 after K*X seconds does not fulfil A3 condition, indication=TRUE i.e. prediction indicates that Cell-2 after X seconds still fulfils A3 condition, indication=TRUE i.e. prediction indicates that Cell-2 after 2*X seconds still fulfils A3 condition, . . . , indication=FALSE i.e. prediction indicates that Cell-2 after K*X seconds does not fulfil A3 condition, indication=TRUE i.e. prediction indicates that Cell-3 after X seconds still fulfils A3 condition, indication=TRUE i.e. prediction indicates that Cell-3 after 2*X seconds still fulfils A3 condition, . . . , indication=FALSE i.e. prediction indicates that Cell-3 after K*X seconds does not fulfil A3 condition,].

Cell Information

The mobility information may comprise information related to cells, e.g. referred to as cell information or cell measurements, the UE 401 may enter into coverage of e.g. a list of cells and possibly time information, according to a given criteria.

Predicting the of mobility information may comprise that the UE 401 selects or lists the “best” cells, according to criteria such as cell with strongest RSRP and/or RSRQ and/or SINR, at a given instant in time. For example, at time t0 the UE 401 performs for a given frequency and a number of neighbour cells, predictions of the RSRP values of that SpCell in one or multiple time instants such as t0+T, t0+2*T, t0+3*T, . . . , t0+K*T. T, K and the interval between predictions may be configured by the network node 403 and/or defined in the standard. Then, having these lists per neighbour cell the UE 401 may select a cell per interval. For example, if the UE 401 detects for an interval [t0+T, t0+4*T] cells A, B, C the UE 401 may first generate the RSRP series for each cell, and, after determining the strongest RSRP per instant t0+k*T, list the cells. The outcome may be [cell A, cell B, cell C, cell A] indicating that cell A is the strongest in t0+T, cell B is the strongest in t0+2*T, cell C is the strongest in t0+3*T and cell A is the strongest in t0+4*T, according to the predicted measurement results for these cells.

Beam Information

The mobility information may comprise information related to beams, i.e. SSBs and/or CSI-RS resources, e.g. list of beams and possibly time information where the UE 401 may predict it is going to be covered by, according to a given criteria. Information related to beams may be referred to as beam information or beam measurements.

The prediction of mobility information may comprise that the UE 401 selects or lists the “best” beams according to criteria such as beam with strongest RSRP and/or RSRQ and/or SINR and at a given instant in time. For example, at time t0 the UE 401 performs for a given frequency and cell, predictions of the RSRP values per beam in one or multiple time instants such as t0+T, t0+2*T, t0+3*T, . . . , t0+K*T. T, K and the interval between predictions may be configured by the network node 403 and/or defined in the standard. Then, having these lists per beam for a given cell on a given frequency, i.e., ARFCN for the SSB or carrier information, the UE 401 may select a beam per interval to be added in a list of beams. For example, if the UE 401 detects for an interval [t0+T, t0+4*T] beam-1, and beam-5 the UE 401 may first generate the RSRP series for each beam, and, after determining the strongest RSRP per instant t0+k*T, list the beams. The outcome may be [beam-1, beam-1, beam-1, beam-5] indicating that beam-1 is the strongest between t0+T until t0+3*T, and at t0+4*T it becomes beam-5 the strongest, according to the predicted measurement results for these beams for the given cell. Then, any information derived from these predictions beam information may be used as input for an entry condition of an event, that once triggered lead to a transmission of the message in step 505.

The predicted beam information may be associated to other beams of the serving cell, non-serving cell, etc.

Beam information, e.g. for the serving, may be used by the network node 403 to indicate which downlink beams should be configured or re-configured in a serving cell for beam management related procedures such as TCI state configurations/re-configurations/activations/deactivations, beam switching, Radio Link Monitoring, beam reporting, beam failure detection configuration, beam failure recovery configuration, configuration of contention-free random access resources, mapped to downlink beams, etc. If in addition to the beam information the network node 403 may obtain predictions concerning beam information the network node 403 is able to make more educated decisions concerning these procedures. For example, in the case of contention-free random access resources, the network node 403 may decide not to configure resources associated to a given beam that is reported as a good one, but whose predictions show that it may become worse after k*X seconds, which may be when the UE 403 tries to perform random access.

Route Information

The mobility information may comprise information related to a route or way the UE 401 is going such as positioning information or location information. The information related to the route or way may be referred to as route information or route measurements.

Prediction of the mobility information may comprise that the UE 401 determines exact GPS or equivalent coordinates in one or multiple time instants such as t0+T, t0+2*T, t0+3*T, . . . , t0+K*T. T, K and the interval between predictions may be configured by the network node 403 and/or defined in the standard.

The prediction of the mobility information may comprise at least an indication of the likelihood or probability of the UE 401 moving to a given cell, beam or coverage of a given RS type, e.g. SSB identifier, CSI-RS identifier, Transmitter/Receiver Point (TRP) for each reported cell/beam/TRP.

Predictions of mobility information, or simply mobility predictions, may be performed by the UE 401 according to configurations, i.e. fields and associated IEs comprising further fields or parameters, included in a measConfig of IE MeasConfig or according to a new field e.g. called predConfig of IE PredConfig comprising the configurations of predictions to be performed and possibly comprising the event configurations whose input for triggering is based on the predictions.

Prediction Model

The mobility information may be predicted in different ways. One way of prediction the mobility information may be by using a prediction model. The UE 401 may choose which prediction model to use amongst a plurality of candidate prediction models. The prediction model may also be referred to as a mobility prediction model, a prediction function or a mobility prediction function.

The UE 401 may receive information indicating the prediction mode from the network nod 403. The prediction model may be implemented as a software function that is provided from the network node 403 to the UE 401, for example, in a procedure where the UE 401 may downloads this software function. An alternative solution may rely on Application Protocol Interfaces (APIs) that may be exposed by the UE 401 to the network node 403, so an entity at the network node side may be able to configure a prediction model at the UE 403. In that case, there may be a procedure where the UE 401 may indicate capability related information to the network node 403, i.e. the UE 401 may indicate to the network node 403 that it can download and/or receive a prediction model from the network node 403, for example, for mobility prediction information. This capability may be related to the software and hardware aspects at the UE 401, availability of sensors, etc. Once the UE 401 has the function available, it may be further configured by the network node 403 to use it e.g. in a measurement configuration like reporting configuration, measurement object configuration, etc.

The network node 403 may take different input from the UE 401 to take a decision concerning the prediction model to provide the UE 401 and/or its configurations. For example, a network node 403, e.g., a BS or a cloud entity, may receive the UEs' measurement reports and use them to train a Neural Network (NN). To train the NN, the network node 403 may use the NN signal measurements, e.g., RSRP, RSRQ or SINR, at instant “t” as input to, and signal measurements at instant “t+X” as output. Thus, the NN may be able to predict the value of this measurement, “X” instants of time in advance. Since a NN may be characterized by the number of layers, number of nodes per layer and the nodes' weights, after the training process, the network node 403 may broadcast the NN parameters to the UE 401 in order to allow the UE 401 to reconstruct the NN and use it to predict future values of a given signal measurement. Since this is an example of supervised learning, from time to time, the network node 403 may update the NN weights based on new UEs' measurement reports. The network node 403 may compare the predicted values at instant “t” to the measured values at instant “t+X” in order to validate if the NN accuracy and to force, if necessary, the NN weights update.

The UE 403 may have stored the prediction model, e.g. a UE proprietary prediction model, to be used when perform the prediction. In that case, the UE 401 may indicate to the network node 403 a capability related to that, i.e. the UE 401 may transmit information indicating that it can perform a certain prediction, e.g. prediction of RSRP/RSRQ/SINR based on SSBs, prediction of RSRP/RSRQ/SINR based on CSI-RS, etc. The UE 501 may transmit its capability to the network node 403 in different levels of granularity such as i) the UE 401 may comprise a prediction model and/or ii) which exact prediction model the UE 401 has available, e.g., out of a list defined in the specifications and/or iii) which kinds of predictions the model(s) the UE 401 has available performs and/or iv) what kinds of input the model(s) the UE 401 has available take into account, etc.

It may be standardized at least one prediction model to be implemented at the UE 401 and configured by the network node 403, with a set of parameters. For example: with a NN, the UE 401 may already know that it will implement a NN of “L” layers, where each layer “i” has “Nᵢ” nodes, and each node “j” has a set of weights “Wⱼ”, but the values of “L”, “Nᵢ” and “Wⱼ” are set by the network node 403. Another possibility may be a Random Forest, where the network node 403 may set the number of estimators, e.g. trees in the forest, the depth of each tree and the threshold of each leaf. A capability may be reported to the network node 403 in different levels of granularity such as i) the UE 401 has a prediction model and/or ii) which exact prediction model the UE 401 has available, e.g., out of a list defined in the specifications and/or iii) which kinds of predictions the model(s) the UE 401 has available performs and/or iv) what kinds of input the model(s) the UE has available take into account, etc.

When it comes to the exact prediction model, one example may be based on a Recurrent Neural Network (RNN). Unlike standard feedforward NNs, a RNN has feedback connections that work as a memory state. This memory state may allow a UE 401 to preserve signal measurement statistics across time steps which may be useful for predicting time series. For example, the UE 401 may feed the RNN with the last “N” signal measurements, e.g., RSRP, RSRQ or SINR, and the RNN may be able to output signal measurements shifted by “Y” measurement periods. To train the RNN, the UE 401 may use a Backpropagation Through Time (BPTT) method. A Long Short-Term Memory (LSTM) architecture may be an example of a RNN that may be used. It learns what to store in the long-term state, what to throw away, and what to read from it.

Parameters Possibly Used by the Prediction Model

As mentioned earlier, the usage of different prediction models may be based on different set of input parameters known by the UE 401.

“Real or current measurements” may be as input parameters to the prediction model such as e.g., RSRP, RSRQ, SINR at a certain point in time TO for the same cells the UE 401 perform predictions, based on an RS type like SSB and/or CSI-RS and/or DRMS), either instantaneous values or filtered values, e.g. with L3 filter parameters configured by RRC, from the serving and/or neighbor cells and/or serving or neighbor beams. The input parameters sensor parameters obtained from sensors, such as UE positioning information, e.g. GPS coordinates, barometric sensor information or other indicators of height, rotation sensors, proximity sensors, and mobility such as, location information, previous connected BSs history, speed and mobility direction, information from mapping/guiding applications (e.g. Google maps, Apple maps.

The input parameters may be in the form of metrics related to UE connection, such as average package delay. The UE 401 may also use input parameters from sensors such as rotation, movement, etc. The input parameters may be route information, e.g. current location, final destination and route etc.

The input parameters may comprise UE mobility history information such as last visited beams, last visited cells, last visited tracking areas, last visited registration areas, last visited RAN areas, last visited PLMNs, last visited countries, last visited cities, last visited states, etc.

The input parameters may comprise time information such as the current time, e.g. 10:15 am, and associated time zone, e.g. 10:15 GMT. That may be relevant if the UE 401 has a predictable trajectory and it is typical that at a certain time the UE 401 is in a certain location.

The UE 401 may be configured, e.g. by the network node 403, via an RRC message, to utilize at least one of the above input parameters as input to the prediction model. The availability of these input parameters, e.g. in case of sensors, the availability at the UE 401 of a sensor, like barometric sensor, may depend on a capability information indicated to the network node 403. If the network node 403 is aware that the UE 401 is capable of performing certain measurements, like based on sensors, and, if the network node 403 is aware that a UE 401 benefits in using a parameter in a prediction model, then the UE 401 may be configured to use at least one of these input parameters in the prediction model for which the network node 403 is configuring the UE 401 to report. In that case, the UE 401 may indicate capability related information to the network node 403, i.e. the UE 401 may indicate to the network node 403 that it can download and/or receive a prediction model from the network nod 403, for example, for mobility prediction information. This capability may be related to the software and hardware aspects at the UE 401, availability of sensors, etc. Once the UE 401 has the function available, it may be further configured by the network node 403 to use it e.g. in a measurement configuration like reporting configuration, measurement object configuration, etc.

Different Types of Predictions/Configurations

The predictions of mobility information may be configured in various ways, regardless of the way the UE 401 implements the prediction model. This means that there may still be some configuration parameters from the network node 403.

The UE 401 may receive information indicating a prediction configuration in an RRC message, e.g. a RRCResume message, a RRCReconfiguration message. The prediction configuration may comprise that the prediction is to be performed using at least one of: a prediction identifier, a reporting configuration identifier associated to a reporting configuration and an object identifier associated to an object configuration. This prediction identifier may be comprised in a message, e.g. the message in step 505, when conditions are fulfilled and predictions may be reported to the network node 403.

The information indicating the prediction configuration may be received in a predConfig field of IE PredConfig in an RRC message, e.g. RRCResume, RRCReconfiguration, comprising the prediction to be performed using at least one of: a prediction identifier represented by a predId of IE PredId, a reporting configuration identifier of field reportConfigId associated to a reporting configuration e.g. field reportConfig of IE ReportConfigNR and an object identifier measObjectId associated to an object configuration e.g. field measObject of IE MeasObjectNR if NR predictions are to be performed. These predictions may be configured using an AddMod list structure, just as the one used for configuring measurements.

The information indicating the prediction configuration may be received in a measConfig field of IE MeasConfig in an RRC message, e.g. RRCResume, RRCReconfiguration, comprising the prediction to be performed using at least one of: a prediction identifier represented by a measId of IE MeasId, a reporting configuration identifier of field reportConfigId associated to a reporting configuration e.g. field reportConfig of IE ReportConfigNR and an object identifier measObjectId associated to an object configuration e.g. field measObject of IE MeasObjectNR if NR predictions are to be performed. These predictions may be configured using an AddMod list structure, just as the one used for configuring measurements.

The UE 401 may predict the mobility information for at least one serving cell the UE 401 has configured, comprising cell level predictions and/or beam level predictions. This may be based on different criteria, depending on the presence or absence of various fields within the message. Predictions of mobility information may be performed only for serving cells for which a parameter is configured, e.g. servingCellMO in MeasObjectNR. An example is shown below:

Whenever the UE 401 has a measConfig, it may perform predictions of mobility information such as e.g. RSRP and RSRQ measurements for each serving cell for which servingCellMO is configured as follows:
If the reportConfig associated with at least one measId comprised in the measIdList within VarMeasConfig comprises an rsType set to ssb and ssb-ConfigMobility is configured in the measObject indicated by the servingCellMO:
   If the reportConfig associated with at least one measId comprised in the measIdList within VarMeasConfig comprises a reportQuantityRS-Indexes and maxNrofRS-IndexesToReport and comprises an rsType set to ssb:
      The UE 401 may perform predictions of layer 3 filtered RSRP and RSRQ per beam for the serving cell based on SS/PBCH block;
      The UE 401 may perform predictions of serving cell measurement results based on SS/PBCH block, as described later.

A beam may be interpreted as an SS/PBCH block, sometimes called SSB. The present disclosure is equally applicable for beams transmitted by other reference signals, such as CSI-RSs, Tracking Reference Signals (TRS), Positioning Reference Signals (PRS), etc.

There may be a different rule for the UE 401 to perform predictions of the SINR for the serving cells, for example, if at least one prediction report comprises a reportConfig whose trigger quantity or reporting quantity is set to SINR. An example is shown below:

For each serving cell for which servingCellMO is configured, if the reportConfig associated with at least one measId comprised in the measIdList within VarMeasConfig comprises SINR as trigger quantity and/or reporting quantity;
If the reportConfig comprises rsType set to ssb and ssb-ConfigMobility is configured in the servingCellMO:
   If the reportConfig comprises a reportQuantityRS-Indexes and maxNrofRS-IndexesToReport:
      The UE 401 may perform predictions of layer 3 filtered SINR per beam for the serving cell based on SS/PBCH block;
      The UE 401 may perform predictions of serving cell SINR measurement results based on SS/PBCH block, as described later below.

The UE 401 may perform predictions of mobility information for at least one neighbor cell associated to a configured frequency, comprising cell level predictions and/or beam level predictions. That may be based on different criteria, depending on the presence or absence of various fields within the message. An example is shown below:

For each measId or predId comprised in the measIdList within VarMeasConfig:
If the measObject is associated to NR and the rsType is set to ssb:
   If reportQuantityRS-Indexes and maxNrofRS-IndexesToReport for the associated reportConfig are configured:
      The UE 401 may perform predictions of layer 3 beam measurements only based on SS/PBCH block for each measurement quantity indicated in reportQuantityRS-Indexes, as described later below;
      The UE 401 may perform predictions of cell measurement results based on SS/PBCH block for the trigger quantity and each measurement quantity indicated in reportQuantityCell using parameters from the associated measObject, as described in later below;

Evaluating Reporting Criteria According to a Condition Whose Input is Based on Predictions of Mobility Information as Performed in Step 501

As described above, the UE 401 determines in step 504 whether one or multiple conditions are fulfilled or not for one or multiple cells. This step 504 will now be described in more detail.

At least part of the predicted mobility information is used as input to the one or multiple conditions. This may also be described as the predictions of mobility information are used as input to the one or multiple condition(s) for event-triggered reports. The UE 401 may be configured by the network node 403 with event configurations where it may be indicated that at least one prediction of mobility information, e.g. predicted RSRP, predicted RSRQ, predicted SINR, may to be used as input to the one or multiple condition(s) for a configured event. The event configurations may be Ax/Bx-like event configurations, e.g. A1, A2, A3, A4, A5, A6, B1 or B2.

The UE determines in step 504 whether one or multiple conditions are fulfilled or not for one or more applicable cells. A condition may also be referred to as an entry condition. The UE 401 may consider that the one or multiple condition is fulfilled if all predictions after layer 3 filtering taken during a time to trigger, e.g. a configured field timeToTrigger, defined for this event are fulfilled.

The UE 401 may maintain entries in a report, e.g. internally within the UE 401, where predictions of mobility information are stored, where that may be associated to a prediction identifier. The prediction identifier may correspond to a measurement identity or measId field.

If there is not yet a reporting entry for this prediction identifier. e.g. for this measId, i.e. when a first cell triggers the event, and if the one or multiple conditions based on the predictions of mobility information is fulfilled, the UE 401 may perform at least one of the following actions:
The UE 401 may include a prediction reporting entry in a UE variable where predictions are stored. A prediction reporting entry may correspond to a measurement reporting entry, e.g. if the predictions are transmitted in a measurement report. The UE variable may be the VarMeasReportList. The prediction identifier may be a measId or a new variable could be defined for predictions e.g. VarPredReportList.
The UE 401 may set the number of messages transmitted in step 505, e.g. field numberOfReportsSent, defined within the VarMeasReportList, or a new variable could be defined for predictions e.g. VarPredReportList, for this prediction identifier, e.g. measId, to 0.
The UE 401 may comprise the concerned cell(s) in the list of triggered cells, e.g. field cellsTriggeredList, defined within the VarMeasReportList or a new variable could be defined for predictions e.g. VarPredReportList for this prediction identifier, e.g. measId.
The UE 401 may initiate a transmission of a message in step 505, e.g. a measurement reporting procedure or a new prediction report procedure, to transmit e.g. the predicted mobility information, current mobility information etc.,

The UE may determine whether one or multiple conditions is fulfilled or not for one or more applicable non-triggered cells, i.e. cells that have not been included yet in a list of cells maintained by the UE 401, e.g. cell triggered list field. Cells in that cell triggered list may be cells whose predictions have fulfilled the one or more conditions for the associated event according to previous paragraph. The UE 401 may consider that the condition is fulfilled if all predictions after layer 3 filtering taken during a time to trigger, e.g. a configured field timeToTrigger, defined for this event, subsequent cell triggers the prediction-based event.

If there is already a reporting entry for this prediction identifier, e.g. for this measId, i.e. when a non-triggered cell triggers the event, and if the condition based on the predictions of mobility information is fulfilled, the UE 401 may perform at least one of the following actions:
The UE 401 may set the number of messages transmitted in step 505, e.g. numberOfReportsSent field, defined within the VarMeasReportList or a new variable could be defined for predictions e.g. VarPredReportList, for this prediction identifier, e.g. measId. to 0;
The UE 401 may comprise the concerned cell(s) in the cellsTriggeredList defined within the VarMeasReportList or a new variable could be defined for predictions e.g. VarPredReportList for this prediction identifier, e.g. measId;
The UE 401 may initiating a transmission of the message in step 505 to transmit e.g. the predictions of mobility information, current mobility information etc.

The UE 401 may be configured to perform the evaluations of at least one of the events: A1, A2, . . . , B1, B2, H1, H2, etc. Any of the events and/or combinations may be configured as part of a reportConfig field of IE ReportConfigNR with a reportConfigId, with an associated object, e.g. measObject of MeasObjectNR IE for NR frequencies, and a predId, which may be a measId.

Fulfilment of One or Multiple Conditions

As described above, step 505 may comprise that, upon the fulfilment of one or multiple conditions, whose input is based on predictions of mobility information, the UE 401 may trigger a reporting procedure. The reporting procedure may also be referred to as transmission of the message.

In the following, details will be provided related to how each event functions when predictions of mobility information are used as input to the one or multiple condition of the events.

Even though the present disclosure shows examples where predicted measurement information comprising cell measurements are used as input parameters to the one or multiple condition(s) being e.g. A1-A6, B1-B2 etc., the present disclosure also applies to predicted measurement information comprising beam measurement predictions or information derived from predictions of beam measurements, e.g. number of beams whose a quantity like RSRP is above a threshold, as input parameters to the one or multiple condition(s).

A1 Event Triggered by Predictions of Mobility Information

The UE 401 may be configured with an A1 event that indicates that prediction of mobility information of a serving cell becomes better than a threshold. The event may be configured as part of a reportConfig field of IE ReportConfigNR with a reportConfigId, with an associated object, e.g. measObject of MeasObjectNR IE for NR frequencies, and a predId, which may be a measId, to indicate to the network node 403 in a message such as a prediction report or measurement report, that predictions of a serving cell with the associated measurement object became better than a configured threshold based on predictions of a measurement quantity and RS type. Or, as described previously, new fields and IEs may be defined for predictions.

Based on these A1 legacy reports, the network node 403 may be able to identify that a serving cell is recovering. Hence, one possible action may be to deactivate or remove possibly configured inter-frequency measurements at the UE 401 that consume UE power and reduces throughput as they may require measurement gaps. Hence, when prediction-based reports are defined herein, that may be done earlier e.g. the network node 403 may remove these measurement configurations based on the report of predictions even before the serving cell becomes good, i.e. the UE 401 may remain performing inter-frequency measurements during an even shorter time and degrades throughput for an even shorter time, since measurement gaps may also be reconfigured earlier. Another possible action based on predictions is that the network node 403 may activate a configured SCell that becomes in good conditions, route traffic via an SCell or PSCell that becomes better, consider that as a candidate for a handover or reconfiguration with sync, e.g. in case that is not the PCell already, re-configure the UE 401 to perform fewer measurements considering that this serving cell is good, i.e. above a threshold, etc.

The definition of Event A1 entry condition based on predictions may be as follows:

For an event A1 based on predictions, i.e. serving cell becomes better than the threshold mentioned above, the UE 401 may perform at least one of the following steps:
1> consider the entering condition for this event to be satisfied when condition A1-1, as specified below, is fulfilled;
1> for this measurement, consider the NR serving cell corresponding to the associated measObjectNR associated with this event.

Ms−Hys>Thresh Inequality A1-1 (condition)

The variables in the formula are defined as follows:
Ms is the predictions of measurement result of the serving cell.
Hys is the hysteresis parameter for this event, i.e. hysteresis as defined within reportConfigNR for this event.
Thresh is the threshold parameter for this event, i.e. a1-Threshold as defined within reportConfigNR for this event.
Ms is expressed in dBm in case of RSRP, or in dB in case of RSRQ and RS-SINR.
Hys is expressed in dB.
Thresh is expressed in the same unit as Ms.

In the above, Ms may correspond to a prediction of mobility information. More precisely, the mobility information may correspond to a measurement result of the serving cell.

There may be different ways to realize the exact triggering of the message transmission based on prediction of mobility information.

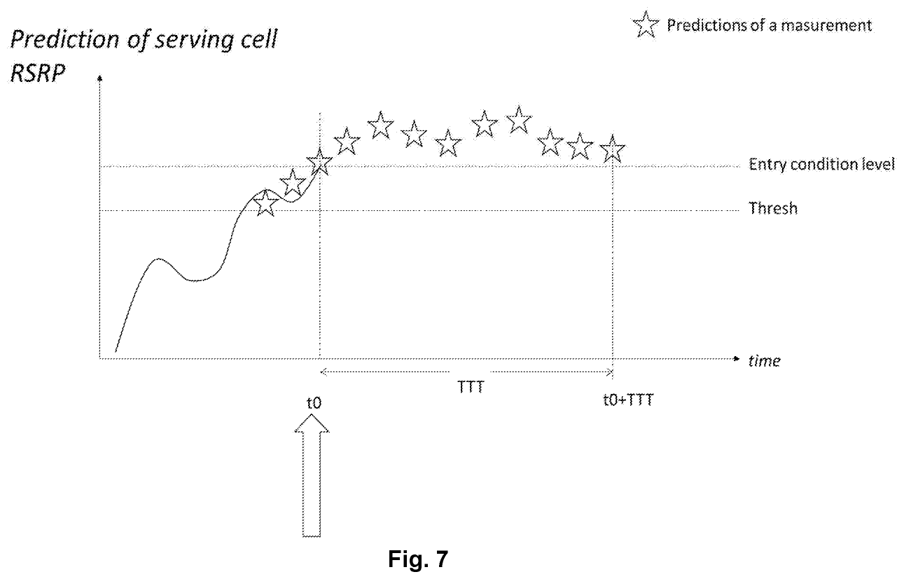

Assuming a trigger quantity like RSRP, just to exemplify—a similar principle applies for other quantities like RSRQ, SINR, the event may be triggered, i.e. one or multiple conditions fulfilled, if all predictions within an interval of TTT range fulfils the condition. That may be implemented as a moving window of TTT size, i.e. at a given time instant the UE 401 may check the predictions for the next N samples onwards and checks if from that sample onwards until TTT all measurement predictions fulfil the condition. Another possible implementation may be that the UE 401 may monitor each prediction at a given timer t0 and, if that fulfils the entry condition the UE 401 may start a timer whose expiration value is TTT so that when the timer expires, i.e. at t0+TTT, and all predictions fulfil the entry condition the event is considered triggered, and the message is transmitted. This is exemplified in the FIG. 7. The x-axis of FIG. 7 represents time and the y-axis represents the prediction of serving cell RSRP. The stars in FIG. 7 represent predictions of a measurement. At t0, the UE 401 detects that all RSRP predictions in the interval [t0, t0+TTT] for the configured serving cell fulfil the one or more conditions for the event. Hence, the event may be considered fulfilled for that serving cell. As it can be seen in FIG. 7, the message is transmitted at t0 since at t0 all predictions, represented by the stars in FIG. 7, from t0 until the TTT fulfil the one or multiple condition. The message may also be referred to as a report.

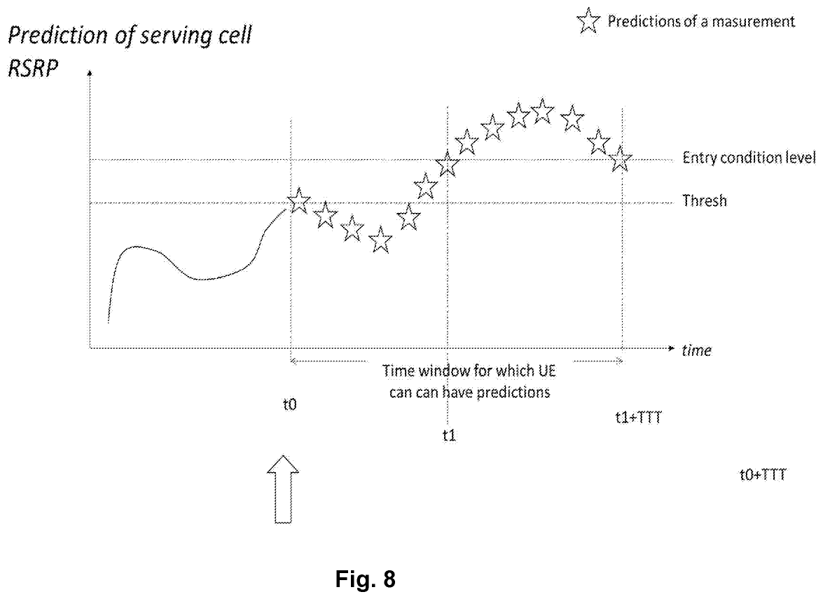

At a time instant, e.g. t0, the UE 401 may predict RSRP or any other quantity for a given time window, which may be pre-defined in the standard, hard coded, or configured by the network, for the serving cell, e.g. the time window may be longer than the configured time to trigger. Then, the one or multiple condition for a given event may be considered fulfilled if all predictions fulfil the condition for a TTT duration, where the starting prediction may be at a time instance greater or equal to t0 e.g. t1, as shown in FIG. 8 for the A1 event. As shown in FIG. 8, at t0, the predictions show that at t1 the entry condition would start to get fulfilled and would remain fulfilled for all measurements after TTT i.e. all predictions of RSRP for the serving cell between t1 and t1+TTT fulfil the entry condition. Hence, at t0 the UE 401 may consider the entry condition for the event as fulfilled. The time value t1 may be comprised in the message associated to that event, e.g. if configured, to indicate to the network node 403 when the event starts to be fulfilled according to the prediction, indicating to the network node 403 how critical it is to take a counter actions from the network node side based on that message. The x-axis of FIG. 8 represents time and the y-axis represents the prediction of serving cell RSRP. The stars seen in FIG. 8 represent predictions of a measurement. In FIG. 8, at t0, the UE 401 may predict RSRP for a given time window. For example, at t0, the predictions show that at t1 the one or multiple condition may start to get fulfilled and may remain fulfilled for all measurements after TTT, i.e. all predictions of RSRP for the serving cell between t1 and t1+TTT fulfil the one or multiple conditions. Hence, at t0 the UE 401 may consider the one or multiple conditions for the event is fulfilled. The time t1 may be comprised in the message as well.

As it may be seen in FIG. 8, the message may be transmitted at t0 based on the prediction that the message would have been sent at t1+TTT, which enables a faster transmission of the information from the UE 401. In another variant, the value of t1 or associated values such as t1-t0 interval may also be configured.

A2 Event Triggered by Predictions of Mobility Information

The UE 401 may be configured with an A2 event that indicates that prediction of mobility information of serving cell becomes worse than the threshold. The event may be configured as part of a reportConfig field of IE ReportConfigNR, with a reportConfigId, with an associated object, e.g. measObject of MeasObjectNR IE for NR frequencies, and a predId, which may be a measId, to indicate to the network node 403 in the message, e.g. a prediction report or a measurement report, that predictions of a serving cell with the associated measurement object are worse than a configured threshold based on predictions of a measurement quantity and RS type.

Upon reception of legacy A2 messages the network node 403 may become aware that a given serving cell, e.g. the SpCell, is getting worse than a threshold. And, if the network node 403 has not received any A3 message for that frequency, the network node 403 may configure inter-frequency measurements to possibly trigger an inter-frequency handover. Then, upon the reception of A2 messages based on predictions of mobility information, such as predictions of measurements, the network node 403 may become aware that a given serving cell, e.g. the SpCell, is likely to get worse than a threshold e.g. within a certain time. And, if the network node 403 has not received any A3 message, also possibly based on predictions and/or measurements for that frequency, the network node 403 may configure earlier inter-frequency measurements to possibly trigger an inter-frequency handover and reduce the chances of radio link failure. That is quite sensitive especially because the first samples may take few 100's of milliseconds until they are reported, hence, configuring earlier inter-frequency measurements or even inter-frequency measurement predictions thanks to the predictions that triggered an A2 event in this scenario may be beneficial. The network node 403 may also balance the risks with the consequences of early inter-frequency measurement configurations, such as the earlier need for measurement gaps, which may reduce throughput, and the higher power needed for inter-frequency measurements. Reported predictions based on A2 messages may also be used to deactivate an active SCell or remove it, also depending on traffic demands. Another possibility may be to give the UE 401 higher priority in scheduling.

The predictions of mobility information in this may be just as described earlier.

The definition of an event A2 condition based on predictions may be as follows:

For an event A2 based on predictions, e.g. the serving cell measurements becomes worse than the threshold, the UE 401 may:
1> consider the entering condition for this event to be satisfied when condition A2-1, as specified below, is fulfilled;
1> for this measurement, consider the serving cell indicated by the measObjectNR associated to this event.

Ms+Hys<Thresh Inequality A2-1 (Entering condition)

The variables in the formula are defined as follows:
Ms is the predictions of measurement result of the serving cell.
Hys is the hysteresis parameter for this event, i.e. hysteresis as defined within reportConfigNR for this event.
Thresh is the threshold parameter for this event, i.e. a2-Threshold as defined within reportConfigNR for this event.
Ms is expressed in dBm in case of RSRP, or in dB in case of RSRQ and RS-SINR.
Hys is expressed in dB.
Thresh is expressed in the same unit as Ms.
Ms may correspond to a prediction of mobility information. More precisely, the mobility information may correspond to a measurement result of the serving cell.

There may be different ways to realize the exact triggering of the message in step 505 based on prediction of mobility information.

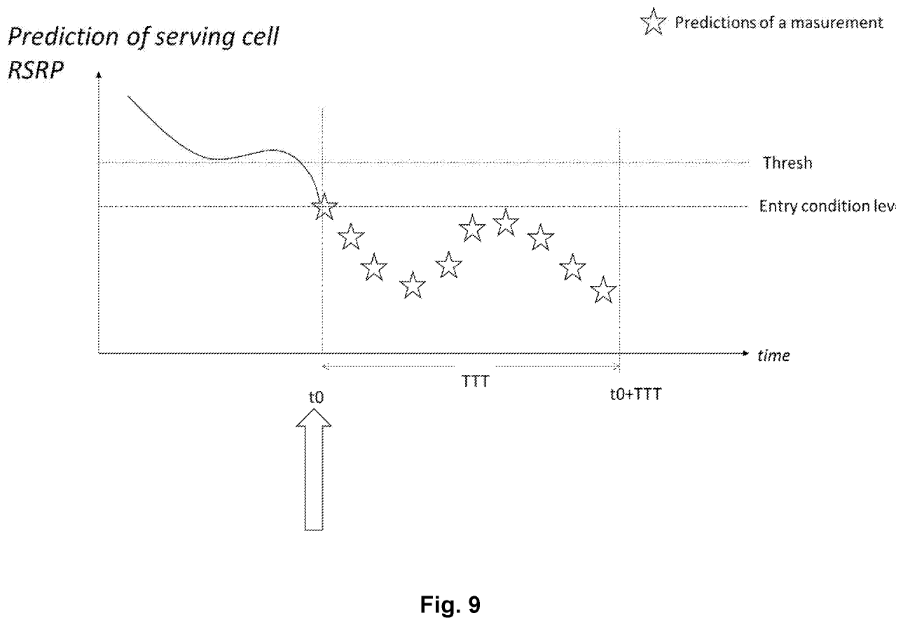

In one example, assuming a trigger quantity like RSRP, the event may be triggered, i.e. one or multiple conditions are fulfilled, if all predictions within an interval of TTT range fulfils the one or multiple conditions. That may be in the form of a moving window of TTT size where, at each measurement performed or configured for predictions, the UE 401 may check the predictions for the next samples onwards and checks if from that sample onwards until TTT all measurement predictions fulfil the entry condition. This is exemplified FIG. 9. The x-axis of FIG. 9 represents time and the y-axis represents the prediction of serving cell RSRP. The stars seen in FIG. 9 represent predictions of a measurement.

As it can be seen form FIG. 9, the message may be transmitted at t0 based on the prediction that the message may have been sent at t0+TTT anyway, which may enable a faster transmission of the information from the UE 401 to the network node 403. At t0, the UE detects that all RSRP predictions in the interval [t0, t0+TTT] for the configured serving cell fulfil the one or multiple conditions for the event. Hence, the event is considered fulfilled for that serving cell.

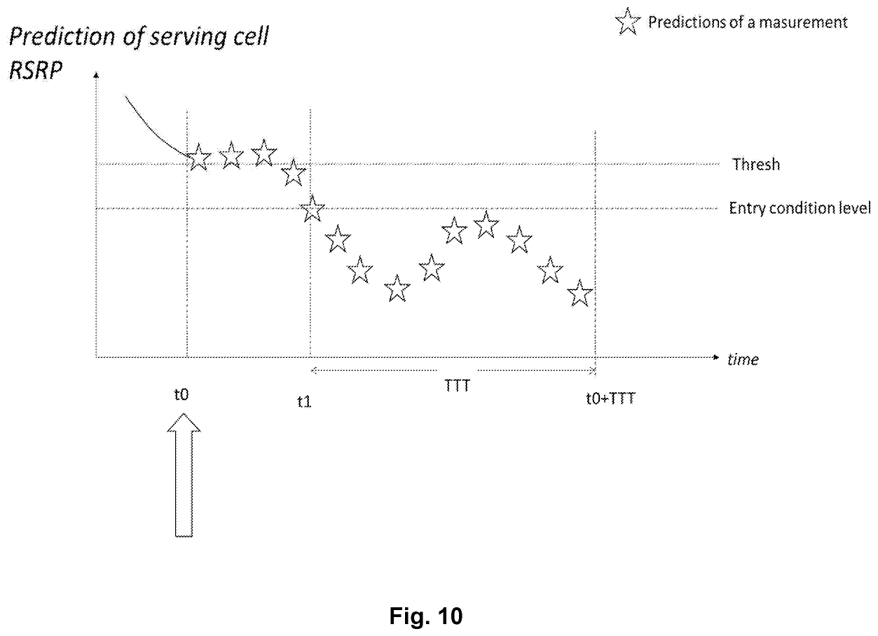

A certain point in time, e.g. t0, the UE 401 may predict RSRP or any other quantity for a given time window, which may be pre-defined in the standard, hard coded, or configured by the network node 403, for the serving cell, where that time window may be longer than the configured time to trigger. Then, the condition for a given event may be considered fulfilled if all predictions fulfil the condition for a TTT where the starting prediction may be at a time instance >=t0 e.g. t1, as shown in FIG. 9. As shown in FIG. 10, at t0, the predictions show that at t1 the one or multiple conditions may start to get fulfilled and may remain fulfilled for all measurements after TTT i.e. all predictions of RSRP for the serving cell between t1 and t1+TTT fulfil the entry condition. Hence, at t0 the UE 401 may consider the one or multiple conditions for the event as fulfilled. The time value t1 may be comprised in the message associated to that event, to indicate to the network node 403 when the event would have started to be fulfilled. In other words, indicating how critical it is to take a counter action from the network node side based on that message.

As it can be seen in FIG. 10, the message may be transmitted at t0 based on the prediction that the message may have been sent at t1+TTT, which enables a faster transmission of the information to the UE 401. In another variant, the value of t1 may also be configured, or something equivalent like a t1-t0 interval.

The x-axis of FIG. 10 represents time and the y-axis represents the prediction of serving cell RSRP. The stars seen in FIG. 10 represent predictions of a measurement. In FIG. 10, at t0, the UE 401 may predict RSRP for a given time window. For example, at t0, the predictions show that at t1 the one or multiple conditions may start to get fulfilled and may remain fulfilled for all measurements after TTT, i.e. all predictions of RSRP for the serving cell between t1 and t1+TTT fulfil the one or multiple conditions. Hence, at t0, the UE 401 may consider the one or multiple conditions for the event as fulfilled. The time t1 may be comprised in the message in step 505.

A3 Event Triggered by Predictions of Mobility Related Information (Entry Condition)

The UE 401 may be configured with an A3 event that indicates that a prediction of mobility information of a neighbor cell becomes offset better than prediction of mobility information SpCell. The term offset better may be described as x−y>off, i.e. x is not just better than y, but it is an offset better than y.

Upon reception of legacy A3 message, the network node 403 may become aware that a given neighbor cell in a given frequency, e.g. same frequency as the SpCell, is getting better than the SpCell for the trigger quantity, which may means that it may be a good candidate for intra-frequency handover, corresponding to a reconfiguration with sync in NR. The given neighbor cell is getting better in that it is getting higher than the one associated to the other cell. Then, upon the reception of a A3 message based on predictions of mobility information, such as predictions of measurements, the network node 403 may become aware in advance that a given neighbor cell may have good potential to be a handover candidate, or PSCell change candidate if the UE 401 is in Multi-Radio Dual Connectivity, so that the network node 403 may prepare a neighbor cell in advance and/or configure conditional handover/conditional reconfiguration for that UE 401. In other words, the triggering may indicate that according to predictions, at a certain point in time there may going to be a neighbor cell in the serving frequency of that SpCell that becomes an offset better than the SpCell. Hence, at that point in time that neighbor cell(s) are strong candidates for a reconfiguration with sync, e.g. handover. That information may be used by the network node 403 to configure conditional handover.

In addition, predictions of beam measurements or information derived from it may be used by the network node 403 to configure contention-free random access resources, as these map to SSBs and/or CSI-RSs. For example, if the UE 401 reports SSB1 and SSB2 as good beams, but also report other ones based on predictions, e.g. SSB4 and SSB7, the network node 403 may configure contention free random access resources also for SSB4 and SSB7 if possible. A good beam may be described as a beam whose measurement results, e.g. RSRP, RSRQ, SINR or any other parameter, is above a threshold.

The predictions of mobility information in this may be just as in the previous examples.

For an event A3 based on predictions only when a neighbour cell becomes offset better than a SpCell, the UE 401 may:
1> consider the entering condition for this event to be satisfied when condition A3-1, as specified below, is fulfilled;
1> use the SpCell for Mp, Ofp and Ocp.
NOTE The cell(s) that triggers the event has reference signals indicated in the measObjectNR associated to this event which may be different from the NR SpCell measObjectNR.

Mn+Ofn+Ocn−Hys>Mp+Ofp+Ocp+Off Inequality A3-1 (Entering condition)

The above two lines describes the term offset better in details. The neighbour results—Serving results A Offset, which is the addition of all other variables.

The variables in the formula may be defined as follows:
Mn is the predictions of measurement result of the neighbouring cell.
Ofn is the measurement object specific offset of the reference signal of the neighbour cell, i.e. offsetMO as defined within measObjectNR corresponding to the neighbour cell.
Ocn is the cell specific offset of the neighbour cell, i.e. cellIndividualOffset as defined within measObjectNR corresponding to the frequency of the neighbour cell, and set to zero if not configured for the neighbour cell.
Mp is predictions of the measurement result of the SpCell.
Ofp is the measurement object specific offset of the SpCell, i.e. offsetMO as defined within measObjectNR corresponding to the SpCell.
Ocp is the cell specific offset of the SpCell, i.e. cellIndividualOffset as defined within measObjectNR corresponding to the SpCell, and is set to zero if not configured for the SpCell.
Hys is the hysteresis parameter for this event, i.e. hysteresis as defined within reportConfigNR for this event.
Off is the offset parameter for this event, i.e. a3-Offset as defined within reportConfigNR for this event.
Mn, Mp are expressed in dBm in case of RSRP, or in dB in case of RSRQ and RS-SINR.
Ofn, Ocn, Ofp, Ocp, Hys, Off are expressed in dB.

As show above, Mn and Mp may correspond to a prediction of mobility information. More precisely, for Mp the mobility information may correspond to a measurement result of the SpCell. For Mn, the mobility information may correspond to a measurement result of the neighbour cell.

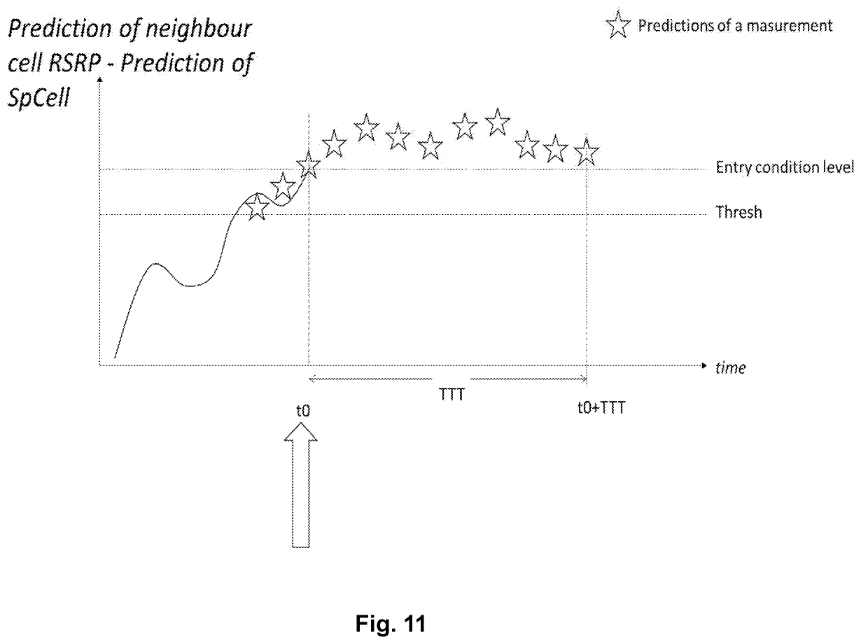

There may be different ways to realize the exact triggering of the message transmission based on prediction of mobility information. Assuming a trigger quantity like RSRP, the event may be triggered, i.e. one or multiple conditions fulfilled, if all predictions within an interval of TTT range fulfils the entry condition. That may be implemented in the UE 401 as a moving window of TTT size where at each measurement performed or configured for predictions, the UE 401 may check the predictions for the next samples onwards and checks if from that sample onwards until TTT all measurement predictions fulfil the entry condition. This is exemplified in FIG. 11. As it can be seen in FIG. 11, the message in step 505 may be transmitted at t0 based on the prediction that the message may have been sent at t0+TTT anyways, which may enable a faster transmission of the information from the UE 401.

The x-axis of FIG. 11 represents time and the y-axis represents prediction of neighbour cell RSRP—Prediction of SPcell. Each star seen in FIG. 11 represents predictions of a measurement. At t0, the UE 401 may detect that all predictions in the interval [t0, t+TTT] for the SpCell and a neighbour cell fulfil the one or multiple conditions for the event, e.g. A3 event. Hence, the event is considered fulfilled.

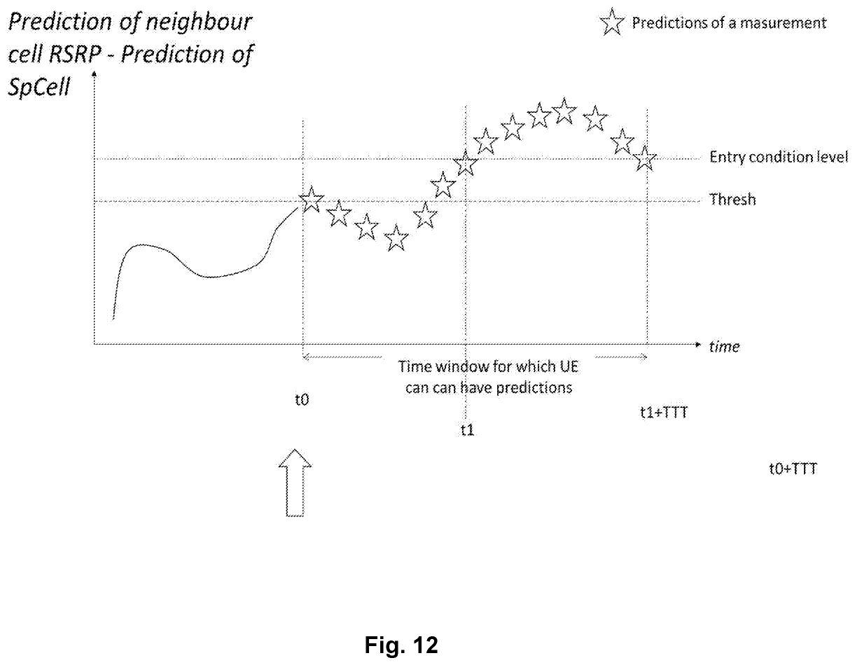

At a certain point in time, e.g. t0, the UE 401 may predict RSRP or any other quantity for a given time window, which may be pre-defined in the standard, hard coded, or configured by the network node 403, for the SpCell and a neighbour cell, at least one, where that time window may be longer than the configured time to trigger. Then, the one or multiple conditions for a given event may be considered fulfilled if all predictions fulfil the condition for at least TTT where the starting prediction may be at a time instance >=t0 e.g. t1, as shown in FIG. 11. As shown in FIG. 12, at t0, the predictions show that at t1 the one or multiple conditions may start to get fulfilled and may remain fulfilled for all measurements after TTT i.e. all predictions of RSRP for the serving cell and neighbour cell(s) between t1 and t1+TTT fulfil the entry condition. Hence, at t0 the UE 401 may consider the one or multiple conditions for the event as fulfilled. The time value t1 may be comprised in the message in step 505 associated to that event, to indicate to the network node 403 when the event would have started to be fulfilled. In other words, indicating how critical it is to take a counter action from the network node side based on that message.

The x-axis of FIG. 12 represents time and the y-axis of FIG. 12 represents a prediction of neighbour cell RSRP—prediction of SpCell. Each star in FIG. 12 represent predictions of a measurement. As it can be seen in FIG. 12, the message may be transmitted at t0 based on the prediction that the message may have been sent at t1+TTT, which enables a faster transmission of the information to the UE 401. The value of t1 may also be configured or something equivalent like a t1-t0 interval. At t0, the UE 401 may predict RSRP for a given time window for neighbours and SpCell. For example, at t0, the predictions show that at t1 the one or multiple conditions may start to get fulfilled and may remain fulfilled for all measurements after TTT, i.e. all predictions of RSRP for SpCell and neighbour cell between t1 and t1+TTT fulfil the one or multiple conditions.

Hence, at t0, the UE 410 may consider the entry condition for the event as fulfilled. The time t1 may be comprised in the message in step 505.

A4 Event Triggered by Predictions of Mobility Related Information (Entry Condition)

The UE 401 may be configured with an A4 event that indicates that prediction of mobility information of neighbor cell becomes better than a threshold. Better than a threshold may also be described as being above the threshold. The event may be configured as part of a reportConfig field of IE ReportConfigNR with a reportConfigId, with an associated object, e.g. measObject of MeasObjectNR IE for NR frequencies, and a predId, which may be a measId, to indicate to the network node 403 in a message in step 505, e.g. a prediction report, e.g. a measurement report, that predictions of a neighbor cell with the associated measurement object became better than a configured threshold based on predictions of a measurement quantity and RS type.

Based on these A4 prediction-based messages, the network node 403 may take educated actions for mobility load balancing. For example, if the network node 403 may configure the UE 401 to transmit predicted mobility information associated to a frequency Fx, e.g. by configuring an object associated to Fx, the UE 401 may perform predictions of mobility information in frequency Fx, e.g. predictions of measurements in Fx for neighbor cells, and when the predictions fulfill one or multiple condition(s), the UE 401 may report the predicted mobility information to the network node 403. Upon receiving these predictions, the network node 403 may be able to identify that a given neighbor in frequency Fx may be a good candidate for mobility load balancing and/or multi-radio dual connectivity for an SN in frequency Fx. That may be known in advance compared to legacy A4 events, so that the target for mobility load balance may be prepared in advanced, e.g. via conditional handover, or the target for PSCell addition may be prepared in advanced so that the time to speed up DC becomes shorter, which is a quite critical time. The longer it takes, the less useful it is as many packets may have been transmitted in the single link. Other possible updates comprise re-configuration of measurement configuration, etc.

The definition of Event A4 entry condition based on predictions may be as follows:

For an event A4 based on predictions where the neighbour cell becomes better, i.e. higher or above, than threshold, the UE 401 may:
1> consider the entering condition for this event to be satisfied when condition A4-1, as specified below, is fulfilled;

Mn+Ofn+Ocn−Hys>Thresh Inequality A4-1 (Entering condition)

The variables in the formula are defined as follows:
Mn is the predictions of the measurement result of the neighbouring cell.
Ofn is the measurement object specific offset of the neighbour cell, i.e. offsetMO as defined within measObjectNR corresponding to the neighbour cell.
Ocn is the measurement object specific offset of the neighbour cell. i.e. cellIndividualOffset as defined within measObjectNR corresponding to the neighbour cell, and set to zero if not configured for the neighbour cell.
Hys is the hysteresis parameter for this event, i.e. hysteresis as defined within reportConfigNR for this event.
Thresh is the threshold parameter for this event, i.e. a4-Threshold as defined within reportConfigNR for this event.
Mn is expressed in dBm in case of RSRP, or in dB in case of RSRQ and RS-SINR.
Ofn, Ocn, Hys are expressed in dB.
Thresh is expressed in the same unit as Mn.

Mn may correspond to a prediction of mobility related information. More precisely, the mobility information may correspond to a measurement result of the neighbour cell.

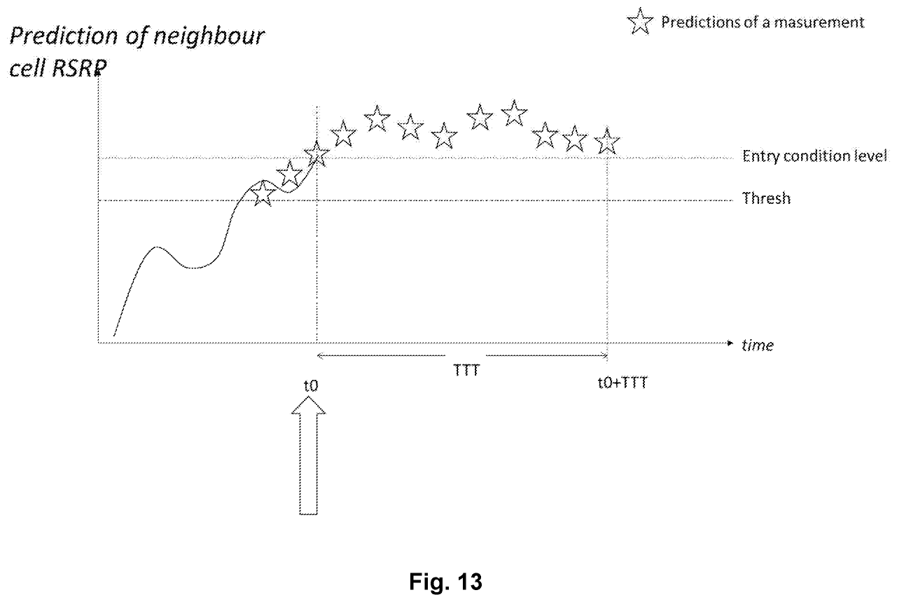

Triggering of the message transmission based on predicted mobility information may be performed in different ways. For example, assuming a trigger quantity like RSRP, the event may be triggered. i.e. the one or multiple condition is fulfilled, if all predictions within an interval of TTT range fulfils the one or multiple condition. That may in the form of a moving window of TTT size where at each measurement performed or configured for predictions, the UE 401 may check the predictions for the next samples onwards and check if from that sample onwards until TTT all measurement predictions fulfil the entry condition. This is exemplified in FIG. 13. In FIG. 13, at t0, the UE 401 may detect that all RSRP predictions in the interval [t0, t0+TTT] for a neighbour cell fulfil the one or multiple conditions for the event. Hence, the event may be considered fulfilled. The x-axis of FIG. 13 represents time and the y-axis represents prediction of neighbour cell RSRP. Each star in FIG. 13 represent predictions of a measurement.

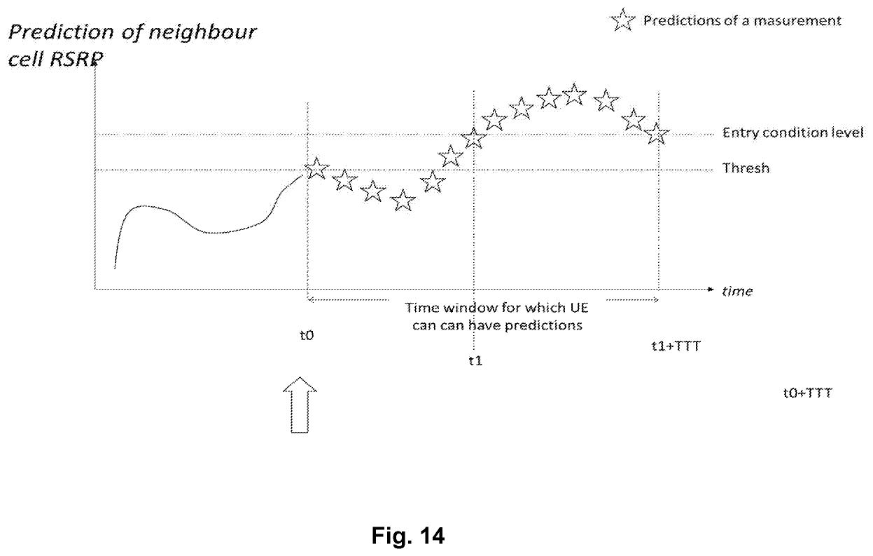

At a time instant, e.g. t0, the UE 401 may predict RSRP or any other quantity for a given time window, which may be pre-defined in the standard, hard coded, or configured by the network node 403, for the serving cell, where that time window may be longer than the configured time to trigger. Then, the one or multiple conditions for a given event may be considered fulfilled if all predictions fulfil the entry condition for a TTT where the starting prediction may be at a time instance greater or equal to t0 e.g. t1, as shown in the FIG. 14 for A4 event. As shown in FIG. 14, at t0, the predictions show that at t1 the one or multiple conditions may start to get fulfilled and may remain fulfilled for all measurements after TTT i.e. all predictions of RSRP for the neighbour cell between t1 and t1+TTT fulfil the one or multiple conditions. Hence, at t0 the UE 401 may consider the entry condition for the event as fulfilled. The time value t1 may be comprised in the message in step 505 associated to that event, e.g. if configured, to indicate to the network node 403 when the event starts to be fulfilled according to the prediction. In other words, indicating to the network node 403 how critical it is to take counter actions from the network node side based on that message. The x-axis of FIG. 14 represents time and the y-axis represents prediction of neighbour cell RSRP. Each star in FIG. 14 represent predictions of a measurement.

In FIG. 14, at t0, the UE 401 may predict RSRP for a given time window. For example, at t0, the predictions show that at t1 the one or multiple conditions may start to get fulfilled and may remain fulfilled for all measurements after TTT, i.e. all predictions of RSRP between t1 and t1+TTT fulfil the one or multiple conditions. Hence, at t0, the UE 401 may consider the one or multiple conditions for the event as fulfilled. The time t1 may be comprised in the message in step 505.

As it can be seen from FIG. 14, the message in step 505 may be transmitted at t0 based on the prediction that the message may have been sent at t1+TTT, which enables a faster transmission of the information to the UE 401. The value of t1 may also be configured or something equivalent like a t1-t0 interval. The associated measurement object may be in the same frequency or in a different frequency than any serving frequency.

A5 Event Triggered by Predictions of Mobility Related Information (Entry Condition) The UE 401 may be configured with an A5 event that indicates that prediction of mobility information for the SpCell becomes worse than a first threshold and prediction of mobility information neighbor becomes better, i.e. higher or above, than a second threshold. Worse than the threshold may be described as being lower or below the threshold. There may be or may not be an association between the first threshold and the second threshold. The event may be configured as part of a reportConfig field of IE ReportConfigNR with a reportConfigId, with an associated object, e.g. measObject of MeasObjectNR IE for NR frequencies, and a predId, which may be a measId, to indicate to the network node 403 in the message in step 505, e.g. a measurement report, that predictions of an SpCell with the associated measurement object became worse than a configured threshold based on predictions of a measurement quantity and RS type; while at the same time (sort of an AND condition) predictions of a neighbor cell becomes better than a threshold2.

Legacy A5 messages may be used for inter-frequency handover e.g. if A3 or A4 is not configured. For example, the network node 403 may like to know when the SpCell degrades at the same time a given neighbor in another frequency becomes above a threshold, indicating that the neighbor may be a good candidate for an inter-frequency handover. Hence, with A5 messages being triggered by predictions of measurements rather than measurements, the network node 403 may know that situation in advance and either prepare inter-frequency cells, e.g. resources, and/or understand in advance whether inter-frequency handovers are really required, which may improve the connection reliability.

The predictions of mobility information in this may be just as in the previous example.

For the event A5 based on predictions where the SpCell becomes worse than a first threshold and the neighbour becomes better than a second threshold, then the UE 401 may:
1> consider the entering condition for this event to be satisfied when both condition A5-1 and condition A5-2, as specified below, are fulfilled;
1> use the SpCell for Mp.
NOTE: The parameters of the reference signal(s) of the cell(s) that triggers the event are indicated in the measObjectNR associated to the event which may be different from the measObjectNR of the NR SpCell.

Mp+Hys<Thresh1 Inequality A5-1 (Entering condition 1)

Mn+Ofn+Ocn−Hys>Thresh2 Inequality A5-2 (Entering condition 2)

The variables in the formula are defined as follows:
Mp is the predictions of the measurement result of the NR SpCell, not taking into account any offsets.
Mn is the predictions of the measurement result of the neighbouring cell, not taking into account any offsets.
Ofn is the measurement object specific offset of the neighbour cell, i.e. offsetMO as defined within measObjectNR corresponding to the neighbour cell.
Ocn is the cell specific offset of the neighbour cell, i.e. cellIndividualOffset as defined within measObjectNR corresponding to the neighbour cell, and set to zero if not configured for the neighbour cell.
Hys is the hysteresis parameter for this event, i.e. hysteresis as defined within reportConfigNR for this event.
Thresh1 is the threshold parameter for this event, i.e. a5-Threshold1 as defined within reportConfigNR for this event.
Thresh2 is the threshold parameter for this event, i.e. a5-Threshold2 as defined within reportConfigNR for this event.
Mn, Mp are expressed in dBm in case of RSRP, or in dB in case of RSRQ and RS-SINR.
Ofn, Ocn, Hys are expressed in dB.
Thresh1 is expressed in the same unit as Mp.
Thresh2 is expressed in the same unit as Mn.

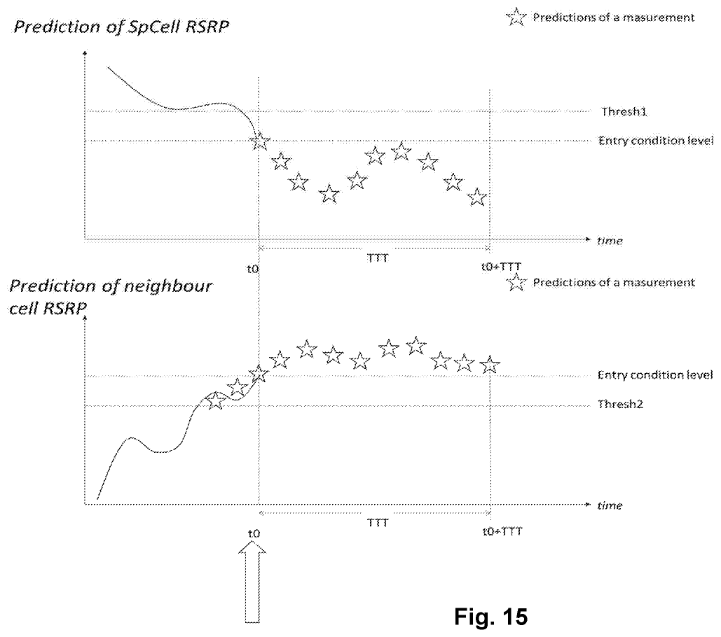

Assuming a trigger quantity like RSRP, the event may be triggered, i.e. by that one or multiple conditions are fulfilled, if all predictions within an interval of TTT range fulfil the one or multiple conditions. In the case of an A5 event, that means that all predictions of measurement results, e.g. RSRP, for the SpCell associated to the reporting configuration are below the first threshold 1 and all predictions of measurement results, e.g. RSRP, for a neighbour cell associated to the reporting configuration are below the second threshold. That may be in the form of a moving window of TTT size where at each measurement performed or configured for predictions, the UE 401 may check the predictions for the next samples onwards and checks if from that sample onwards until TTT all measurement predictions fulfil the entry condition. This is exemplified in FIG. 15. The top graph of FIG. 15 represents the prediction of SpCell RSRP and the bottom graph in FIG. 15 represents the prediction of neighbour cell RSRP. The x-axis of FIG. 15 may represents time and the y-axis represent prediction of SpCell, e.g. RSRP for the top graph and the neighbour cell RSRP for the bottom graph. Each star in FIG. 15 represents predictions of a measurement.

In FIG. 15, at t0, the UE 401 detects that all RSRP predictions in the time interval [t0, t0+TTT] for the SpCell and the neighbour cell ma fulfil the one or multiple conditions for the event. Hence, the even may be considered fulfilled. As it can be seen in FIG. 15, the message in step 505 may be transmitted at t0 based on the prediction that the message may have been sent at t0+TTT anyways, which may enable a faster transmission of the information from the UE 401.

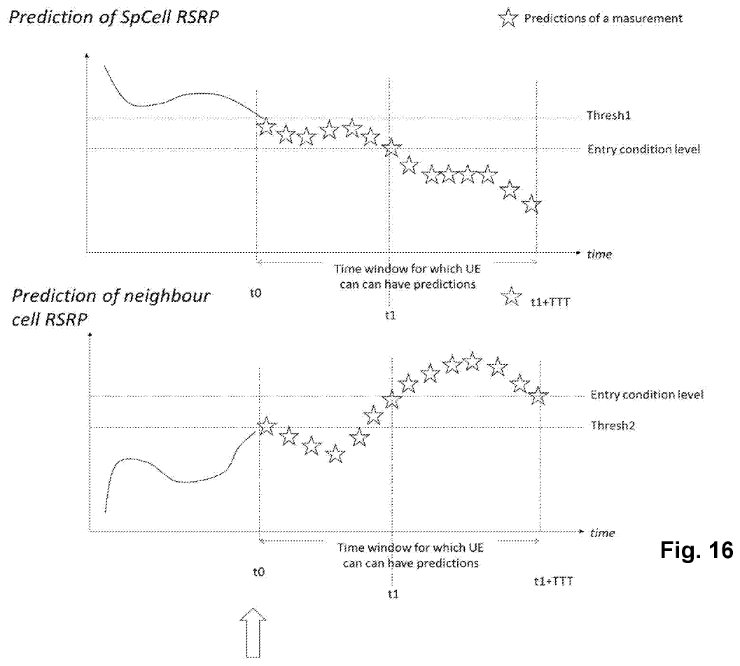

At a certain point in time, e.g. t0, the UE 401 may predict RSRP or any other quantity for a given time window which may be pre-defined in the standard, hard coded, or configured by the network node 403, for the SpCell and at least one neighbour cell, where that time window may be longer than the configured time to trigger. Then, the one or multiple conditions for a given event may be considered fulfilled if all predictions fulfil the entry condition for a TTT where the starting prediction may be at a time instance >=t0 e.g. t1 (as shown above). As shown in FIG. 16, at t0, the predictions show that at t1 the entry condition may start to get fulfilled and may remain fulfilled for all measurements after TTT i.e. all predictions of RSRP for the serving cell between t1 and t1+TTT fulfil the entry condition. Hence, at t0 the UE 401 may consider the entry condition for the event as fulfilled. The time value t1 may be comprised in the message in step 505 associated to that event, to indicate to the network node 403 when the event may have started to be fulfilled. In other words, indicating how critical it is to take a counter action from the network node side based on that message.

The top graph in FIG. 16 represents the prediction of SpCell RSRP and the bottom graph in FIG. 16 represents the prediction of neighbour cell RSRP. The x-axis of FIG. 16 represents time and the y-axis represents prediction of SpCell RSRP and neighbour cell RSRP, respectively. In FIG. 16, at t0, the UE 401 may predict RSRP for a given time window. For example, at t0, the predictions may show that at t1, the one or multiple conditions may start to get fulfilled and may remain fulfilled for all measurements after TTT, i.e. all predictions of RSRP for the SpCell between t1 and t1+TTT fulfil the one or multiple conditions and all predictions of RSRP for the neighbour cell between t1 and t1+TTT fulfil the one or multiple conditions. Hence, at t0, the UE 401 may consider the one or multiple conditions for the event as fulfilled. The time t1 may be comprised in the message in step 505.

A6 Event Triggered by Predictions of Mobility Related Information (Entry Condition)

The UE 401 may be configured with an A6 event that indicates that prediction of mobility information for a neighbor cell(s) becomes offset better than for a SCell. The term offset better is described in more detail earlier. The event may be configured as part of a reportConfig field of IE ReportConfigNR, with a reportConfigId, with an associated object, e.g. measObject of MeasObjectNR IE for NR frequencies, and a predId, which may be a measId, to indicate to the network node 403 in the message in step 505, e.g. a prediction report or a measurement report, that predictions of a serving cell, with the associated measurement object, became better than, i.e. above or higher than, a configured threshold based on predictions of a measurement quantity and RS type.

The reception of a legacy report associated to an A6 event to the network node 403, e.g. a serving gNB, may indicate that the UE 401 may have detected that a neighbor cell in a serving frequency has better quality e.g. better or higher RSRP, RSRQ or and/or SINR, that a configured SCell in that same frequency, which may indicate to the network node 403 that the network node 403 may remove that SCell and add a new one in that frequency and/or activate/deactivate SCells. With the message transmitted based on predictions that might be known in advance, i.e., before the throughput event degrades. For example, the network node 403 may already add a given SCell in a deactivated state and only later activated to speed up the time to start operating in the new SCell.

The predictions of mobility information in this may be just as in the previous examples. For the event A6 based on predictions where the neighbour cell becomes offset better than SCell, the UE 401 may:
1> consider the entering condition for this event to be satisfied when condition A6-1, as specified below, is fulfilled;
1> for this measurement, consider the (secondary) cell corresponding to the measObjectNR associated to this event to be the serving cell.
NOTE: The reference signal(s) of the neighbour(s) and the reference signal(s) of the SCell are both indicated in the associated measObjectNR.

Mn+Ocn−Hys>Ms+Ocs+Off Inequality A6-1 (Entering condition)

The variables in the formula are defined as follows:
Mn is the prediction of measurement result of the neighbouring cell, not taking into account any offsets.
Ocn is the cell specific offset of the neighbour cell, i.e. cellIndividualOffset as defined within the associated measObjectNR, and set to zero if not configured for the neighbour cell.
Ms is the prediction of measurement result of the serving cell, not taking into account any offsets.
Ocs is the cell specific offset of the serving cell, i.e. cellIndividualOffset as defined within the associated measObjectNR, and is set to zero if not configured for the serving cell.
Hys is the hysteresis parameter for this event, i.e. hysteresis as defined within reportConfigNR for this event).
Off is the offset parameter for this event, i.e. a6-Offset as defined within reportConfigNR for this event.
Mn, Ms are expressed in dBm in case of RSRP, or in dB in case of RSRQ and RS-SINR.
Ocn, Ocs, Hys, Off are expressed in dB.

Mn and Ms may correspond to a prediction of mobility information. For Ms, the mobility information may correspond to a measurement result of an SCell, and for Mn the mobility information may correspond to a measurement result of the neighbour cell.

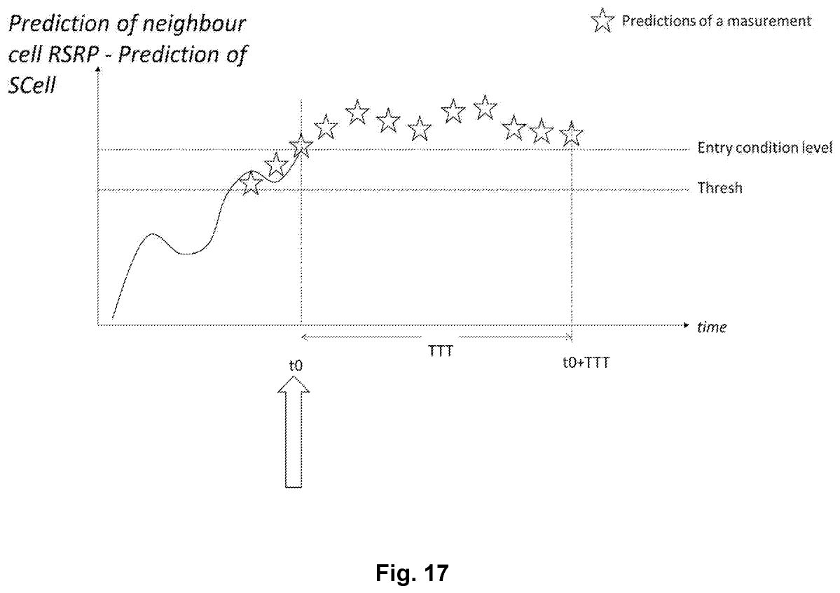

There may be different ways to trigger the transmission of the message in step 505 based on prediction of mobility related information. Assuming a trigger quantity like RSRP, the event may be triggered, i.e. one or multiple conditions are fulfilled, if all predictions within an interval of TTT range fulfil the one or multiple conditions. That may be in the form of a moving window of TTT size where at each measurement performed or configured for predictions, the UE 401 may check the predictions for the next samples onwards and checks if from that sample onwards until TTT all measurement predictions fulfil the entry condition. This is exemplified in the FIG. 17. As it can be seen from FIG. 17, the message in step 505 in FIG. 5 may be transmitted at t0 based on the prediction that the message may have been sent at t0+TTT anyways, which may enable a faster transmission of the information from the UE 401. At t0, the UE 401 may detect that all predictions in the interval [t0, t0+TTT] for the SCell and a neighbour cell fulfil the one or multiple conditions for the event. Hence, the event may be considered fulfilled.

The x-axis of FIG. 17 represents the time and the y-axis represent a prediction of neighbour cell RSRP—prediction of SCell. Each star in FIG. 17 represents predictions of a measurement.

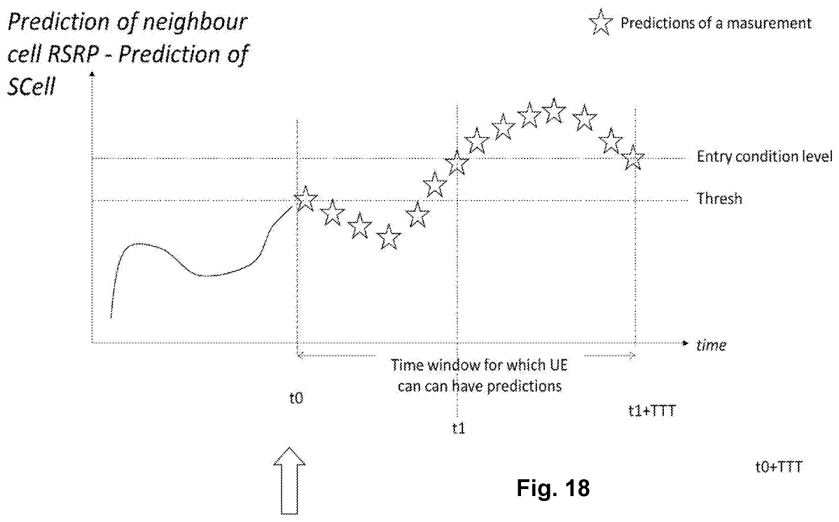

At a certain point in time, e.g. t0, the UE 401 may predict RSRP or any other quantity for a given time window, which may be pre-defined in the standard, hard coded, or configured by the network, for the SCell and at least one neighbour cell, where that time window may be longer than the configured time to trigger. Then, the entry condition for a given event may be considered fulfilled if all predictions fulfil the entry condition for a TTT where the starting prediction may be at a time instance >=t0 e.g. t1, as shown in FIG. 17. As shown in FIG. 18, at t0, the predictions show that at t1 the entry condition may start to get fulfilled and may remain fulfilled for all measurements after TTT i.e. all predictions of RSRP for the serving cell between t1 and t1+TTT fulfil the entry condition. Hence, at t0 the UE 401 may consider the one or multiple conditions for the event as fulfilled. The time value t1 may be comprised in the message in step 505 associated to that event, to indicate to the network node 403 when the event may have started to be fulfilled. In other words, indicating how critical it may be to take counter actions from the network node side based on that message.

As it can be seen form FIG. 18, the message may be transmitted at t0 based on the prediction that the message may have been sent at t1+TTT, which may enable a faster transmission of the information to the UE 401. The value of t1 may also be configured or something equivalent like a t1-0 interval.

In FIG. 18, at t0, the UE 401 may predict RSRP for a given time window for neighbour cells and SpCells. For example, at t0, the predictions may show that at t1 the one or multiple conditions may start to get fulfilled and may remain fulfilled for all measurements after TTT, i.e. all predictions of RSRP for SCell and neighbour cell between t1 and t1+TTT fulfil the one or multiple conditions. Hence, at t0 the UE 401 may consider the one or multiple conditions for the event as fulfilled. The time t1 may be comprised in the message in step 505.

The x-axis of FIG. 18 represents time and the y-axis represents prediction of neighbour cell RSRP—prediction of SCell. Each star in FIG. 18 represents predictions of a measurement.

Inter-RAT events like B1 and B2 follows the same principles.

Other Aspects which May be Applicable to any Event

When there are multiple conditions used in step 504, also referred to as entry condition, each condition may be linked by a logical AND. The condition may be associated to an event triggered event such as events A1, A2, A3, A4, A5, A6, B1, B2, etc. The conditions here may be distinguished by that they are based at least on predictions. For example, the condition based on predictions of mobility information may be considered fulfilled when a combination of event configurations is fulfilled where the combination may be any of the following:
A3 AND A3, e.g. A3 (trigger quantity=RSRP)+A3 (trigger quantity=RSRQ); or any other combination of trigger quantities e.g. RSRP and SINR.
A3 AND A5, with various different configurations;
A5 AND A5, with various different configurations;
Any other combinations.

This may also be formulated as follows:
Ax AND Ay, with x, y being integers from 1 to 6, with various different configurations;
Bx AND By, with x, y being integers from 1 to 2, with various different configurations;
Ax AND By, with x, y being integers from 1 to 6, with various different configurations.

In case of multiple conditions, each condition may be linked by a logical OR. The condition may be associated to an event triggered event such as events A1, A2, A3, A4, A5, A6, B1, B2, etc., where the conditions here may be distinguished by that they are based at least on predictions. For example, the condition based on predictions of mobility information may be considered fulfilled when at last one of events in a combination of events configured to the UE 401 and associate do a single identifier/indication is fulfilled, where the combination may be any of these:
A3 OR A3, e.g. A3 (trigger quantity=RSRP)+A3 (trigger quantity=RSRQ); or any other combination of trigger quantities e.g. RSRP and SINR.
A3 OR A5, with various different configurations;
A5 OR A5, with various different configurations;
Other combinations.

This may also be formulated as follows:
Ax OR Ay, with x, y being integers from 1 to 6, with various different configurations;
Bx OR By, with x, y being integers from 1 to 2, with various different configurations;
Ax OR By, with x, y being integers from 1 to 6, with various different configurations;

The monitoring of the condition(s) may be configured by the network node 403. For example, the UE 401 may perform the evaluation of events, i.e. monitoring, upon receiving an event-triggered reporting configuration by a network node 403 such as a reportConfig of IE ReportConfigNR associated to a measObject of IE MeasObjectNR and a measId of IE MeasId, etc.

The measurement predictions may be filtered using L3 filtering, where prediction filtering parameters may be configured by the network node 403. Parameters of the filtering configuration may be equivalent to the ones defined in QuantityConfig IE.

Transmitting the Message—Step 505

In step 505, the results of the predictions of mobility information may be transferred from the UE 401 to the network node 401. The UE 401 may initiate the transfer only after successful AS security activation.

For the prediction indication or identifier, like a predid, or a measId used for purpose, for which the transmission was triggered, the UE 401 may set a field, e.g. predMeasResults or measResults within the PredictionReport or MeasurementReport, message, according to at least one of the following rules.

Transmitting Predictions of Mobility Information Associated to Serving Cells

The transmission of predictions of mobility information for configured serving cells, at least one of the following steps may be performed by the UE 401:
Set the prediction identity, e.g. measId, predId, etc., to the prediction identity in the message that triggered the message. The message may need to comprise a prediction identification so that the network node 403 may be able to understand which predictions this is, among the ones the network node 403 has configured the UE 401 to perform.
For each serving cell, e.g. configured with servingCellMO, if the predictions of serving cell measurements based on the RS type comprised in the message transmission configuration that triggered the message are available, set a field, e.g. predMeasResultServingCell or measResultServingCell, if that field is used for that purpose, within measResultServingMOList, or predMeasResultServingMOList, to comprise the predicted RSRP, RSRQ and the available predicted SINR of the serving cell, derived based on the rsType comprised in the reportConfig that triggered the message;
Set a serving cell identifier in the message to indicate to the network node 403 which cell is associated to the reported predictions, as there may be multiple serving cells e.g. SpCell for Master Cell Group (MCG), SpCell for Secondary Cell Group (SCG), and SCells associated to the MCG, and SCells associated to the SCG.
For at least a serving cell, possibly based on a specific configuration like presence of a servingCellMO field, comprise beam measurement information based on measurement predictions according to the associated reportConfig;

Transmitting Predictions of Mobility Information for Best Neighbour Cells on Serving Frequencies

For transmission of predictions of mobility information for best neighbours, i.e. with highest quality, in at least one serving frequency, at least one of the following actions may be performed by the UE 401:
Transmitting the message may be performing only if a specific configuration is provided e.g. a flag in reporting configuration or measurement object indicating that UE reports best neighbours in that serving frequency;
Set the field defined for that message, e.g. predMeasResultBestNeighCell or measResultBestNeighCell, within predMeasResultServingMOList or measResultServingMOList, to comprise the physCellId and the available predictions of measurement quantities based on the reportQuantityCell and rsType indicated in reportConfig of the non-serving cell corresponding to the concerned measObjectNR with the highest predicted measured RSRP if predictions of RSRP measurement results are available for cells corresponding to this measObjectNR, otherwise with the highest predictions of measured RSRQ if predictions of RSRQ measurement results are available for cells corresponding to this measObjectNR, otherwise with the highest predicted measured SINR;
Including beam measurement information based on measurement predictions according to the associated message transmission configuration;

Transmitting a Message Comprising Predictions of Mobility Information for Cells while the UE 401 is Configured with Multi-Radio Dual Connectivity, e.g. MR-DC, NR-DC, EN-DC, Etc.

If the UE 401 is in NR-DC and the prediction configuration, e.g. measurement configuration, that triggered the message in step 505, e.g. prediction report or measurement report, is associated with the MCG, the UE 401 may set the field for including SCG measurements, e.g. predMeasResultServFreqListNR-SCG or measResultServFreqListNR-SCG, to include for each NR SCG serving cell, e.g. that is configured with servingCellMO, if any, the following:
If the reporting configuration, e.g. reportConfig, associated with the prediction identifier, e.g. predId, that triggered the transmission of the message comprises an RS type field e.g. rsType.
   And, if the predictions of serving cell measurements based on the RS Type, e.g. rsType, comprised in the reporting configuration, e.g. reportConfig, that triggered the transmission of the message are available according to the measurement configuration associated with the SCG:
      The field for serving cells may be set, e.g. predMeasResultServingCell or measResultServingCell, within measResultServFreqListNR-SCG or equivalent to include predictions of RSRP, RSRQ and the available predictions of SINR of the serving cell, derived based on the rsType included in the reportConfig that triggered the message;
   If predictions of SSB based serving cell measurements are available according to the measurement configuration associated with the SCG, the measResultServingCell within measResultServFreqListNR-SCG may be set to include predictions of RSRP, RSRQ and the available predictions of SINR of the serving cell, derived based on SSB;
      Else if predictions of CSI-RS based serving cell measurements are available according to the measurement configuration associated with the SCG:
         The measResultServingCell within measResultServFreqListNR-SCG may be set to comprise predictions of RSRP, RSRQ and the available predictions of SINR of the serving cell, derived based on CSI-RS;
      If predictions of results for the serving cell derived based on SSB are included, the ssbFrequency may be included to the value indicated by ssbFrequency as included in the MeasObjectNR of the serving cell;
      If predictions of results for the serving cell derived based on CSI-RS are included, the refFreqCSI-RS may be included to the value indicated by refFreqCSI-RS as included in the MeasObjectNR of the serving cell;
      If the reportConfig associated with the measId that triggered the measurement reporting includes reportQuantityRS-Indexes and maxNrofRS-IndexesToReport, then for each serving cell configured with servingCellMO, beam measurement information may be included based on measurement predictions according to the associated reportConfig as described above, where availability is considered according to the measurement configuration associated with the SCG.

Transmitting the Message Comprising Predictions of Mobility Information for Neighbour Cells

For each cell included, predictions of the layer 3 filtered measured results may be comprised in accordance with the reporting configuration, e.g. reportConfig, for this prediction identifier, e.g. predId or measId, according to at least one of the following actions:

If the prediction object or measurement object, like a measObject associated with this prediction identifier, e.g. predId or measId concerns NR, if RS type, e.g. rsType, in the associated reporting configuration, e.g. reportConfig, is set to ssb:
The field for SSB based predictions per cell, e.g. resultsSSB-Cellwithin the measResult or preMeasResult, may be set to comprise the predictions of SS/PBCH block based quantity(ies) indicated in the reportQuantityCell within the concerned reportConfig, in decreasing order of the sorting quantity e.g. with the best cell is included first;
If reportQuantityRS-Indexes and maxNrofRS-IndexesToReport are configured or equivalents for predictions, then beam measurement information based on beam measurement predictions may be comprised in the message.

Once the content of the message is set, the UE 401 may submit a report of the message, e.g. PreMeasurementReport or MeasurementReport, to lower layers for transmission, upon which the procedure ends.

Beam reporting for the serving cell may be used by the network node 403 to indicate which downlink beams may be configured/re-configured in a serving cell for beam management related procedures such as TCI state configurations/re-configurations/activations/deactivations, beam switching, Radio Link Monitoring, beam reporting, beam failure detection configuration, beam failure recovery configuration, configuration of contention-free random access resources, mapped to downlink beams, etc. If in addition to the beam measurements the network node 403 may obtain predictions concerning beam measurement information the network node 403 may be able to make more educated decisions concerning these procedures. For example, in the case of contention-free random access resources, the network node 403 may decide not to configure resources associated to a given beam that is reported as a good one, but whose predictions show that it may become worse after k*X seconds, which may be when the UE 401 tries to perform random access.

Example of an Implementation in the RRC Specifications

There may be ways the method can be specified in RRC for NR RRC specifications. That reporting configuration, i.e. the message transmission configuration, may be associated to a measurement object and to a measurement identifier or measurement prediction identifier that may enable the network node 403 to quickly detect this is a prediction message, that may be handled differently from a measurement report, that is included in the message to enable the network node 403 to identify what event has triggered a given prediction report. The associated measurement object may indicate to the UE 401 in which frequency the UE 401 may perform the predictions. In other words, it indicates which ARFCN the SS/PBCH Block (SSB) needs to be searched and detected, so the UE 401 may perform the measurement predictions.

The reporting configuration for the predictions may be configured in a field predReportConfig of IE PredReportConfigNR, that may have a somewhat similar structure to the existing ReportConfigNR, except that it may refer to prediction of measurements, rather than real measurements, i.e. all fields mat still be applicable. The reporting configuration or the predictions may be configured in the field reportConfig of IE ReportConfigNR, that may need to be an extended version including additional configuration, which may be done for example one of the following ways:
The additional configuration may be a new report type within ReportConfigNR, indicating that the reporting configuration is about predictions, instead of measurements. That additional configuration may be a flag indicating that the reporting configuration is about predictions, instead of measurements (see the example below)

One example of how that may be captured in RRC is shown below, starting from the ASN.1 encoding of messages, fields and IE and procedure text:

ReportConfigNR

The IE ReportConfigNR specifies criteria for triggering of an NR measurement reporting event or an NR prediction reportinq event. Measurement reporting events are based on cell measurement results, which can either be derived based on SS/PBCH block or CSI-RS. These events are labelled AN with N equal to 1, 2 and so on. Measurement prediction reportinq events are based on predictions of cell measurement results, which can either be derived based on cell measurements based on SS/PBCH block or CSI-RS.
Event A1: Serving becomes better than absolute threshold;
Event A2: Serving becomes worse than absolute threshold;
Event A3: Neighbour becomes amount of offset better than PCell/PSCell;
Event A4: Neighbour becomes better than absolute threshold;
Event A5: PCell/PSCell becomes worse than absolute threshold1 AND Neighbour/SCell becomes better than another absolute threshold2;
Event A6: Neighbour becomes amount of offset better than SCell.

ReportConfigNR information element

| | |
|---|---|
| -- ASN1START | |
| -- TAG-REPORTCONFIGNR-START | |
| ReportConfigNR : := | SEQUENCE { |
| reportType | CHOICE { |
| periodical | PeriodicalReportConfig, |
| eventTrigged | EventTriggerConfig, |
| . . . , | |
| reportCGI | ReportCGI, |
| [ [ | |
| report SFTD | Report SFTD-NR |
| ] ] | |
| } | |
| } | |
| ReportCGI : := | SEQUENCE { |
| cellForWhichToReportCGI | PhysCellId, |
| . . . | |
| } | |
| Report SFTD-NR : : = | SEQUENCE { |
| reportSFTD-Meas | BOOLEAN, |
| reportRSRP | BOOLEAN, |
| . . . | |
| } | |
| EventTriggerConfig: := | SEQUENCE { |
| eventId | CHOICE { |
| eventA1 | SEQUENCE { |
| a1-Threshold | MeasTriggerQuantity, |
| reportOnLeave | BOOLEAN, |
| hysteresis | Hysteresis, |
| timeToTrigger | TimeToTrigger |
| }, | |
| eventA2 | SEQUENCE { |
| a2-Threshold | MeasTriggerQuantity, |
| reportOnLeave | BOOLEAN, |
| hysteresis | Hysteresis, |
| timeToTrigger | TimeToTrigger |
| }, | |
| eventA3 | SEQUENCE { |
| a3-Offset | MeasTriggerQuantityOffset, |
| reportOnLeave | BOOLEAN, |
| hysteresis | Hysteresis, |
| timeToTrigger | TimeToTrigger, |
| useWhiteCellList | BOOLEAN |
| }, | |
| eventA4 | SEQUENCE { |
| a4-Threshold | MeasTriggerQuantity, |
| reportOnLeave | BOOLEAN, |
| hysteresis | Hysteresis, |
| timeToTrigger | TimeToTrigger, |
| useWhiteCellList | BOOLEAN |
| }, | |
| eventA5 | SEQUENCE { |
| a5-Threshold1 | MeasTriggerQuantity, |
| a5-Threshold2 | MeasTriggerQuantity, |
| reportOnLeave | BOOLEAN, |
| hysteresis | Hysteresis, |
| timeToTrigger | TimeToTrigger, |
| useWhiteCellList | BOOLEAN |
| }, | |
| eventA6 | SEQUENCE { |
| a6-Offset | MeasTriggerQuantityOffset, |
| report OnLeave | BOOLEAN, |
| hysteresis | Hysteresis, |
| timeToTrigger | TimeToTrigger, |
| useWhiteCellList | BOOLEAN |
| }, | |
| . . . | |
| }, | |
| rsType | NR-RS-Type, |
| report Interval | Report Interval, |
| reportAmount | ENUMERATED {r1, r2, r4, r8, r16, r32, r64, |
| infinity}, | |
| reportQuantityCell | MeasReportQuantity, |
| maxReportCells | INTEGER (1. . maxCellReport), |
| reportQuantityRS-Indexes | MeasReportQuantity |
| OPTIONAL, -- Need R | |
| maxNrofRS-IndexesToReport | INTEGER (1. . maxNrofIndexesToReport) |
| OPTIONAL, -- Need R | |
| includeBeamMeasurements | BOOLEAN, |
| reportAddNeighMeas | ENUMERATED {setup} |
| OPTIONAL, -- Need R | |
| [ | |
| triggerBasedOnPredictions | BOOLEAN, |
| ] | |
| . . . | |
| } | |

According to the example above of ASN.1 code for the ReportConfigIE, if the parameter triggerBasedOnPredictions is set to TRUE or other equivalent parameter, the UE 401 may perform measurement predictions and may use predictions as input to entry and/or leaving conditions associated to each event being configured. That may be according to the associated measurement object and measId or any other type of report identifier e.g. a prediction identifier defined by a new field called predId or IE PredId.

According to the example above of ASN.1 code for the ReportConfigIE, at least one of the parameters within ReportConfigNR, e.g. includeBeamMeasurements, may be interpreted from a prediction perspective, as follows:
For example, the field rsType of IE NR-RS-Type may indicate to the UE 401 that predictions based on the configured RS type, e.g. ssb, are to be used as input for the entry/leaving condition of the configured event.
For example, the field reportInterval of IE ReportInterval may indicates to the UE 401 the reporting interval between predictions that are being reported.
Other parameters are described in the following field description, as shown below.

EventTriggerConfig field descriptions
a3-Offset/a6-Offset
Offset value(s) to be used in NR measurement or prediction report triggering condition for
event a3/a6. The actual value is field value * 0.5 dB.
aN-ThresholdM
Threshold value associated to the selected trigger quantity (e.g. RSRP, RSRQ, SINR) per
RS Type (e.g. SS/PBCH block, CSI-RS) to be used in NR measurement or prediction
report triggering condition for event number aN. If multiple thresholds are defined for event
number aN, the thresholds are differentiated by M. The network configures aN-Threshold1
only for events A1, A2, A4, A5 and a5-Threshold2 only for event A5. In the same eventA5,
the network configures the same quantity for the Meas TriggerQuantity of the a5-
Threshold1 and for the Meas TriggerQuantity of the a5-Threshold2.
eventId
Choice of NR event triggered reporting criteria.
maxNrofRS-Indexes ToReport
Max number of RS indexes to include in the measurement or prediction report for A1-A6
events. If this is a prediction report, this indicates the max number of predicted RS indexes
to include in the prediction report.
maxReportCells
Max number of non-serving cells to include in the measurement or prediction report. If this
is a prediction report, this indicates the max number of predicted cells to be included in the
prediction report.
reportAddNeighMeas
Indicates that the UE shall include the best neighbour cells per serving frequency. If this is
a prediction report, this indicates that the UE shall include in the prediction report the best
predicted neighbour cells per serving frequency.
reportAmount
Number of measurement reports or prediction reports applicable for eventTriggered as well
as for periodical report types.
reportOnLeave
Indicates whether or not the UE shall initiate the measurement reporting procedure when
the leaving condition is met for a cell in cells TriggeredList. If this is a prediction report, this
indicates whether or not the UE shall initiate the prediction reporting procedure when the
leaving condition is met for a cell in cells TriggeredList for a prediction (not a
measurement).
reportQuantityCell
The cell measurement quantities to be included in the measurement report or the predicted
cell measurement quantities to be included in the prediction report.
reportQuantityRS-Indexes
Indicates which measurement information per RS index the UE shall include in the
measurement report. If this is a prediction report, indicates which predicted information per
RS index the UE shall include in the prediction report.
time To Trigger
Time during which specific criteria for the event needs to be met in order to trigger a
measurement report or a prediction report.
useWhiteCellList
Indicates whether only the cells included in the white-list of the associated measObject are
applicable.

An example of procedure text implementing this may be as follows:

### 5.5.3 Performing Measurements

### 5.5.3.1 General

An RRC_CONNECTED UE shall derive and/or predict cell measurement results by measuring one or multiple beams associated per cell as configured by the network, 3. For all cell measurement results and/or predictions in RRC_CONNECTED the UE applies the layer 3 filtering as specified in 5.5.3.2, before using the predicted and/or measured results for evaluation of reporting criteria and measurement/prediction reporting. For cell measurements and/or cell measurement predictions, the network can configure RSRP, RSRQ or SINR as trigger quantity. Reporting quantities can be any combination of quantities (i.e. only RSRP; only RSRQ; only SINR; RSRP and RSRQ; RSRP and SINR; RSRQ and SINR; RSRP, RSRQ and SINR), irrespective of the trigger quantity.

The network may also configure the UE to report measurement or predicted information per beam (which can either be measurement results or predictions per beam with respective beam identifier(s) or only beam identifier(s)) associated to predicted measurements, derived. If beam measurement information is configured to be included in measurement and/or prediction reports, the UE applies the layer 3 beam filtering. On the other hand, the exact L1 filtering of beam measurements used to derive cell measurement results is implementation dependent.

The UE shall:
1> whenever the UE has a measConfig, perform RSRP and RSRQ measurements for each serving cell for which servingCellMO is configured as follows:
   2> if the reportConfig associated with at least one measId included in the measIdList within VarMeasConfig contains an rsType set to ssb and ssb-ConfigMobility is configured in the measObject indicated by the servingCellMO:
      3> if the reportConfig associated with at least one measId included in the measIdList within VarMeasConfig contains a reportQuantityRS-Indexes and maxNrojRS-IndexesToReport and contains an rsType set to ssb:
         4> derive layer 3 filtered RSRP and RSRQ per beam for the serving cell based on SS/PBCH block;
      3> if the reportConfig associated with at least one measId included in the measIdList within VarMeasConfig has the triggerBasedOnPredictions set to ‘true’:
         4> derive layer 3 filtered predictions for RSRP and RSRQ per beam for the serving cell based on SS/PBCH block;
      3> derive serving cell measurement results based on SS/PBCH block;
   2> if the reportConfig associated with at least one measId included in the measIdList within VarMeasConfig contains an rsType set to ssb and ssb-ConfigMobility is configured in the measObject indicated by the servingCellMO and with the flag triggerBasedOnPredictions set to ‘true’:
      3> derive prediction(s) of serving cell measurement results based on SS/PBCH block;
      [ . . . ]//CSI-RS handling has been omitted but similar handling is foreseen as the one defined above for SSB measurements
1> for each serving cell for which servingCellMO is configured, if the reportConfig associated with at least one measId included in the measIdList within VarMeasConfig contains SINR as trigger quantity and/or reporting quantity:
   2> if the reportConfig contains rsType set to ssb and ssb-ConfigMobility is configured in the servingCellMO:
      3> if the reportConfigcontains a reportQuantityRS-Indexes and maxNrofRS-IndexesToReport:
         4> derive layer 3 filtered SINR per beam for the serving cell based on SS/PBCH block;
      3> derive serving cell SINR based on SS/PBCH block;
   2> if the reportConfig contains rsType set to ssb and ssb-ConfigMobility is configured in the servingCellMO and the flag triggerBasedOnPredictions set to ‘true’:
      3> if the reportConfig contains a reportQuantityRS-Indexes and maxNrofRS-IndexesToReport:
         4> derive prediction(s) layer 3 filtered SINR per beam for the serving cell based on SS/PBCH block;
      3> derive predictions of serving cell SINR based on SS/PBCH block;
      [ . . . ]//CSI-RS handling has been omitted but similar handling is foreseen as the one defined above for SSB measurements
1> for each measId included in the measIdList within VarMeasConfig:
   [ . . . ]
   2> if the reportType for the associated reportConfig is periodical or eventTriggered:
      3> if a measurement gap configuration is setup, or
      3> if the UE does not require measurement gaps to perform the concerned measurements:
         4> if s-MeasureConfig is not configured, or
         4> if s-MeasureConfig is set to ssb-RSRP and the NR SpCell RSRP based on SS/PBCH block, after layer 3 filtering, is lower than ssb-RSRP, or
         4> if s-MeasureConfig is set to csi-RSRP and the NR SpCell RSRP based on CSI-RS, after layer 3 filtering, is lower than csi-RSRP:
         [ . . . ]
         5> if the measObject is associated to NR and the rsType is set to ssb:
         6> if reportQuantityRS-Indexes and maxNrojRS-IndexesToReport for the associated reportConfig are configured:
         7> derive layer 3 beam measurements only based on SS/PBCH block for each measurement quantity indicated in reportQuantityRS-Indexes;
         6> derive cell measurement results based on SS/PBCH block for the trigger quantity and each measurement quantity indicated in reportQuantityCell using parameters from the associated measObject,
         6> if the associated reportConfig has triggerBasedOnPredictions set to ‘true’:
         7> if reportQuantityRS-Indexes and maxNrofRS-IndexesToReport for the associated reportConfig are configured:
         8> predict layer 3 beam measurements only based on SS/PBCH block for each quantity indicated in reportQuantityRS-Indexes;
         7> predict cell measurement results based on SS/PBCH block for the trigger quantity and each quantity indicated in reportQuantityCell using parameters from the associated measObject:
         [ . . . ]
   2> perform the evaluation of reporting criteria as specified in 5.5.4.
[ . . . ]

### 5.5.4 Measurement Report Triggering

### 5.5.4.1 General

If AS security has been activated successfully, the UE shall:
1> for each measId included in the measIdList within VarMeasConfig:
   2> if the corresponding reportConfig includes a reportType set to eventTriggered or periodical:
      3> if the corresponding measObject concerns NR:
         4> if the eventA1 or eventA2 is configured in the corresponding reportConfig:
         5> consider only the serving cell to be applicable;
         4> if the eventA3 or eventA5 is configured in the corresponding reportConfig:
         5> if a serving cell is associated with a measObjectNR and neighbours are associated with another measObjectNR, consider any serving cell associated with the other measObectNR to be a neighbouring cell as well;
         4> if corresponding reportConfig includes reportType set to periodical; or
         4> for measurement events other than eventA1 or eventA2:
         5> if useWhiteCellList is set to true:
         6> consider any neighbouring cell detected based on parameters in the associated measObjectNR to be applicable when the concerned cell is included in the whiteCellsToAddModList defined within the VarMeasConfig for this measId;
         5> else:
         6> consider any neighbouring cell detected based on parameters in the associated measObjectNR to be applicable when the concerned cell is not included in the blackCellsToAddModList defined within the VarMeasConfig for this measId;
      [ . . . ]
   2> if the reportType is set to eventTriggered and if the entry condition applicable for this event, i.e. the event corresponding with the eventId of the corresponding reportConfig within VarMeasConfig, is fulfilled for one or more applicable cells for all measurements after layer 3 filtering taken during timeToTrigger defined for this event within the VarMeasConfig, while the VarMeasReportList does not include a measurement reporting entry for this measId (a first cell triggers the event):
      3> include a measurement reporting entry within the VarMeasReportList for this measId;
      3> set the numberOfReportsSent defined within the VarMeasReportList for this measId to 0;
      3> include the concerned cell(s) in the cellsTriggeredList defined within the VarMeasReportList for this measId;
      3> initiate the measurement reporting procedure;
   2> if triggerBasedOnPredictions is set to ‘true’:
      3> if the reportType is set to eventTriggered and if the entry condition applicable for this event, i.e. the event corresponding with the eventId of the corresponding reportConfig within VarMeasConfig, is fulfilled for one or more applicable cells for all predictions after layer 3 filtering taken during timeToTrigger defined for this event within the VarMeasConfig, while the VarMeasReportList does not include a measurement reporting entry for this measId (a first cell triggers the event):
         4> include a prediction reporting entry within the VarMeasReportList for this measId:
         4> set the numberOfReportsSent defined within the VarMeasReportList for this measId to 0:
         4> include the concerned cell(s) in the cellsTriggeredList defined within the VarMeasReportList for this measId;
         4> initiate the measurement reporting procedure, as specified in 5.5.5;
      3> else if the reportType is set to eventTriggered and if the entry condition applicable for this event, i.e. the event corresponding with the eventId of the corresponding reportConfig within VarMeasConfig, is fulfilled for one or more applicable cells not included in the cellsTriggeredList for all predictions after layer 3 filtering taken during timeToTrigger defined for this event within the VarMeasConfig (a subsequent cell triggers the event):
         4> set the numberOfReportsSent defined within the VarMeasReportList for this measId to 0:
         4> include the concerned cell(s) in the cellsTriggeredList defined within the VarMeasReportList for this measId;
         4> initiate the measurement reporting procedure, as specified in 5.5.5;
      3> else if the reportType is set to eventTriggered and if the leaving condition applicable for this event is fulfilled for one or more of the cells included in the cellsTriggeredList defined within the VarMeasReportList for this measId for all predictions after layer 3 filtering taken during timeToTrigger defined within the VarMeasConfig for this event:
         4> remove the concerned cell(s) in the cellsTriggeredList defined within the VarMeasReportList for this measId;
         4> if reportOnLeave is set to true for the corresponding reporting configuration:
         5> initiate the measurement reporting procedure, as specified in 5.5.5;
         4> if the cellsTriggeredList defined within the VarMeasReportList for this measId is empty:
         5> remove the prediction reporting entry within the VarMeasReportList for this measId:
         5> stop the periodical reporting timer for this measId, if running;
   2> else if the reportType is set to eventTriggered and if the entry condition applicable for this event, i.e. the event corresponding with the eventId of the corresponding reportConfig within VarMeasConfig, is fulfilled for one or more applicable cells not included in the cellsTriggeredList for all measurements after layer 3 filtering taken during timeToTrigger defined for this event within the VarMeasConfig (a subsequent cell triggers the event):
      3> set the numberOfReportsSent defined within the VarMeasReportList for this measId to 0;
      3> include the concerned cell(s) in the cellsTriggeredList defined within the VarMeasReportList for this measId;
      3> initiate the measurement reporting procedure, as specified in 5.5.5;
   2> else if the reportType is set to eventTriggered and if the leaving condition applicable for this event is fulfilled for one or more of the cells included in the cellsTriggeredList defined within the VarMeasReportList for this measId for all measurements after layer 3 filtering taken during timeToTrigger defined within the VarMeasConfig for this event:
      3> remove the concerned cell(s) in the cellsTriggeredList defined within the VarMeasReportList for this measId;
      3> if reportOnLeave is set to true for the corresponding reporting configuration:
         4> initiate the measurement reporting procedure, as specified in 5.5.5;
      3> if the cellsTriggeredList defined within the VarMeasReportList for this measId is empty:
         4> remove the measurement reporting entry within the VarMeasReportList for this measId;
         4> stop the periodical reporting timer for this measId, if running;
   2> if reportType is set to periodical and if a (first) measurement result is available:
      3> include a measurement reporting entry within the VarMeasReportList for this measId;
      3> set the numberOfReportsSent defined within the VarMeasReportList for this measId to 0;
      3> if the reportAmount exceeds 1:
         4> initiate the measurement reporting procedure, as specified in 5.5.5, immediately after the quantity to be reported becomes available for the NR SpCell;
      3> else (i.e. the reportAmount is equal to 1):
         4> initiate the measurement reporting procedure, as specified in 5.5.5, immediately after the quantity to be reported becomes available for the NR SpCell and for the strongest cell among the applicable cells;
   2> upon expiry of the periodical reporting timer for this measId:
      3> initiate the measurement reporting procedure, as specified in 5.5.5.
   2> if the corresponding reportConfig includes a reportType is set to reportSFTD:
      3> if the corresponding measObject concerns NR:
         4> if the drx-SFTD-NeighMeas is included:
         5> if the quantity to be reported becomes available for each requested pair of PCell and NR cell:
         6> stop timer T322;
         6> initiate the measurement reporting procedure, as specified in 5.5.5;
         4> else
         5> initiate the measurement reporting procedure, as specified in 5.5.5, immediately after the quantity to be reported becomes available for each requested pair of PCell and NR cell or the maximal measurement reporting delay as specified in TS 38.133 [14];
      3> else if the corresponding measObject concerns E-UTRA:
         4> initiate the measurement reporting procedure, as specified in 5.5.5, immediately after the quantity to be reported becomes available for the pair of PCell and E-UTRA PSCell or the maximal measurement reporting delay as specified in TS 38.133 [14];
   2> if reportType is set to reportCGI:
      3> if the UE acquired the SIB1 or SystemInformationBlockType1 for the requested cell; or
      3> if the UE detects that the requested NR cell is not transmitting SIB1 (see TS 38.213 [13], clause 13):
         4> stop timer T321;
         4> include a measurement reporting entry within the VarMeasReportList for this measId;
         4> set the numberOfReportsSent defined within the VarMeasReportList for this measId to 0;
         4> initiate the measurement reporting procedure, as specified in 5.5.5;
   2> upon the expiry of T321 for this measId:
      3> include a measurement reporting entry within the VarMeasReportList for this measId;
      3> set the numberOfReportsSent defined within the VarMeasReportList for this measId to 0;
      3> initiate the measurement reporting procedure, as specified in 5.5.5.
   2> upon the expiry of T322 for this measId:
      3> initiate the measurement reporting procedure, as specified in 5.5.5;
         5.5.4.2 Event A1 (Serving Becomes Better than Threshold)

The UE shall:
1> consider the entering condition for this event to be satisfied when condition A1-1, as specified below, is fulfilled;
1> consider the leaving condition for this event to be satisfied when condition A1-2, as specified below, is fulfilled;
1> for this measurement, consider the NR serving cell corresponding to the associated measObjectNR associated with this event.

Ms−Hys>Thresh Inequality A1-1 (Entering condition)

Ms+Hys<Thresh Inequality A1-2 (Leaving condition)

The variables in the formula are defined as follows:
Ms is the measurement result of the serving cell, not taking into account any offsets. If triggerBasedOnPredictions is set to ‘true’, the variable corresponds to the predictions of measurement result of the serving cell.
Hys is the hysteresis parameter for this event (i.e. hysteresis as defined within reportConfigNR for this event).
Thresh is the threshold parameter for this event (i.e. a1-Threshold as defined within reportConfigNR for this event).
Ms is expressed in dBm in case of RSRP, or in dB in case of RSRQ and RS-SINR.
Hys is expressed in dB.
Thresh is expressed in the same unit as Ms.
   5.5.4.3 Event A2 (Serving Becomes Worse than Threshold)

The UE shall:
1> consider the entering condition for this event to be satisfied when condition A2-1, as specified below, is fulfilled;
1> consider the leaving condition for this event to be satisfied when condition A2-2, as specified below, is fulfilled;
1> for this measurement, consider the serving cell indicated by the measObjectNR associated to this event.

Ms+Hys<Thresh Inequality A2-1 (Entering condition)

Ms−Hys>Thresh Inequality A2-2 (Leaving condition)

The variables in the formula are defined as follows:
Ms is the measurement result of the serving cell, not taking into account any offsets. If triggerBasedOnPredictions is set to ‘true’, the variable corresponds to the predictions of measurement result of the serving cell.
Hys is the hysteresis parameter for this event (i.e. hysteresis as defined within reportConfigNR for this event).
Thresh is the threshold parameter for this event (i.e. a2-Threshold as defined within reportConfigNR for this event).
Ms is expressed in dBm in case of RSRP, or in dB in case of RSRQ and RS-SINR.
Hys is expressed in dB.
Thresh is expressed in the same unit as Ms.
   5.5.4.4 Event A3 (Neighbour becomes offset better than SpCell)

The UE shall:
1> consider the entering condition for this event to be satisfied when condition A3-1, as specified below, is fulfilled;
1> consider the leaving condition for this event to be satisfied when condition A3-2, as specified below, is fulfilled;
1> use the SpCell for Mp, Ofp and Ocp.
NOTE The cell(s) that triggers the event has reference signals indicated in the measObjectNR associated to this event which may be different from the NR SpCell measObjectNR.

Mn+Ofn+Ocn−Hys>Mp+Ofp+Ocp+Off Inequality A3-1 (Entering condition)

Mn+Ofn+Ocn+Hys<Mp+Ofp+Ocp+Off Inequality A3-2 (Leaving condition)

The variables in the formula are defined as follows:
Mn is the measurement result of the neighbouring cell, not taking into account any offsets. If triggerBasedOnPredictions is set to ‘true’, the variable corresponds to the predictions of measurement result of the neighbouring cell.
Ofn is the measurement object specific offset of the reference signal of the neighbour cell (i.e. offsetMO as defined within measObjectNR corresponding to the neighbour cell).
Ocn is the cell specific offset of the neighbour cell (i.e. cellIndividualOffset as defined within measObjectNR corresponding to the frequency of the neighbour cell), and set to zero if not configured for the neighbour cell.
Mp is the measurement result of the SpCell, not taking into account any offsets. If triggerBasedOnPredictions is set to ‘true’, the variable corresponds to the predictions of the measurement result of the SpCell.
Ofp is the measurement object specific offset of the SpCell (i.e. offsetMO as defined within measObjectNR corresponding to the SpCell).
Ocp is the cell specific offset of the SpCell (i.e. cellIndividualOffset as defined within measObjectNR corresponding to the SpCell), and is set to zero if not configured for the SpCell.
Hys is the hysteresis parameter for this event (i.e. hysteresis as defined within reportConfigNR for this event).
Off is the offset parameter for this event (i.e. a3-Offset as defined within reportConfigNR for this event).
Mn, Mp are expressed in dBm in case of RSRP, or in dB in case of RSRQ and RS-SINR.
Ofn, Ocn, Ofp, Ocp, Hys, Off are expressed in dB.
   5.5.4.5 Event A4 (Neighbour Becomes Better than Threshold)

The UE shall:
1> consider the entering condition for this event to be satisfied when condition A4-1, as specified below, is fulfilled;
1> consider the leaving condition for this event to be satisfied when condition A4-2, as specified below, is fulfilled.

Mn+Ofn+Ocn−Hys>Thresh Inequality A4-1 (Entering condition)

Mn+Ofn+Ocn+Hys<Thresh Inequality A4-2 (Leaving condition)

The variables in the formula are defined as follows:
Mn is the measurement result of the neighbouring cell, not taking into account any offsets. If triggerBasedOnPredictions is set to ‘true’, the variable corresponds to the predictions of the measurement result of the neighbouring cell.
Ofn is the measurement object specific offset of the neighbour cell (i.e. offsetMO as defined within measObjectNR corresponding to the neighbour cell).
Ocn is the measurement object specific offset of the neighbour cell (i.e. cellIndividualOffset as defined within measObjectNR corresponding to the neighbour cell), and set to zero if not configured for the neighbour cell.
Hys is the hysteresis parameter for this event (i.e. hysteresis as defined within reportConfigNR for this event).
Thresh is the threshold parameter for this event (i.e. a4-Threshold as defined within reportConfigNR for this event).
Mn is expressed in dBm in case of RSRP, or in dB in case of RSRQ and RS-SINR.
Ofn, Ocn, Hys are expressed in dB.
Thresh is expressed in the same unit as Mn.
   5.5.4.6 Event A5 (SpCell Becomes Worse than Threshold1 and Neighbour Becomes Better than Threshold2)

The UE shall:
1> consider the entering condition for this event to be satisfied when both condition A5-1 and condition A5-2, as specified below, are fulfilled;
1> consider the leaving condition for this event to be satisfied when condition A5-3 or condition A5-4, i.e. at least one of the two, as specified below, is fulfilled;
1> use the SpCell for Mp.
NOTE: The parameters of the reference signal(s) of the cell(s) that triggers the event are indicated in the measObjectNR associated to the event which may be different from the measObjectNR of the NR SpCell.

Mp+Hys<Thresh1 Inequality A5-1 (Entering condition 1)

Mn+Ofn+Ocn−Hys>Thresh2 Inequality A5-2 (Entering condition 2)

Mp−Hys>Thresh1 Inequality A5-3 (Leaving condition 1)

Mn+Ofn+Ocn+Hys<Thresh2 Inequality A5-4 (Leaving condition 2)

The variables in the formula are defined as follows:
Mp is the measurement result of the NR SpCell, not taking into account any offsets. If triggerBasedOnPredictions is set to ‘true’, the variable corresponds to the predictions of the measurement result of the NR SpCell.
Mn is the measurement result of the neighbouring cell, not taking into account any offsets. If triggerBasedOnPredictions is set to ‘true’, the variable corresponds to the predictions of the measurement result of the neighbouring cell.
Ofn is the measurement object specific offset of the neighbour cell (i.e. offsetMO as defined within measObjectNR corresponding to the neighbour cell).
Ocn is the cell specific offset of the neighbour cell (i.e. cellIndividualOffset as defined within measObjectNR corresponding to the neighbour cell), and set to zero if not configured for the neighbour cell.
Hys is the hysteresis parameter for this event (i.e. hysteresis as defined within reportConfigNR for this event).
Thresh1 is the threshold parameter for this event (i.e. a5-Threshold1 as defined within reportConfigNR for this event).
Thresh2 is the threshold parameter for this event (i.e. a5-Threshold2 as defined within reportConfigNR for this event).
Mn, Mp are expressed in dBm in case of RSRP, or in dB in case of RSRQ and RS-SINR.
Ofn, Ocn, Hys are expressed in dB.
Thresh1 is expressed in the same unit as Mp.
Thresh2 is expressed in the same unit as Mn.
   5.5.4.7 Event A6 (Neighbour becomes offset better than SCell)

The UE shall:
1> consider the entering condition for this event to be satisfied when condition A6-1, as specified below, is fulfilled;
1> consider the leaving condition for this event to be satisfied when condition A6-2, as specified below, is fulfilled;
1> for this measurement, consider the (secondary) cell corresponding to the measObjectNR associated to this event to be the serving cell.
NOTE: The reference signal(s) of the neighbour(s) and the reference signal(s) of the SCell are both indicated in the associated measObjectNR.

Mn+Ocn−Hys>Ms+Ocs+Off Inequality A6-1 (Entering condition)

Mn+Ocn+Hys<Ms+Ocs+Off Inequality A6-2 (Leaving condition)

The variables in the formula are defined as follows:
Mn is the measurement result of the neighbouring cell, not taking into account any offsets. If triggerBasedOnPredictions is set to ‘true’, the variable corresponds to the predictions of the measurement result of the neighbouring cell.
Ocn is the cell specific offset of the neighbour cell (i.e. cellIndividualOffset as defined within the associated measObjectNR), and set to zero if not configured for the neighbour cell.
Ms is the measurement result of the serving cell, not taking into account any offsets. If triggerBasedOnPredictions is set to ‘true’, the variable corresponds to the predictions of the measurement result of the serving cell.
Ocs is the cell specific offset of the serving cell (i.e. cellIndividualOffset as defined within the associated measObjectNR), and is set to zero if not configured for the serving cell.
Hys is the hysteresis parameter for this event (i.e. hysteresis as defined within reportConfigNR for this event).
Off is the offset parameter for this event (i.e. a6-Offset as defined within reportConfigNR for this event).
Mn, Ms are expressed in dBm in case of RSRP, or in dB in case of RSRQ and RS-SINR.
Ocn, Ocs, Hys, Off are expressed in dB.
   5.5.4.8 Event B1 (Inter RAT neighbour becomes better than threshold)

The UE shall:
1> consider the entering condition for this event to be satisfied when condition B1-1, as specified below, is fulfilled;
1> consider the leaving condition for this event to be satisfied when condition B1-2, as specified below, is fulfilled.

Mn+Ofn+Ocn−Hys>Thresh Inequality B1-1 (Entering condition)

Mn+Ofn+Ocn+Hys<Thresh Inequality B1-2 (Leaving condition)

The variables in the formula are defined as follows:
Mn is the measurement result of the inter-RAT neighbour cell, not taking into account any offsets. If triggerBasedOnPredictions is set to ‘true’, the variable corresponds to the predictions of the measurement result of the inter-RAT neighbour cell.
Ofn is the measurement object specific offset of the frequency of the inter-RAT neighbour cell (i.e. eutra-Q-OffsetRange as defined within the measObjectEUTRA corresponding to the frequency of the neighbour inter-RAT cell).
Ocn is the cell specific offset of the inter-RAT neighbour cell (i.e. cellIndividualOffset as defined within the measObjectEUTRA corresponding to the neighbour inter-RAT cell), and set to zero if not configured for the neighbour cell.
Hys is the hysteresis parameter for this event (i.e. hysteresis as defined within reportConfigInterRAT for this event).
Thresh is the threshold parameter for this event (i.e. b1-ThresholdEUTRA as defined within reportConfigInterRAT for this event).
Mn is expressed in dBm or in dB, depending on the measurement quantity of the inter-RAT neighbour cell.
Ofn, Ocn, Hys are expressed in dB.
Thresh is expressed in the same unit as Mn.
   5.5.4.9 Event B2 (PCell Becomes Worse than Threshold1 and Inter RAT Neighbour Becomes Better than Threshold2)

The UE shall:
1> consider the entering condition for this event to be satisfied when both condition B2-1 and condition B2-2, as specified below, are fulfilled;
1> consider the leaving condition for this event to be satisfied when condition B2-3 or condition B2-4, i.e. at least one of the two, as specified below, is fulfilled;

Mp+Hys<Thresh1 Inequality B2-1 (Entering condition 1)

Mn+Ofn+Ocn−Hys>Thresh2 Inequality B2-2 (Entering condition 2)

Mp−Hys>Thresh1 Inequality B2-3 (Leaving condition 1)

Mn+Ofn+Ocn+Hys<Thresh2 Inequality B2-4 (Leaving condition 2)

The variables in the formula are defined as follows:
Mp is the measurement result of the PCell, not taking into account any offsets. If triggerBasedOnPredictions is set to ‘true’, the variable corresponds to the predictions of the measurement result of the PCell.
Mn is the measurement result of the inter-RAT neighbour cell, not taking into account any offsets. If triggerBasedOnPredictions is set to ‘true’, the variable corresponds to the predictions of the measurement result of the inter-RAT neighbour cell.
Ofn is the measurement object specific offset of the frequency of the inter-RAT neighbour cell (i.e. eutra-Q-OffsetRange as defined within the measObjectEUTRA corresponding to the frequency of the inter-RAT neighbour cell).
Ocn is the cell specific offset of the inter-RAT neighbour cell (i.e. cellIndividualOffset as defined within the measObjectEUTRA corresponding to the neighbour inter-RAT cell), and set to zero if not configured for the neighbour cell.
Hys is the hysteresis parameter for this event (i.e. hysteresis as defined within reportConfigInterRAT for this event).
Thresh1 is the threshold parameter for this event (i.e. b2-Threshold1 as defined within reportConfigInterRAT for this event).
Thresh2 is the threshold parameter for this event (i.e. b2-Threshold2EUTRA as defined within reportConfigInterRAT for this event).
Mp is expressed in dBm in case of RSRP, or in dB in case of RSRQ and SINR.
Mn is expressed in dBm or dB, depending on the measurement quantity of the inter-RAT neighbour cell.
Ofn, Ocn, Hys are expressed in dB.
Thresh1 is expressed in the same unit as Mp.
Thresh2 is expressed in the same unit as Mn.

### 5.5.5 Measurement Reporting

### 5.5.5.1 General

The purpose of this procedure is to transfer measurement results and/or predictions of measurement results from the UE to the network. The UE shall initiate this procedure only after successful AS security activation.

For the measId for which the measurement reporting procedure was triggered, the UE shall set the measResults within the MeasurementReport message as follows:
1> set the measId to the measurement identity that triggered the measurement reporting;
1> for each serving cell configured with servingCellMO:
   2> if the reportConfig associated with the measId that triggered the measurement reporting includes rsType:
      3> If triggerBasedOnPredictions is set to ‘true’:
         4> if the predictions of the serving cell measurements based on the rsType included in the reportConfig that triggered the measurement report are available:
         5> set the measResultServingCell within measResultServingMOList to include the predicted RSRP, RSRQ and the available SINR of the serving cell, derived based on the rsType included in the reportConfig that triggered the measurement report;
      3> else if the serving cell measurements based on the rsType included in the reportConfig that triggered the measurement report are available:
         4> set the measResultServingCell within measResultServingMOList to include RSRP, RSRQ and the available SINR of the serving cell, derived based on the rsType included in the reportConfig that triggered the measurement report;
   2> else:
      3> If triggerBasedOnPredictions is set to ‘true’:
         4> if predictions of SSB based serving cell measurements are available:
         5> set the measResultServingCell within measResultServingMOList to include predictions of the RSRP, RSRQ and the available SINR of the serving cell, derived based on SSB;
         4> else if predictions of CSI-RS based serving cell measurements are available:
         5> set the measResultServingCell within measResultServingMOList to include predictions of the RSRP, RSRQ and the available SINR of the serving cell, derived based on SSB;
      3> else if SSB based serving cell measurements are available:
         4> set the measResultServingCell within measResultServingMOList to include RSRP, RSRQ and the available SINR of the serving cell, derived based on SSB;
      3> else if CSI-RS based serving cell measurements are available:
         4> set the measResultServingCell within measResultServingMOList to include RSRP, RSRQ and the available SINR of the serving cell, derived based on CSI-RS;
1> set the servCellId within measResultServingMOList to include each NR serving cell that is configured with servingCellMO, if any;
1> If triggerBasedOnPredictions is set to ‘true’:
1> if the reportConfig associated with the measId that triggered the measurement reporting includes reportQuantityRS-Indexes and maxNrofRS-IndexesToReport:
   2> for each serving cell configured with servingCellMO, include beam measurement information based on measurement predictions according to the associated reportConfig;
1> else if the reportConfig associated with the measId that triggered the measurement reporting includes reportQuantityRS-Indexes and maxNrofRS-IndexesToReport:
   2> for each serving cell configured with servingCellMO, include beam measurement information according to the associated reportConfig;
1> If triggerBasedOnPredictions is set to ‘true’
   2> if the reportConfig associated with the measId that triggered the measurement reporting includes reportAddNeighMeas:
      3> for each measObjectId referenced in the measIdList which is also referenced with servingCellMO, other than the measObjectId corresponding with the measId that triggered the measurement reporting:
         4> if the measObjectNR indicated by the servingCellMO includes the RS resource configuration corresponding to the rsType indicated in the reportConfig:
         5> set the measResultBestNeighCell within measResultServingMOList to include the physCellId and the available predictions of measurement quantities based on the reportQuantityCell and rsType indicated in reportConfig of the non-serving cell corresponding to the concerned measObjectNR with the highest predicted measured RSRP if predictions of RSRP measurement results are available for cells corresponding to this measObjectNR, otherwise with the highest predictions of measured RSRO if predictions of RSRQ measurement results are available for cells corresponding to this measObjectNR, otherwise with the highest predicted measured SINR;
         5> if the reportConfig associated with the measId that triggered the measurement reporting includes reportQuantityRS-Indexes and maxNrofRS-IndexesToReport:
         6> for each best non-serving cell included in the measurement report:
         7> include beam measurement information based on measurement predictions according to the associated reportConfig;
1> else if the reportConfig associated with the measId that triggered the measurement reporting includes reportAddNeighMeas:
   2> for each measObjectId referenced in the measIdList which is also referenced with servingCellMO, other than the measObjectId corresponding with the measId that triggered the measurement reporting:
      3> if the measObjectNR indicated by the servingCellMO includes the RS resource configuration corresponding to the rsType indicated in the reportConfig:
         4> set the measResultBestNeighCell within measResultServingMOList to include the physCellId and the available measurement quantities based on the reportQuantityCell and rsType indicated in reportConfig of the non-serving cell corresponding to the concerned measObjectNR with the highest measured RSRP if RSRP measurement results are available for cells corresponding to this measObjectNR, otherwise with the highest measured RSRQ if RSRQ measurement results are available for cells corresponding to this measObjectNR, otherwise with the highest measured SINR;
         4> if the reportConfig associated with the measId that triggered the measurement reporting includes reportQuantityRS-Indexes and maxNrofRS-IndexesToReport:
         5> for each best non-serving cell included in the measurement report:
         6> include beam measurement information according to the associated reportConfig;
1> if the reportConfig associated with the measId that triggered the measurement reporting is set to eventTriggered and eventID is set to eventA3, or eventA4, or eventA5, or eventB1, or eventB2:
   2> if the UE is in NE-DC and the measurement configuration that triggered this measurement report is associated with the MCG:
      3> set the measResultServFreqListEUTRA-SCG to include an entry for each E-UTRA SCG serving frequency with the following:
         4> include carrierFreq of the E-UTRA serving frequency;
         4> set the measResultServingCell to include the available measurement quantities that the UE is configured to measure by the measurement configuration associated with the SCG;
         4> if reportConfig associated with the measId that triggered the measurement reporting includes reportAddNeighMeas:
         5> set the measResultServFreqListEUTRA-SCG to include within measResultBestNeighCell the quantities of the best non-serving cell, based on RSRP, on the concerned serving frequency;
1> if reportConfig associated with the measId that triggered the measurement reporting is set to eventTriggered and eventID is set to eventA3, or eventA4, or eventA5; and
1> if triggerBasedOnPredictions is set to ‘false’:
   2> if the UE is in NR-DC and the measurement configuration that triggered this measurement report is associated with the MCG:
      3> set the measResultServFreqListNR-SCG to include for each NR SCG serving cell that is configured with servingCellMO, if any, the following:
         4> if the reportConfig associated with the measId that triggered the measurement reporting includes rsType:
         5> if the serving cell measurements based on the rsType included in the reportConfig that triggered the measurement report are available according to the measurement configuration associated with the SCG:
         6> set the measResultServingCell within measResultServFreqListNR-SCG to include RSRP, RSRQ and the available SINR of the serving cell, derived based on the rsType included in the reportConfig that triggered the measurement report;
         4> else:
         5> if SSB based serving cell measurements are available according to the measurement configuration associated with the SCG:
         6> set the measResultServingCell within measResultServFreqListNR-SCG to include RSRP, RSRQ and the available SINR of the serving cell, derived based on SSB;
         5> else if CSI-RS based serving cell measurements are available according to the measurement configuration associated with the SCG:
         6> set the measResultServingCell within measResultServFreqListNR-SCG to include RSRP, RSRQ and the available SINR of the serving cell, derived based on CSI-RS;
         4> if results for the serving cell derived based on SSB are included:
         5> include the ssbFrequency to the value indicated by ssbFrequency as included in the MeasObjectNR of the serving cell;
         4> if results for the serving cell derived based on CST-RS are included:
         5> include the refFreqCSI-RS to the value indicated by refFreqCSI-RS as included in the MeasObjectNR of the serving cell;
         4> if the reportConfig associated with the measId that triggered the measurement reporting includes reportQuantityRS-Indexes and maxNrofRS-IndexesToReport:
         5> for each serving cell configured with servingCellMO, include beam measurement information according to the associated reportConfig, where availability is considered according to the measurement configuration associated with the SCG;
         4> if reportConfig associated with the measId that triggered the measurement reporting includes reportAddNeighMeas:
         5> if the measObjectNR indicated by the servingCellMO includes the RS resource configuration corresponding to the rsType indicated in the reportConfig:
         6> set the measResultBestNeighCellListNR within measResultServFreqListNR-SCG to include one entry with the physCellId and the available measurement quantities based on the reportQuantityCell and rsType indicated in reportConfig of the non-serving cell corresponding to the concerned measObjectNR with the highest measured RSRP if RSRP measurement results are available for cells corresponding to this measObjectNR, otherwise with the highest measured RSRQ if RSRQ measurement results are available for cells corresponding to this measObjectNR, otherwise with the highest measured SINR, where availability is considered according to the measurement configuration associated with the SCG;
         7> if the reportConfig associated with the measId that triggered the measurement reporting includes reportQuantityRS-Indexes and maxNrofRS-IndexesToReport:
         8> for each best non-serving cell included in the measurement report:
         9> include beam measurement information according to the associated reportConfig, where availability is considered according to the measurement configuration associated with the SCG;
1> if reportConfig associated with the measId that triggered the measurement reporting is set to eventTriggered and eventID is set to eventA3, or eventA4, or eventA5; and
1> if triggerBasedOnPredictions is set to ‘true’:
   2> if the UE is in NR-DC and the measurement configuration that triggered this measurement report is associated with the MCG:
      3> set the measResultServFreqListNR-SCG to include for each NR SCG serving cell that is configured with servingCellMO, if any, the following:
         4> if the reportConfig associated with the measId that triggered the measurement reporting includes rsType:
         5> if the predictions of serving cell measurements based on the rsType included in the reportConfig that triggered the measurement report are available according to the measurement configuration associated with the SCG:
         6> set the measResultServingCell within measResultServFregListNR-SCG to include predictions of RSRP, RSRQ and the available predictions of SINR of the serving cell, derived based on the rsType included in the reportConfig that triggered the measurement report;
         4> else:
         5> if predictions of SSB based serving cell measurements are available according to the measurement configuration associated with the SCG:
         6> set the measResultServingCell within measResultServFregListNR-SCG to include predictions of RSRP, RSRQ and the available predictions of SINR of the serving cell, derived based on SSB;
         5> else if predictions of CSI-RS based serving cell measurements are available according to the measurement configuration associated with the SCG:
         6> set the measResultServingCell within measResultServFregListNR-SCG to include predictions of RSRP, RSRQ and the available predictions of SINR of the serving cell, derived based on CSI-RS;
         4> if predictions of results for the serving cell derived based on SSB are included:
         5> include the ssbFrequency to the value indicated by ssbFrequency as included in the MeasObjectNR of the serving cell:
         4> if predictions of results for the serving cell derived based on CSI-RS are included:
         5> include the refFregCSI-RS to the value indicated by refFregCSI-RS as included in the MeasObjectNR of the serving cell:
         4> if the reportConfig associated with the measId that triggered the measurement reporting includes reportQuantityRS-Indexes and maxNrofRS-IndexesToReport:
         5> for each serving cell configured with servingCellMO, include beam measurement information based on measurement predictions according to the associated reportConfig, where availability is considered according to the measurement configuration associated with the SCG:
         4> if reportConfig associated with the measId that triggered the measurement reporting includes reportAddNeighMeas:
         5> if the measObjectNR indicated by the servingCellMO includes the RS resource configuration corresponding to the rsType indicated in the reportConfig:
         6> set the measResultBestNeighCellListNR within measResultServFregListNR-SCG to include one entry with the physCellId and the available predictions of measurement quantities based on the reportQuantityCell and rsType indicated in reportConfig of the non-serving cell corresponding to the concerned measObjectNR with the highest prediction of measured RSRP if RSRP measurement results are available for cells corresponding to this measObjectNR, otherwise with the highest prediction of measured RSRQ if RSRQ measurement results are available for cells corresponding to this measObjectNR, otherwise with the highest measured SINR, where availability is considered according to the measurement configuration associated with the SCG:
         7> if the reportConfig associated with the measId that triggered the measurement reporting includes reportQuantityRS-Indexes and maxNrofRS-IndexesToReport:
         8> for each best non-serving cell included in the measurement report:
         9> include beam measurement information based on measurement predictions according to the associated reportConfig, where availability is considered according to the measurement configuration associated with the SCG:
1> if there is at least one applicable neighbouring cell to report:
   2> if the reportType is set to eventTriggered or periodical:
      3> set the measResultNeighCells to include the best neighbouring cells up to maxReportCells in accordance with the following:
         4> if the reportType is set to eventTriggered:
         5> include the cells included in the cellsTriggeredList as defined within the VarMeasReportList for this measId;
         4> else:
         5> include the applicable cells for which the new measurement results and/or predictions of new measurement results became available since the last periodical reporting or since the measurement and/or predictions was initiated or reset;
         4> for each cell that is included in the measResultNeighCells, include the physCellId;
         4> if triggerBasedOnPredictions is set to ‘false; and
         4> if the reportType is set to eventTriggered or periodical:
         5> for each included cell, include the layer 3 filtered measured results in accordance with the reportConfig for this measId, ordered as follows:
         6> if the measObject associated with this measId concerns NR:
         7> if rsType in the associated reportConfig is set to ssb:
         8> set resultsSSB-Cell within the measResult to include the SS/PBCH block based quantity(ies) indicated in the reportQuantityCell within the concerned reportConfig, in decreasing order of the sorting quantity, determined as specified in 5.5.5.3, i.e. the best cell is included first;
         8> if reportQuantityRS-Indexes and maxNrojRS-IndexesToReport are configured, include beam measurement information;
         7> else if rsType in the associated reportConfig is set to csi-rs:
         8> set resultsCSI-RS-Cell within the measResult to include the CSI-RS based quantity(ies) indicated in the reportQuantityCell within the concerned reportConfig, in decreasing order of the sorting quantity, determined as specified in 5.5.5.3, i.e. the best cell is included first;
         8> if reportQuantityRS-Indexes and maxNrojRS-IndexesToReport are configured, include beam measurement information;
         6> if the measObject associated with this measId concerns E-UTRA:
         7> set the measResult to include the quantity(ies) indicated in the reportQuantity within the concerned reportConfigInterRAT in decreasing order of the sorting quantity, determined as specified in 5.5.5.3, i.e. the best cell is included first;
         4> else, if triggerBasedOnPredictions is set to ‘true’; and
         4> if the reportType is set to eventTriggered or periodical:
         5> for each included cell, include predictions of the layer 3 filtered measured results in accordance with the reportConfig for this measId, ordered as follows:
         6> if the measObject associated with this measId concerns NR:
         7> if rsType in the associated reportConfig is set to ssb:
         8> set resultsSSB-Cell within the measResult to include the predictions of SS/PBCH block based quantity(ies) indicated in the reportQuantityCell within the concerned reportConfig, in decreasing order of the sorting quantity, determined as specified in 5.5.5.3, i.e. the best cell is included first;
         8> if reportQuantityRS-Indexes and maxNrofRS-IndexesToReport are configured, include beam measurement information based on beam measurement predictions:
         7> else if rsType in the associated reportConfig is set to csi-rs:
         8> set resultsCSI-RS-Cell within the measResult to include the predictions of CSI-RS based quantity(ies) indicated in the reportQuantityCell within the concerned reportConfig, in decreasing order of the sorting quantity, determined as specified in 5.5.5.3. i.e. the best cell is included first:
         8> if reportQuantityRS-Indexes and maxNrofRS-IndexesToReport are configured, include beam measurement information based on beam measurement predictions:
         6> if the measObject associated with this measId concerns E-UTRA:
         7> set the measResult to include the predictions of quantity(ies) indicated in the reportQuantity within the concerned reportConfigInterRAT in decreasing order of the sorting quantity, determined as specified in 5.5.5.3, i.e. the best cell is included first;
   2> else:
      3> if the cell indicated by cellForWhichToReportCGI is an NR cell:
         [ . . . ]
1> if the corresponding measObject concerns NR:
   2> if the reportSFTD-Meas is set to true within the corresponding reportConfigNR for this measId:
      [ . . . ]
   2> else if the reportSFTD-NeighMeas is included within the corresponding reportConfigNR for this measId:
      [ . . . ]
1> increment the numberOfReportsSent as defined within the VarMeasReportList for this measId by 1;
1> stop the periodical reporting timer, if running;
1> if the numberOfReportsSent as defined within the VarMeasReportList for this measId is less than the reportAmount as defined within the corresponding reportConfig for this measId:
   2> start the periodical reporting timer with the value of reportInterval as defined within the corresponding reportConfig for this measId;
1> else:
   2> if the reportType is set to periodical:
      3> remove the entry within the VarMeasReportList for this measId;
      3> remove this measId from the measIdList within VarMeasConfig;
1> if the UE is in (NG)EN-DC:
   2> if SRB3 is configured:
      3> submit the MeasurementReport message via SRB3 to lower layers for transmission, upon which the procedure ends;
   2> else:
      3> submit the MeasurementReport message via the E-UTRA MCG embedded in E-UTRA RRC message ULInformationTransferMRDC as specified in TS 36.331 [10].
1> else if the UE is in NR-DC:
   2> if the measurement configuration that triggered this measurement report is associated with the SCG:
      3> if SRB3 is configured:
         4> submit the MeasurementReport message via SRB3 to lower layers for transmission, upon which the procedure ends;
      3> else:
         4> submit the MeasurementReport message via the NR MCG embedded in NR RRC message ULInformationTransferMRDC as specified in 5.7.2a.3;
   2> else:
      3> submit the MeasurementReport message via SRB1 to lower layers for transmission, upon which the procedure ends;
1> else:
   2> submit the MeasurementReport message to lower layers for transmission, upon which the procedure ends.
      5.5.5.2 Reporting of beam measurement information

For beam measurement information to be included in a measurement report the UE shall:
1> if reportType is set to eventTriggered:
   2> consider the trigger quantity as the sorting quantity if available, otherwise RSRP as sorting quantity if available, otherwise RSRQ as sorting quantity if available, otherwise SINR as sorting quantity;
1> if reportType is set to periodical:
   2> if a single reporting quantity is set to true in reportQuantityRS-Indexes;
      3> consider the configured single quantity as the sorting quantity;
   2> else:
      3> if rsrp is set to true;
         4> consider RSRP as the sorting quantity;
      3> else:
         4> consider RSRQ as the sorting quantity;
1> set rsIndexResults to include up to maxNrofRS-IndexesToReport SS/PBCH block indexes or CSI-RS indexes in order of decreasing sorting quantity as follows:
   2> if the measurement information to be included is based on SS/PBCH block:
   2> if triggerBasedOnPredictions is set to ‘false:
      4> include within resultsSSB-Indexes the index associated to the best beam for that SS/PBCH block sorting quantity and if absThreshSS-BlocksConsolidation is included in the VarMeasConfig for the measObject associated to the cell for which beams are to be reported, the remaining beams whose sorting quantity is above absThreshSS-BlocksConsolidation;
      4> if includeBeamMeasurements is configured, include the SS/PBCH based measurement results for the quantities in reportQuantityRS-Indexes set to true for each SS/PBCH block index;
   2> if triggerBasedOnPredictions is set to ‘true’:
      4> include within resultsSSB-Indexes the index associated to the best beam for that SS/PBCH block sorting quantity and if absThreshSS-BlocksConsolidation is included in the VarMeasConfig for the measObject associated to the cell for which beams are to be reported, the remaining beams whose sorting quantity is above absThreshSS-BlocksConsolidation, where best and remaining beams are decided based on measurements predictions:
      4> if includeBeamMeasurements is configured, include the predictions of SS/PBCH based measurement results for the quantities in reportQuantityRS-Indexes set to true for each SS/PBCH block index;
   2> else if the beam measurement information to be included is based on CSI-RS:
      3> if triggerBasedOnPredictions is set to ‘false:
         4> include within resultsCSI-RS-Indexes the index associated to the best beam for that CSI-RS sorting quantity and, if absThreshCSI-RS-Consolidation is included in the VarMeasConfig for the measObject associated to the cell for which beams are to be reported, the remaining beams whose sorting quantity is above absThreshCSI-RS-Consolidation;
         4> if includeBeamMeasurements is configured, include the CSI-RS based measurement results for the quantities in reportQuantityRS-Indexes set to true for each CSI-RS index.
      3> if triggerBasedOnPredictions is set to ‘true’:
         4> include within resultsCSI-RS-Indexes the index associated to the best beam for that CSI-RS sorting quantity and, if absThreshCSI-RS-Consolidation is included in the VarMeasConfig for the measObject associated to the cell for which beams are to be reported, the remaining beams whose sorting quantity is above absThreshCSI-RS-Consolidation, where best and remaining beams are decided based on measurements predictions;
         4> if includeBeamMeasurements is configured, include the predictions of CSI-RS based measurement results for the quantities in reportQuantityRS-Indexes set to true for each CSI-RS index.

For all messages comprises predictions, likelihood, probabilities and/or accuracies related to the reported predictions may be comprised. The report of this associated information may be configured by the network node 403, i.e. the UE 401 may only include if the network node 403 configures a field associated to that e.g. in ReportConfig.

For all messages comprising predictions, time-relate information for the prediction may be comprised. The report of this associated information may be configured by the network node 403, i.e. the UE 401 may only include if the network node 403 configures a field associated to that e.g. in ReportConfig.

One advantage of reporting additional cells that are not triggered may have to do with robustness. For example, the network node 403 may may prepare these cells as candidates for re-establishment in failure a handover failure happens or candidates for conditional handover.

For inter-RAT events like B1 and B2, all principles described herein apply, where mobility information prediction may be associated to inter-RAT cells/beams/frequencies.

Prediction Reporting Content and Structure

Predictions of which neighbor cells and associated neighbour nodes may be target candidates for mobility procedures, e.g. handovers, reconfiguration with sync, Secondary Cell Group addition, Secondary Cell Group change, release with redirect, etc. One application of the predictions of radio measurements reported by the UE 401, e.g. cell level/beam level RSRP, RSRQ, SINR based on SSB and/or CSI-RS, may be to assist the network node 403 to take decisions related to mobility management such as release with redirect to a target RAT, carrier, cell; handovers; conditional handovers; PSCell additions; PSCell changes, handovers, reconfiguration with sync, conditional handovers, SCG additions, SCG changes, SCG release, Release with redirect, conditional SCG addition, conditional SCG change, etc.

The message in step 505 may be a new message e.g. defined in RRC specifications, where the IEs are similar to the ones defined for measurement reports but comprises predictions. The UE 401 may indicate in the message a time related information 35 associated to the prediction e.g. some validity and/or an indication that the reported prediction is the predicted value for a given future time, such as the predicted value in the next X seconds, or the list of cells and/or beams in sequence indicating where the UE 401 is going.

The information reported by the UE 401 may be enriched by a time information associated to the mobility information e.g. Cell A in X seconds, Cell A at time stamp TO, Cell A will have RSRP=Y at time stamp TO, Cell A will have RSRP=Y in X seconds, etc. that information can be used by the network to perform paging (e.g. RAN paging for Inactive UEs). There may also be some reporting configuration associated to that time related information e.g. indication to comprise that, or a maximum time value so the UE 401 only include predictions valid within a certain time window like next X cells the UE will move in the next Y seconds/minutes/hours.

The message in step 505 may be as shown below:

MeasurementPredictionReport

The MeasurementPredictionReport message is used for the indication of predicted measurement results.
Signalling radio bearer: SRB1, SRB3
RLC-SAP: AM
Logical channel: DCCH
Direction: UE to Network

MeasurementPredictionReport message

-- ASN1START
-- TAG-MEASUREMENTPREDICTIONREPORT-START

| | |
|---|---|
| MeasurementPredictionReport : := | SEQUENCE { |
| criticalExtensions | CHOICE { |
| measurementPredictionReport | MeasurementPredictionReport-IEs, |
| criticalExtensionsFuture | SEQUENCE { } |
| } | |
| } | |
| MeasurementPredictionReport -IEs : := | SEQUENCE { |
| measPredictionResults | MeasPredictionResults, |
| lateNonCriticalExtension | OCTET STRING |
| OPTIONAL, | |
| nonCriticalExtension | SEQUENCE { } |
| OPTIONAL | |
| } | |

-- TAG- MEASUREMENTPREDICTIONREPORT -STOP
-- ASN1STOP
. . .

MeasPredictionResults

The IE MeasPredictionResults covers measured results for intra-frequency, inter-frequency, and inter-RAT mobility.

MeasPredictionReults information element

-- ASN1START
-- TAG-MEASRESULTS-START

| | |
|---|---|
| MeasPredictionResults : := | SEQUENCE { |
| measId | MeasId, |
| measPredictionResultServingMOList | MeasResultServMOList, |
| measPredictionResultNeighCells | CHOICE { |
| measPredictionResultListNR | MeasResultListNR, |
| . . . , | |
| measPredictionResultListEUTRA | MeasResultListEUTRA |
| } | |
| OPTIONAL, | |
| . . . , | |
| [ [ | |
| measPredictionResult ServFreqListEUTRA-SCG | MeasResultServFreqListEUTRA-SCG |
| OPTIONAL, | |
| measPredictionResultServFreqListNR-SCG | MeasResultServFreqListNR-SCG |
| OPTIONAL, | |
| measPredictionResult SFTD-EUTRA | MeasResult SFTD-EUTRA |
| OPTIONAL, | |
| measPredictionResultSFTD-NR | MeasResultCellSFTD-NR |
| OPTIONAL | |
| ] ] | |
| } | |
| MeasResultServMOList : := | SEQUENCE (SIZE (1. . maxNrofServingCells) ) OF |
| MeasResultServMO | |
| MeasResultServMO : := | SEQUENCE { |
| servCellId | ServCellIndex, |
| measResultServingCell | MeasResultNR, |
| measResultBestNeighCell | MeasResultNR |
| OPTIONAL, | |
| . . . | |
| } | |
| MeasResultListNR : := | SEQUENCE (SIZE (1. . maxCellReport) ) OF MeasResultNR |
| MeasResultNR : := | SEQUENCE { |
| physCellId | PhysCellId |
| OPTIONAL, | |
| measResult | SEQUENCE { |
| cellResults | SEQUENCE { |
| resultsSSB-Cell | MeasQuantityResults |
| OPTIONAL, | |
| resultsCSI-RS-Cell | MeasQuantityResults |
| OPTIONAL | |
| }, | |
| rsIndexResults | SEQUENCE { |
| resultsSSB-Indexes | ResultsPerSSB-IndexList |
| OPTIONAL, | |
| resultsCSI-RS-Indexes | ResultsPerCSI-RS-IndexList |
| OPTIONAL | |
| } | |
| OPTIONAL | |
| }, | |
| . . . , | |
| [ [ | |
| cgi-Info | CGI-InfoNR |
| OPTIONAL | |
| ] ] | |
| } | |

As described before, there may be different predicted mobility information that is comprised in the message in step 505, possibly with the measurements comprised in the reported. The predicted mobility information may be comprised in a measurement report, possibly together with measurements results. Another example is shown below:

MeasResults

The IE MeasResults covers measured results and predictions for intra-frequency, inter-frequency, and inter-RAT mobility.

MeasResults information element

-- ASN1START
-- TAG-MEASRESULTS-START

| | |
|---|---|
| MeasResults : := | SEQUENCE { |
| measId | MeasId, |
| measResultServingMOList | MeasResult ServMOList, |
| measPredictionResult ServingMOList | MeasResult ServMOList, |
| measResultNeighCells | CHOICE { |
| measResultListNR | MeasResultListNR, |
| . . . , | MeasResultListEUTRA |
| measResultListEUTRA | |
| } | |
| OPTIONAL, | |
| measPredcitionsResultNeighCells | CHOICE { |
| measPredictionResultListNR | MeasResultListNR, |
| . . . , | |
| measPredictionResultListEUTRA | MeasResultListEUTRA |
| } | |
| OPTIONAL, | |
| . . . , | |
| [ [ | |
| measResult ServFreqListEUTRA-SCG | MeasResult ServFreqListEUTRA-SCG |
| OPTIONAL, | |
| measResultServFreqListNR-SCG | MeasResultServFreqListNR-SCG |
| OPTIONAL, | |
| measResult SFTD-EUTRA | MeasResult SFTD-EUTRA |
| OPTIONAL, | |
| measResult SFTD-NR | MeasResultCellSFTD-NR |
| OPTIONAL | |
| ] ] , | |
| [ [ | |
| measPredictionResultServFreqListEUTRA-SCG | MeasResultServFreqListEUTRA-SCG |
| OPTIONAL, | |
| measPredictionResultServFreqListNR-SCG | MeasResult ServFreqListNR-SCG |
| OPTIONAL, | |
| measPredictionResult SFTD-EUTRA | MeasResult SFTD-EUTRA |
| OPTIONAL, | |
| measPredictionResultSFTD-NR | MeasResultCellSFTD-NR |
| OPTIONAL | |
| ] ] | |
| } | |
| MeasResultServMOList : := | SEQUENCE (SIZE (1. . maxNrofServingCells) ) OF |
| MeasResult ServMO | |
| MeasResult ServMO : := | SEQUENCE { |
| servCellId | ServCellIndex, |
| measResultServingCell | MeasResultNR, |
| measResultBestNeighCell | MeasResultNR |
| OPTIONAL, | |
| . . . | |
| } | |
| MeasResultListNR : := | SEQUENCE (SIZE (1. . maxCellReport) ) OF MeasResultNR |
| MeasResultNR : := | SEQUENCE { |
| physCellId | PhysCellId |
| OPTIONAL, | |
| measResult | SEQUENCE { |
| cellResults | SEQUENCE { |
| resultsSSB-Cell | MeasQuantityResults |
| OPTIONAL, | |
| resultsCSI-RS-Cell | MeasQuantityResults |
| OPTIONAL | |
| }, | |
| rsIndexResults | SEQUENCE { |
| resultsSSB-Indexes | ResultsPerSSB-IndexList |
| OPTIONAL, | |
| resultsCSI-RS-Indexes | ResultsPerCSI-RS-IndexList |
| OPTIONAL | |
| } | |
| OPTIONAL | |
| }, | |
| . . . , | |
| [ [ | |
| cgi-Info | CGI-InfoNR |
| OPTIONAL | |
| ] ] | |
| } | |
| MeasResultListEUTRA : := | SEQUENCE (SIZE (1. . maxCellReport) ) OF |
| MeasResultEUTRA | |
| MeasResultEUTRA : := | SEQUENCE { |
| eutra-PhysCellId | PhysCellId, |
| measResult | MeasQuantityResultsEUTRA, |
| cgi-Info | CGI-InfoEUTRA |
| OPTIONAL, . . . | |
| } | |
| MultiBandInfoListEUTRA : := | SEQUENCE (SIZE (1. . maxMultiBands) ) OF |
| FreqBandIndicatorEUTRA | |
| MeasQuantityResults : := | SEQUENCE { |
| rsrp | RSRP-Range |
| OPTIONAL, | |
| rsrq | RSRQ-Range |
| OPTIONAL, | |
| sinr | SINR-Range |
| OPTIONAL | |
| } | |
| MeasQuantityResultsEUTRA : := | SEQUENCE { |
| rsrp | RSRP-RangeEUTRA |
| OPTIONAL, | |
| rsrq | RSRQ-RangeEUTRA |
| OPTIONAL, | |
| sinr | SINR-RangeEUTRA |
| OPTIONAL | |
| } | |
| ResultsPerSSB-IndexList : := | SEQUENCE (SIZE (1. . maxNrofIndexesToReport2) ) OF |
| ResultsPerSSB-Index | |
| ResultsPerSSB-Index : := | SEQUENCE { |
| ssb-Index | SSB-Index, |
| ssb-Results | MeasQuantityResults |
| OPTIONAL | |
| } | |
| ResultsPerCSI-RS-IndexList : : = | SEQUENCE (SIZE (1. . maxNrofIndexesToReport2) ) OF |
| ResultsPerCSI-RS-Index | |
| ResultsPerCSI-RS-Index : := | SEQUENCE { |
| csi-RS-Index | CSI-RS-Index, |
| csi-RS-Results | MeasQuantityResults |
| OPTIONAL | |
| } | |

MeasResultServFreqListEUTRA-SCG : := SEQUENCE (SIZE (1. . maxNrofServingCellsEUTRA) ) OF
MeasResult 2EUTRA
MeasResultServFreqListNR-SCG : := SEQUENCE (SIZE (1. . maxNrofServingCells) ) OF MeasResult2NR
-- TAG-MEASRESULTS-STOP
-- ASN1STOP

The UE 401 may transmit a list of cells and/or beams, e.g. comprising cells and beam identifiers, in the message for the cells and/or beams the UE 401 predicts that is going to, e.g. in the next X seconds, possibly with a certain probability. The UE 401 may comprise the cell and/or beam with an associated likelihood to enter the coverage of that cell and/or beam(s). The reporting configuration may comprise a likelihood threshold indicating to the UE 401 that only cells with likelihood above the threshold are to be reported.

The UE 401 may have a limited number of predictive cells to be reported. Hence, it may be necessary for the UE 401 to perform sorting. The UE 401 may use the trigger quantity as a sorting quantity to sort cells and/beams accordingly and comprise the ones with highest sorting quantity. The likelihood may be used as sorting criterion where the UE 401 comprises the cells with highest likelihood.

Network Node Aspects

The present disclosure seen from the network node aspect will now be described in more detail.

The network node 403, also called a source network node, target network node, gNodeB etc. may for perform a measurement prediction configuration, measurement configuration and mobility management. The network node 403 may perform one or more of the following:
Configuring the UE 401 to perform predictions of mobility information such as RSRP, RSRQ, SINR in a given frequency, e.g. per cell, per beam, per RS type like SSB and/or CSI-RS, etc.;
Configuring the UE 401 to transmit a message possibly comprising these predictions of mobility information;
Receiving, from a UE 401, messages comprising measurements and/or prediction of measurements and making mobility decisions based on these reports.

The network node 403 may take one or more decisions based on the message from the UE comprising current mobility information and/or prediction of mobility information and making mobility decisions based on this message.

The mobility information, current and/or predicted, may be used by the network node 403 for CHO configurations and HO configurations. The network node 403 may receive in a message comprising current mobility information associated to a set of reported triggered cells, e.g. RSRP, RSRQ, SINR for cells C1, C2, C3 and predicted mobility information of a set of predicted cells, not necessarily overlapping with the triggered cells, e.g. RSRP, RSRQ, SINR for cells C4, C5, associated to an A3 event. Upon reception of this current mobility information and predicted mobility information, the network node 403 may initiates a CHO preparation procedure, which may be a HO preparation procedure over Xn with a flag indicating this is a CHO, for cells C4 and C5, which are not triggered cells but predicted cells. This may be based on the likelihood that C4 and C5 will appears as additional cells anyway that would be later needed to be added to the UE's CHO configuration. This may be done in addition to the CHO preparation of cells C4 and C5. The network node 403 may verify the predicted values for the measurements of the predicted cells before taking this decision e.g. it may only prepare these predicted cells for CHO if predictions are above a certain value and/or associated real/current value, if reported and available, are also above a certain threshold.

Upon receiving from each target candidate cell/node requested based on the predicted mobility information that were transmitted by the UE 401, the confirmation of acceptance for CHO and the target's configuration for the UE 401, e.g. an RRCReconfiguration message to be applied on top of UE's current configuration, the network node may perform one or more of the following:
The network node 403 may provide the CHO configurations to the UE 401;
The network node 403 may store at least one CHO configuration, i.e. it may store the RRCReconfiguration with a reconfiguration with sync per target candidate, or equivalent configuration in another format, for these cells and only provides to the UE 401 upon reception of some further indication/report, different compared to existing CHO where that is provided to the UE 401 upon reception from target candidates.
   This sub-sequent indication from the UE 401 may be a measurement report based on an A3 event that comprises as triggered cells one of the cells for which the source gNB has a stored CHO configuration (which has been possibly prepared based on the predicted measurements and/or based on real measurements). In response to this indication, the network node 403 may perform any of the following:
      Configure CHO for at least one cell indicated for the UE (e.g. by adding the CHO configuration with a trigger condition for that cell, using an AddMod list structure);
      Trigger a handover for at least one cell indicated i.e. directly provide the RRCReconfiguration from the target candidate without any triggering condition so the UE 401 accesses that target directly upon reception of the message;
      Delete the CHO for at least one cell indicated in case that cell becomes worse than before and/or achieves a leaving condition for the message. Upon that, network node 403 contacts the target network node and cancels the previously configured CHO.

Notice that this may be applicable for candidate cells chosen by the network node 403 based on measurement reports or other criteria, e.g. blind configuration of CHO, i.e. the present disclosure are not exclusively applicable based on predictions, but also on measurements. For example, the UE 401 may reports a set of cells in an A3 event C1, C2, C3 as good candidates for CHO. Then, the network node 403 may prepares each of these cells, receive an RRCReconfiguration with reconfiguration with sync for each of these cells, i.e. HO commands for target candidates, but does not provide to the UE 401, at least not immediately. The network node 403 may wait until the occurrence of a further event may be the reception of another measurement report having one of these cells as candidates, the detection of some problem in the source cell, e.g. some L1 reporting that may indicate that the connection with source is not very good and UE may declare RLF, etc.

The present disclosure may be applicable for a network node capable of CHO and a target candidate capable of CHO, and a UE 401 that is not capable of CHO. In other words, even for these UEs 401, there may be some benefit of having CHO i.e. legacy UEs 401 still benefit from CHO.

The network node 403 may perform a method with at least one target candidate a CHO preparation procedure to obtain an RRCReconfiguration. However, upon reception from a target candidate the network node 403 does not configure the UE 401 and instead, wait for a measurement report fulfilling a trigger condition, e.g. A1, A2, A3, A4, A5, A6, B1, B2, etc., and possibly comprising predicted mobility information. Only upon reception of the message in step 505, the network node 403 may give the UE 401 the RRCReconfiguration, i.e. the prepared handover command from the target candidate, or PSCell change/addition, etc. This aims to improve the interruption time since one or multiple targets are prepared when the UE 401 receives the HO command. This may also be implemented for UEs 401 that are no capable of Conditional Handover.

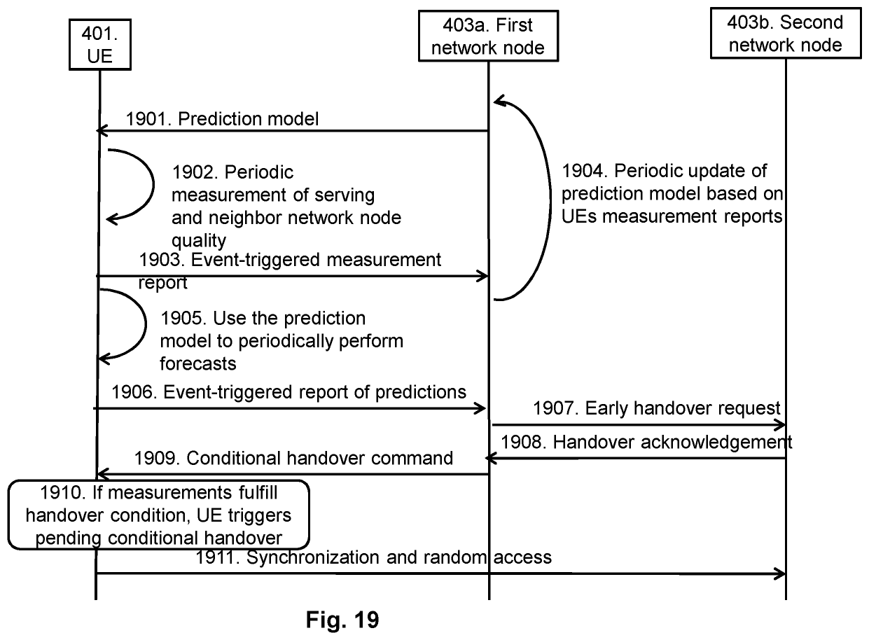

The present disclosure may be applied for forecasting candidate tBSs for conditional HO which is described in FIG. 19. FIG. 19 shows a UE 401, a first network node 403a and a second network node 403b. The first network node 403a may be a serving base station and the second network node 403b may be a target base station. The method comprises at least one of the following steps, which steps may be performed in any suitable order than described below:

Step 1901

This step corresponds to step 502 in FIG. 5. The first network node 403a may provide a prediction model to the UE 401 using broadcast or unicast. The UE 401 may receive the broadcasted prediction model.

Step 1902

This step may correspond to step 503 in FIG. 5. The UE 401 may perform a periodic measurement of serving and neighbor network node quality.

Step 1903

This step corresponds to step 505 in FIG. 5. The UE 401 may transmit an event-triggered measurement report to the first network node 403a. The measurement report comprises the periodic measurement from step 1902.

The event triggered measurement in this step may be the same as the message transmitted in step 505 in FIG. 5.

Step 1904

This step corresponds to step 501 in FIG. 5. The first network node 403 may perform a periodic update of the prediction model based on UEs measurement reports from step 1903.

Step 1905

This step corresponds to step 503 in FIG. 5. The UE 401 may use the prediction model to periodically perform forecasts, i.e. to predict mobility information.

Step 1906

This step corresponds to step 505 in FIG. 5. The UE 401 may transmit an event-triggered report of predictions from step 1905 to the first network node 403a. The event-triggered report of predictions comprises the predict mobility information from step 1905.

In FIG. 19, the transmission of the message is split into two steps, steps 1903 and 1906. In FIG. 5, the transmission of the message is performed in one step 505. Thus, the current mobility information and the predicted mobility information may be transmitted in one or two steps.

Step 1907

This step may correspond to step 506 in FIG. 5. The first network node 403a may transmit an early handover request message to the second network node 403b.

Step 1908

This step may correspond to step 506 in FIG. 5. The second network node 403b may transmit a handover acknowledgement message to the first network node 403b.

Step 1909

This step may correspond to step 506 in FIG. 5. The first network node 403a may transmit a conditional handover command to the UE 401.

Step 1910

The UE 401 checks if the measurements fulfill a handover condition. If the handover condition is fulfilled, the UE 401 triggers the pending conditional handover.

Step 1911

The UE 401 performs synchronization and random access with the second network node 403b.

The network node 403 may periodically broadcasts information related to a prediction model, e.g., info of a NN, such as number of layers, number of nodes, nodes weights, etc., that will be used by the connected UEs 401 to perform predictions, e.g., the best candidate network nodes for conditional HO ‘T’ TTIs ahead. On the UE side, as already done in LTE and 5G NR, periodic measurements of serving and neighbor BSs are performed. These measurements may be event-triggered reported to the first network node 403a to be used latter on to update the prediction model and also used at the UE side as an input in the prediction model to predict, e.g., the best candidate second network node 403b ‘T’ TTIs ahead. These predictions may be event-triggered reported to the first network node 403a, e.g., they may be reported when the UE 401 identifies that ‘T’ TTIs ahead the best candidate second network nodes 403b to be connected to is not its first network node 403. After receiving this report, the first network node 403a will send an early HO request to the candidate second network nodes 403b. The first network node 403a will inform the UE 401 with a conditional HO command which second network nodes 403b answered with an ACK. Finally, if the measurements fulfill an HO condition, the UE 401 will trigger pending conditional HO and will directly synchronize to the second network node 403b.

The present disclosure may be considered a standalone solution that does not need initial data coming from a predefined dataset to be used. From time instant 0, it may be described as follow: at the beginning, the network node 403 may not have received any UE measurement report. In an online manner, the network node 403 may build an historical dataset by adding new reported measured data samples. These samples are used to train the prediction model.

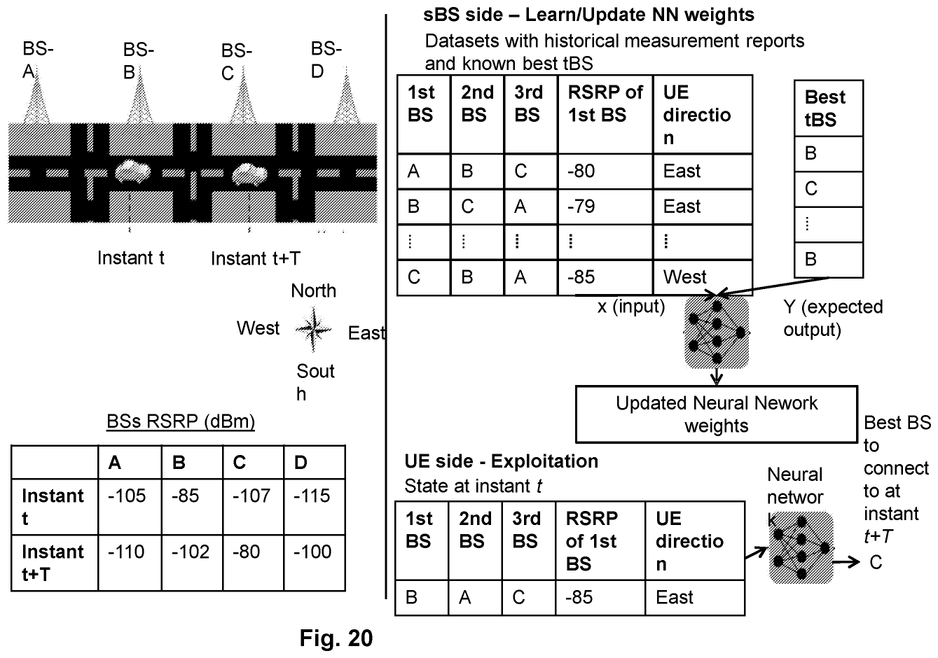

FIG. 20 illustrates an example of how the network node 403, here exemplified with the source base station (sBS), updates a prediction model, in this example, the prediction model is a neural network, and the sBS updates the NN weights, and how the UE 401 may use a NN to predict the best candidate tBS to connect to, ‘T’ TTIs ahead. The left hand side of the FIG. 20 presents a UE 401 moving in a street from instant t to instant t+T. Below this picture, a table presents the measured BSs RSRP at both instants: t and t+T. The right hand side of FIG. 20 presents how the sBS updates the NN weights and how the UE uses the NN. In this example, the input of the NN is a vector with 5 elements: the first three elements are the indexes of the 3 BSs with higher RSRP, the fourth element is a discrete value of RSRP of the best measured BS and the last element is the UE 401 moving direction. The sBS aggregates the UE 401 reported measurements in a dataset which is periodically used to update the NN weight. For this purpose, standard methods can be used, e.g., gradient descent, where for each training instance the backpropagation algorithm first makes a prediction, e.g. forward pass, measures the error, then goes through each layer reverse to measure the error contribution from each connection, e.g. reverse pass, and finally slightly tweaks the connection weights to reduce the error, e.g. a Gradient Descent step.

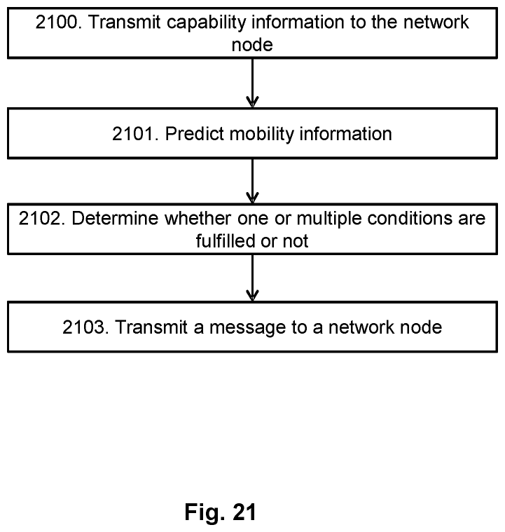

The method described above will now be described seen from the perspective of the UE 401. FIG. 21 is a flowchart describing the present method in the UE 401 for handling mobility information in a communications network. The UE 401 may be configured by the network node 403 to at least one of:
to predict the mobility information, and
to transmit the message.

The method comprises at least one of the following steps to be performed by the UE 401 which steps may be performed in any suitable order than described below:

Step 2100

This step corresponds to step 500 in FIG. 5. The UE 401 may transmit, to the network node 403, capability information indicating that the UE 401 is capable of at least one of:
Receiving the prediction model from the network node 403, and
Transmitting the message when one or multiple conditions are fulfilled. The predicted mobility information may be used as input to the one or multiple conditions.

Step 2101

This step corresponds to step 503 in FIG. 5, step 601 in FIG. 6 and step 1901 in FIG. 19. The UE 401 predicts mobility information related to the UE's 401 predicted mobility in the communications network 400.

The predicted mobility information may be associated with an identity.

The predicted mobility information may comprise at least one of:
radio related information.
information related to cells the UE 401 may enter to coverage of,
information related to beams where the UE 401 predicts it is going to be covered by, and
information related to a route the UE 401 is going.

The mobility information may be predicted using a prediction model.

At least one input parameter may be used as input to the prediction model. The at least one input parameter may comprise at least one of:
measurements,
UE connection information,
UE mobility history information, and
time information.

The prediction model may be stored, e.g. preconfigured, in the UE 401 or it may be received from the network node 403.

The prediction model used to predict the mobility information may be selected by the UE 401 from a plurality of candidate prediction models. The plurality of candidate prediction models may be stored, e.g. preconfigured in the UE 401, or received from the network node 4034.

Step 2102

This step corresponds to step 504 in FIG. 5, step 603 in FIG. 6 and step 1905 in FIG. 19. The UE 501 determines whether one or multiple conditions are fulfilled or not for one or multiple cells. At least part of the predicted mobility information is used as input to the one or multiple conditions.

At least one of beam measurement predictions and information derived from beam measurement predictions may be used as input to the one or more conditions.

The one or more conditions may be at least one of: an A1 event, an A2 event, an A3 event, an A4 event, an A5 event and an A6 event, B1 event, B2 event, or any other event mentioned herein.

Step 2103

This step corresponds to step 505 in FIG. 5, step 605 in FIG. 6 and steps 1903 and 1906 in FIG. 19. The UE 401 transmits a message to a network node 403 when it has been determined that the one or multiple conditions are fulfilled.

The message may comprise at least one of:
the predicted mobility information; and
current mobility information,

The predicted mobility information may be associated with a future time which is ahead of a current time of the current mobility information.

The message may be a measurement report.

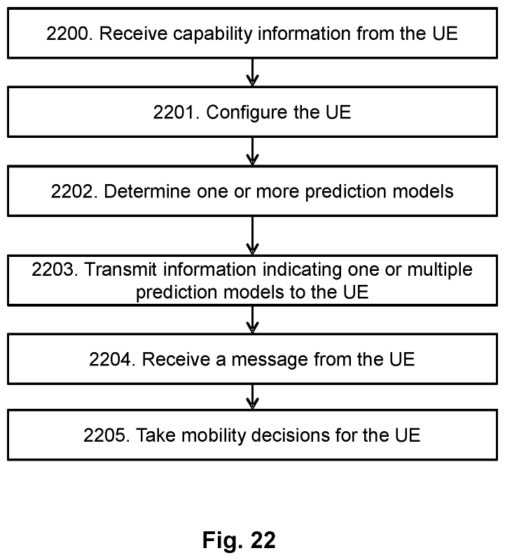

The method described above will now be described seen from the perspective of the network node 403. FIG. 22 is a flowchart describing the present method in the network node 403 for handling mobility information in a communications network. The method comprises at least one of the following steps to be performed by the network node 403, which steps may be performed in any suitable order than described below:

Step 2200

This step corresponds to step 500 in FIG. 5. The network node 403 may receive, from the UE 401, capability information indicating that the UE 101 is capable of at least one of:
Receiving the message from the network node 403; and
Transmitting the message when one or multiple conditions are fulfilled. The predicted mobility information may be used as input to the one or multiple conditions.

Step 2201

This step corresponds to step 501 in FIG. 5. The network node 403 may configure the UE 401 to at least one of:
predict mobility information, and to
transmit the message to network node 403.

Step 2202

This step corresponds to step 501 in FIG. 5 and step 1901 in FIG. 19. The network node 403 may determine one or more prediction models from a plurality of candidate prediction models that the UE 401 should be configured with. The determining may be based on at least one of:
the capability information; and
the message received from the UE 401.

Step 2203

This step corresponds to step 502 in FIG. 5 and step 1901 in FIG. 19. The network node 402 may transmit information indicating one or multiple prediction models to the UE 401.

Step 2204

This step corresponds to step 505 in FIG. 5, step 605 in FIG. 6 and steps 1903 and 1906 in FIG. 19. The network node 403 receives a message from the UE 401.

The message may comprise at least one of:
predicted mobility information related to the UE's 401 mobility in the communications network 400; and
current mobility information,

The predicted mobility information may be associated with a future time which is ahead of a current time of the current mobility information.

The message may be a measurement report.

The predicted mobility information may be associated with an identity.

The predicted mobility information may comprise at least one of:
radio related information.
information related to cells the UE 401 may enter to coverage of,
information related to beams where the UE 401 predicts it is going to be covered by, and
information related to a route the UE 401 is going.

Step 2205

This step corresponds to step 506 in FIG. 5 and steps 1907 and 1908 in FIG. 10. The network node 403 takes mobility decisions for the UE 401 based on the message from step 2201.

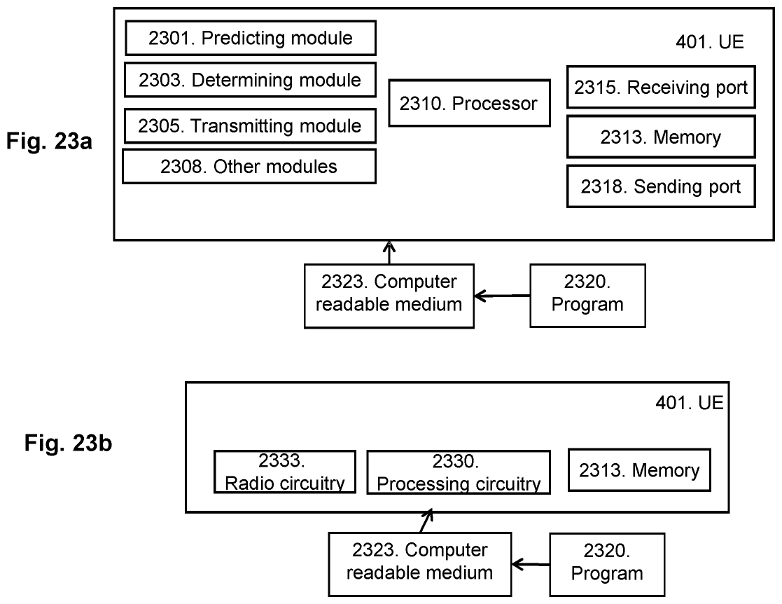

To perform the method steps shown in FIG. 21 for handling mobility information in a communications network the UE 401 may comprise an arrangement as shown in at least one of FIG. 23 FIG. 23b. FIG. 23a and FIG. 23b depict two different examples in panels a) and b), respectively, of the arrangement that the UE 401 may comprise. The UE 401 may comprise the following arrangement depicted in FIG. 23a.

The UE 401 may be adapted to, e.g. by means of a predicting module 2301, predict mobility information related to the UE's 401 predicted mobility in the communications network 400.

The UE 401 may be adapted to, e.g. by means of a determining module 2303, determine whether one or multiple conditions are fulfilled or not for one or multiple cells. At least part of the predicted mobility information is used as input to the one or multiple conditions.

The UE 401 may be adapted to, e.g. by means of a transmitting module 2305, transmit a message to a network node 403 when it has been determined that the one or multiple conditions are fulfilled.

The message comprises at least one of:
the predicted mobility information; and
current mobility information,

The predicted mobility information may be associated with a future time which is ahead of a current time of the current mobility information.

The message may be a measurement report.

The predicted mobility information may be associated with an identity.

At least one of beam measurement predictions and information derived from beam measurement predictions may be further used as input to the one or more conditions.

The one or more conditions may be at least one of: an A1 event, an A2 event, an A3 event, an A4 event, an A5 event and an A6 event, B1 event, B2 event, or any of the other events described herein.

The predicted mobility information may comprise at least one of:
radio related information.
information related to cells the UE 401 may enter to coverage of,
information related to beams where the UE 401 predicts it is going to be covered by, and
information related to a route the UE 401 is going.

The mobility information may be predicted using a prediction model.

At least one input parameter may be used as input to the prediction model. The at least one input parameter may comprise at least one of:
measurements,
UE connection information,
UE mobility history information, and
time information.

The prediction model may be stored in the UE 401 or received from the network node 403.

The prediction model may be selected by the UE 401 from a plurality of candidate prediction models.

The UE 401 may be adapted to, e.g. by means of the transmitting module 2305, transmit, to the network node 403, capability information indicating that the UE 401 is capable of at least one of:
Receiving the prediction model from the network node 403; and
Transmitting the message when one or multiple conditions are fulfilled. The predicted mobility information may be used as input to the one or multiple conditions.

The UE 401 may be configured by the network node 403 to at least one of:
to predict the mobility information, and
to transmit the message.

The present disclosure related to the UE 401 may be implemented through one or more processors, such as a processor 2310 in the UE 401 depicted in FIG. 23a, together with computer program code for performing the functions and actions described herein. A processor, as used herein, may be understood to be a hardware component. The program code mentioned above may also be provided as a computer program product, for instance in the form of a data carrier carrying computer program code for performing the present disclosure when being loaded into the UE 401. One such carrier may be in the form of a CD ROM disc. It is however feasible with other data carriers such as a memory stick. The computer program code may be provided as pure program code on a server and downloaded to the UE 401.

The UE 401 may comprise a memory 2313 comprising one or more memory units. The memory 2313 is arranged to be used to store obtained information, store data, configurations, schedulings, and applications etc. to perform the methods herein when being executed in the UE 401.

The UE 401 may receive information from, e.g. the network node 403, through a receiving port 2315. The receiving port 2315 may be, for example, connected to one or more antennas in UE 401. The UE 401 may receive information from another structure in the communications system 400 through the receiving port 2315. Since the receiving port 2315 may be in communication with the processor 2310, the receiving port 2315 may then send the received information to the processor 2310. The receiving port 2315 may also be configured to receive other information.

The processor 2310 in the UE 401 may be configured to transmit or send information to e.g. network node 403 or another structure in the communications system 400, through a sending port 2318, which may be in communication with the processor 2310, and the memory 2313.

Those skilled in the art will also appreciate that predicting module 2301, the determining module 2303, the transmitting module 2305 and other modules 2308 described above may refer to a combination of analog and digital circuits, and/or one or more processors configured with software and/or firmware, e.g., stored in memory, that, when executed by the one or more processors such as the processor 2310, perform as described above. One or more of these processors, as well as the other digital hardware, may be comprised in a single Application-Specific Integrated Circuit (ASIC), or several processors and various digital hardware may be distributed among several separate components, whether individually packaged or assembled into a System-on-a-Chip (SoC).

The different units 2301-2308 described above may be implemented as one or more applications running on one or more processors such as the processor 2310.

The methods described herein for the UE 401 may be respectively implemented by means of a computer program 2320 product, comprising instructions, i.e., software code portions, which, when executed on at least one processor 2310, cause the at least one processor 2310 to carry out the actions described herein, as performed by the UE 401. The computer program 2320 product may be stored on a computer-readable storage medium 2323. The computer-readable storage medium 2323, having stored thereon the computer program 2320, may comprise instructions which, when executed on at least one processor 2310, cause the at least one processor 2310 to carry out the actions described herein, as performed by the UE 401. The computer-readable storage medium 2323 may be a non-transitory computer-readable storage medium, such as a CD ROM disc, or a memory stick. The computer program 2320 product may be stored on a carrier containing the computer program 2320 just described, wherein the carrier is one of an electronic signal, optical signal, radio signal, or the first computer-readable storage medium 508, as described above.

The UE 401 may comprise a communication interface configured to facilitate communications between the UE 401 and other nodes or devices, e.g., the network node 03, or another structure. The interface may comprise a transceiver configured to transmit and receive radio signals over an air interface in accordance with a suitable standard.

The UE 103 may comprise the following arrangement depicted in FIG. 23b. The UE 401 may comprise a processing circuitry 2330, e.g., one or more processors such as the processor 3210, in the UE 401 and the memory 2313. The UE 401 may also comprise a radio circuitry 2333, which may comprise e.g., the receiving port 2315 and the sending port 2318. The processing circuitry 2330 may be configured to, or operable to, perform the method actions according to FIG. 5, FIG. 6, FIG. 19 and FIG. 21, in a similar manner as that described in relation to FIG. 23a. The radio circuitry 2333 may be configured to set up and maintain at least a wireless connection with the UE 401. Circuitry may be understood herein as a hardware component.

The present disclosure also relate to the UE 401 operative to operate in the communications system 400. The UE 401 may comprise the processing circuitry 2330 and the memory 2313. The memory 2313 comprises instructions executable by said processing circuitry 2330, whereby the UE 401 is operative to perform the actions described herein in relation to the UE 103, e.g. in FIG. 5, FIG. 6, FIG. 19 and FIG. 21.

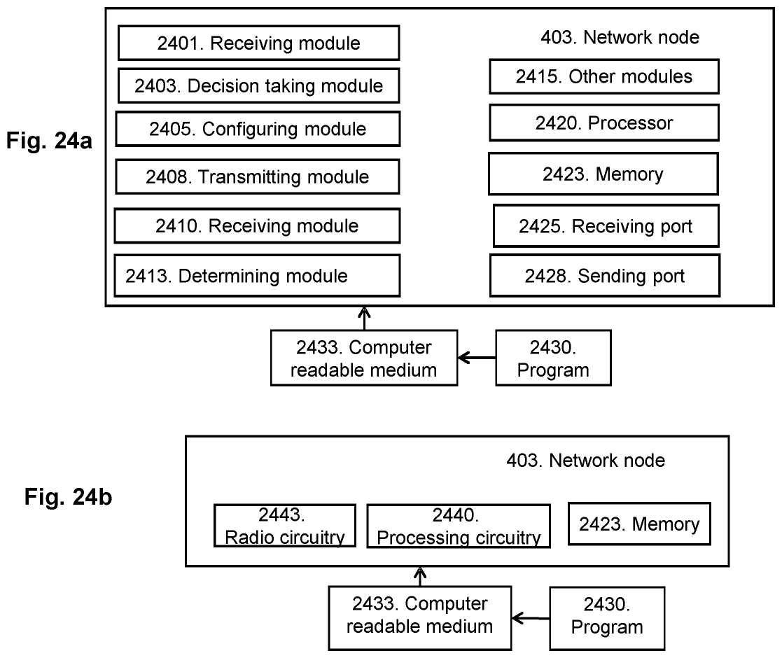

To perform the method steps shown in FIG. 22 for handling mobility information in a communications network the network node 403 may comprise an arrangement as shown in at least one of FIG. 24a FIG. 24b. FIG. 24a and FIG. 24b depict two different examples in panels a) and b), respectively, of the arrangement that the network node 403 may comprise. The network node 403 may comprise the following arrangement depicted in FIG. 24a.

The network node 403 is adapted to, e.g. by means of a receiving module 2401, receive a message from a UE 401.

The network node 403 is adapted to, e.g. by means of a decision taking module 2403, take mobility decisions for the UE 401 based on the message.

The message may comprise at least one of:
predicted mobility information related to the UE's 401 mobility in the communications network 400; and
current mobility information,

The predicted mobility information may be associated with a future time which is ahead of a current time of the current mobility information.

The message may be a measurement report.

The predicted mobility information may be associated with an identity.

The network node 403 may be adapted to, e.g. by means of a configuring module 2405, configure the UE 401 to at least one of:
predict mobility information, and to
transmit the message to network node 403.

The network node 403 may be adapted to, e.g. by means of a transmitting module 2408, transmit information indicating one or multiple prediction models to the UE 401.

The network node 403 may be adapted to, e.g. by means of a receiving module 2410, receive, from the UE 401, capability information indicating that the UE 101 is capable of at least one of:
Receiving the message from the network node 403; and
Transmitting the message when one or multiple conditions are fulfilled. The predicted mobility information may be used as input to the one or multiple conditions.

The network node 403 may be adapted to, e.g. by means of a determining module 2413, determine one or more prediction models from a plurality of candidate prediction models that the UE 401 should be configured with. The determining may be based on at least one of:
the capability information; and
the message received from the UE 401.

The predicted mobility information may comprise at least one of:
radio related information.
information related to cells the UE 401 may enter to coverage of,
information related to beams where the UE 401 predicts it is going to be covered by, and
information related to a route the UE 401 is going.

The present disclosure associated with the network node 403 may be implemented through one or more processors, such as a processor 2420 in the network node 403 depicted in FIG. 24a, together with computer program code for performing the functions and actions described herein. A processor, as used herein, may be understood to be a hardware component. The program code mentioned above may also be provided as a computer program product, for instance in the form of a data carrier carrying computer program code for performing the present disclosure when being loaded into the network node 03. One such carrier may be in the form of a CD ROM disc. It is however feasible with other data carriers such as a memory stick. The computer program code may be provided as pure program code on a server and downloaded to the network node 403.

The network node 403 may comprise a memory 2423 comprising one or more memory units. The memory 2423 is arranged to be used to store obtained information, store data, configurations, schedulings, and applications etc. to perform the methods herein when being executed in the network node 403.

The network node 403 may receive information from, e.g., the UE 401, through a receiving port 2425. The receiving port 2425 may be, for example, connected to one or more antennas in network node 403. The network node 403 may receive information from another structure in the communications system 400 through the receiving port 2425. Since the receiving port 2425 may be in communication with the processor 2420, the receiving port 2425 may then send the received information to the processor 2420. The receiving port 2425 may also be configured to receive other information.

The processor 2420 in the network node 403 may be configured to transmit or send information to e.g., the UE 401, or another structure in the communications system 400, through a sending port 2428, which may be in communication with the processor 2420, and the memory 2423.

The receiving module 2401, the decision taking module 2403, the configuring module 2405, the transmitting module 2408, the receiving module 2410, the determining module 2413 and other modules 2415 described above may refer to a combination of analog and digital circuits, and/or one or more processors configured with software and/or firmware, e.g., stored in memory, that, when executed by the one or more processors such as the processor 2420, perform as described above. One or more of these processors, as well as the other digital hardware, may be comprised in a single Application-Specific Integrated Circuit (ASIC), or several processors and various digital hardware may be distributed among several separate components, whether individually packaged or assembled into a System-on-a-Chip (SoC).

Also, the different units 2401-2415 described above may be implemented as one or more applications running on one or more processors such as the processor 2420.

The methods described herein for the network node 403 may be respectively implemented by means of a computer program 2430 product, comprising instructions, i.e., software code portions, which, when executed on at least one processor 2420, cause the at least one processor 2420 to carry out the actions described herein, as performed by the network node 403. The computer program 2430 product may be stored on a computer-readable storage medium 2433. The computer-readable storage medium 2433, having stored thereon the computer program 2430, may comprise instructions which, when executed on at least one processor 2420, cause the at least one processor 2420 to carry out the actions described herein, as performed by the network node 403. The computer-readable storage medium 2433 may be a non-transitory computer-readable storage medium, such as a CD ROM disc, or a memory stick. The computer program 2430 product may be stored on a carrier containing the computer program 2430 just described, wherein the carrier is one of an electronic signal, optical signal, radio signal, or the second computer-readable storage medium 2433, as described above.

The network node 403 may comprise a communication interface configured to facilitate communications between the network node 403 and other nodes or devices, e.g., the UE 401, or another structure. The interface may, for example, comprise a transceiver configured to transmit and receive radio signals over an air interface in accordance with a suitable standard.

The network node 403 may comprise the following arrangement depicted in FIG. 24b. The network node 403 may comprise a processing circuitry 2440, e.g., one or more processors such as the processor 2420, in the network node 403 and the memory 2423. The network node 403 may also comprise a radio circuitry 2443, which may comprise e.g., the receiving port 2425 and the sending port 2428. The processing circuitry 2440 may be configured to, or operable to, perform the method actions according to FIG. 5, FIG. 6, FIG. 19 and FIG. 22 in a similar manner as that described in relation to FIG. 24a. The radio circuitry 2443 may be configured to set up and maintain at least a wireless connection with the network node 401. Circuitry may be understood herein as a hardware component.

The network node 403 may be operative to operate in the communications system 400. The network node 403 may comprise the processing circuitry 2440 and the memory 2423. The memory 2423 comprises instructions executable by the processing circuitry 2440, whereby the network node 403 is operative to perform the actions described herein in relation to the network node 403, e.g. in FIG. 5, FIG. 6, FIG. 19 and FIG. 22.

### FURTHER EXTENSIONS AND VARIATIONS

A telecommunication network may be connected via an intermediate network to a host computer.

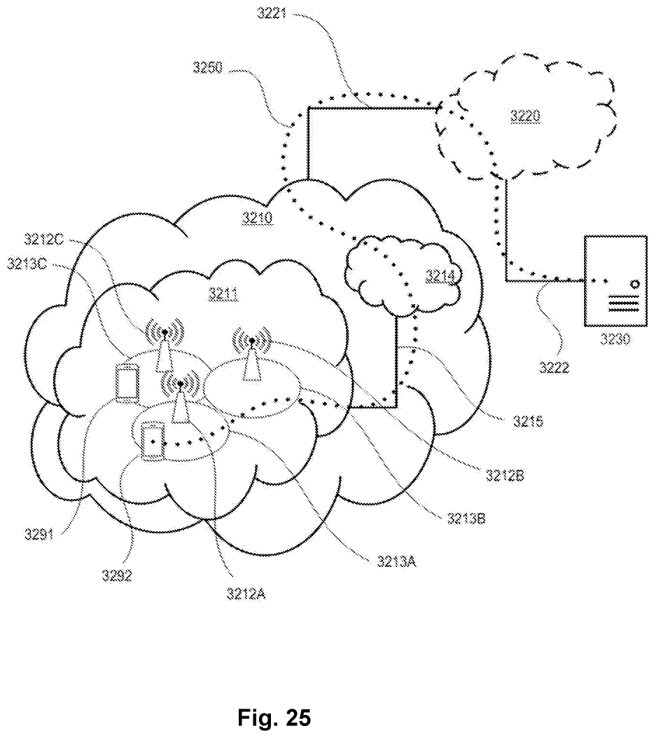

With reference to FIG. 25, a communication system comprises telecommunication network 3210 such as the communications system 400, for example, a 3GPP-type cellular network, which comprises access network 3211, such as a radio access network, and core network 3214. Access network 3211 comprises a plurality of network nodes 403. For example, base stations 3212a, 3212b, 3212c, such as NBs, eNBs, gNBs or other types of wireless access points, each defining a corresponding coverage area 3213a, 3213b, 3213c. Each base station 3212a, 3212b, 3212c is connectable to core network 3214 over a wired or wireless connection 3215. A plurality of user equipments, such as the UE 401 may be comprised in the communications system 100. In FIG. 25, a first UE 3291 located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, it is equally applicable to a situation where a sole UE is in the coverage area or where a sole UE is connecting to the corresponding base station 3212. Any of the UEs 3291, 3292 may be considered examples of the UE 401.

Telecommunication network 3210 is itself connected to host computer 3230, which may be embodied in the hardware and/or software of a standalone server, a cloud-implemented server, a distributed server or as processing resources in a server farm. Host computer 3230 may be under the ownership or control of a service provider, or may be operated by the service provider or on behalf of the service provider. Connections 3221 and 3222 between telecommunication network 3210 and host computer 3230 may extend directly from core network 3214 to host computer 3230 or may go via an optional intermediate network 3220. Intermediate network 3220 may be one of, or a combination of more than one of, a public, private or hosted network; intermediate network 3220, if any, may be a backbone network or the Internet; in particular, intermediate network 3220 may comprise two or more sub-networks (not shown).

The communication system of FIG. 25 as a whole enables connectivity between the connected UEs 3291, 3292 and host computer 3230. The connectivity may be described as an Over-The-Top (OTT) connection 3250. Host computer 3230 and the connected UEs 3291, 3292 are configured to communicate data and/or signaling via OTT connection 3250, using access network 3211, core network 3214, any intermediate network 3220 and possible further infrastructure (not shown) as intermediaries. OTT connection 3250 may be transparent in the sense that the participating communication devices through which OTT connection 3250 passes are unaware of routing of uplink and downlink communications. For example, base station 3212 may not or need not be informed about the past routing of an incoming downlink communication with data originating from host computer 3230 to be forwarded (e.g., handed over) to a connected UE 3291. Similarly, base station 3212 need not be aware of the future routing of an outgoing uplink communication originating from the UE 3291 towards the host computer 3230.

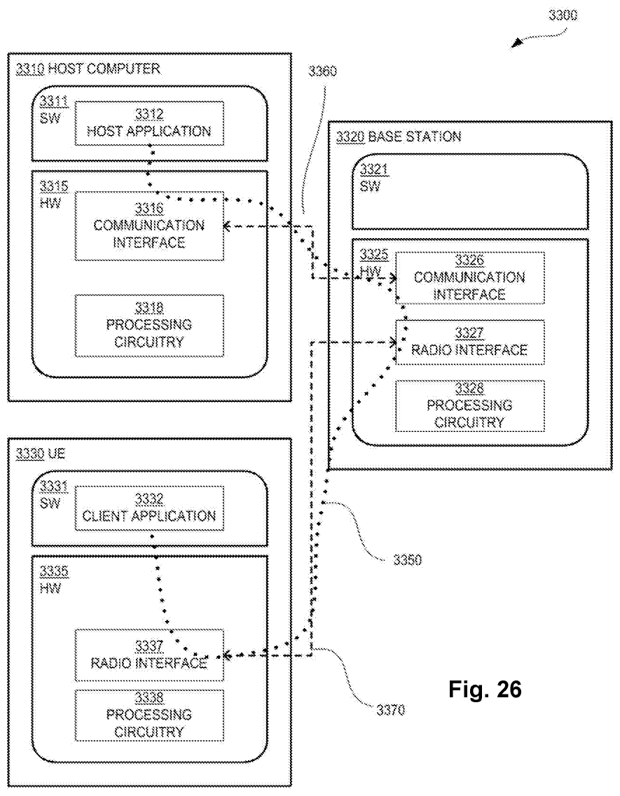

In relation to FIGS. 26-30 which are described next, it may be understood that the base station may be considered an example of the network node 403.

FIG. 26 illustrates an example of host computer communicating via a network node 403 with a UE 401 over a partially wireless connection.

The UE 401 and the network node 403, e.g., a base station and host computer discussed in the preceding paragraphs will now be described with reference to FIG. 26. In communication system 3330, such as the communications system 100, host computer 3310 comprises hardware 3315 comprising communication interface 3316 configured to set up and maintain a wired or wireless connection with an interface of a different communication device of communication system 3300. Host computer 3310 comprises processing circuitry 3318, which may have storage and/or processing capabilities. In particular, processing circuitry 3318 may comprise one or more programmable processors, application-specific integrated circuits, field programmable gate arrays or combinations of these (not shown) adapted to execute instructions. Host computer 3310 comprises software 3311, which is stored in or accessible by host computer 3310 and executable by processing circuitry 3318. Software 3311 comprises host application 3312. Host application 3312 may be operable to provide a service to a remote user, such as UE 3330 connecting via OTT connection 3350 terminating at UE 3330 and host computer 3310. In providing the service to the remote user, host application 3312 may provide user data which is transmitted using OTT connection 3350.

Communication system 3300 comprises the network node 403 exemplified in FIG. 26 as a base station 3320 provided in a telecommunication system and comprising hardware 3325 enabling it to communicate with host computer 3310 and with UE 3330. Hardware 3325 may comprise communication interface 3326 for setting up and maintaining a wired or wireless connection with an interface of a different communication device of communication system 3300, as well as radio interface 3327 for setting up and maintaining at least wireless connection 3370 with the UE 401, exemplified in FIG. 26 as a UE 3330 located in a coverage area served by base station 3320. Communication interface 3326 may be configured to facilitate connection 3360 to host computer 3310. Connection 3360 may be direct or it may pass through a core network (not shown in FIG. 330) of the telecommunication system and/or through one or more intermediate networks outside the telecommunication system. Hardware 3325 of base station 3320 comprises processing circuitry 3328, which may comprise one or more programmable processors, application-specific integrated circuits, field programmable gate arrays or combinations of these (not shown) adapted to execute instructions. Base station 3320 has software 3321 stored internally or accessible via an external connection.

Communication system 3300 comprises UE 3330 already referred to. It's hardware 3335 may comprise radio interface 3337 configured to set up and maintain wireless connection 3370 with a base station serving a coverage area in which UE 3330 is currently located. Hardware 3335 of UE 3330 comprises processing circuitry 3338, which may comprise one or more programmable processors, application-specific integrated circuits, field programmable gate arrays or combinations of these (not shown) adapted to execute instructions. UE 3330 comprises software 3331, which is stored in or accessible by UE 3330 and executable by processing circuitry 3338. Software 3331 comprises client application 3332. Client application 3332 may be operable to provide a service to a human or non-human user via UE 3330, with the support of host computer 3310. In host computer 3310, an executing host application 3312 may communicate with the executing client application 3332 via OTT connection 3350 terminating at UE 3330 and host computer 3310. In providing the service to the user, client application 3332 may receive request data from host application 3312 and provide user data in response to the request data. OTT connection 3350 may transfer both the request data and the user data. Client application 3332 may interact with the user to generate the user data that it provides.

It is noted that host computer 3310, base station 3320 and UE 3330 illustrated in FIG. 330 may be similar or identical to host computer 3230, one of base stations 3212a, 3212b, 3212c and one of UEs 3291, 3292 of FIG. 26, respectively. This is to say, the inner workings of these entities may be as shown in FIG. 330 and independently, the surrounding network topology may be that of FIG. 320.

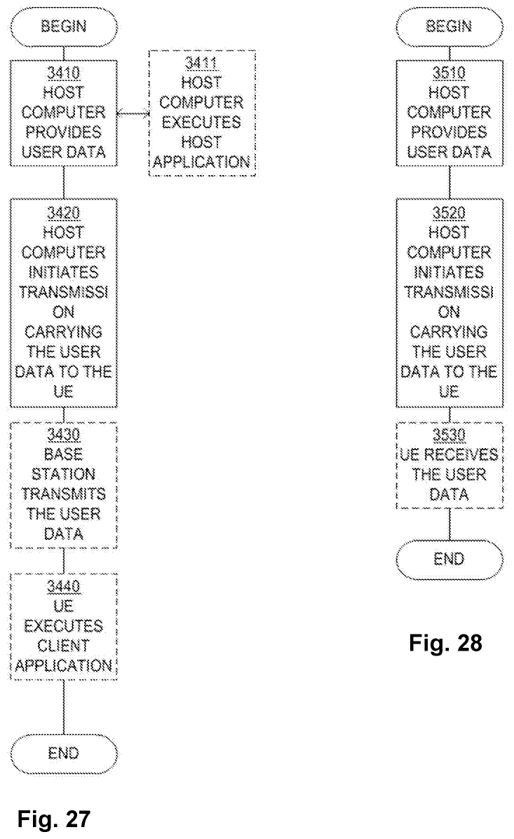

In FIG. 27, OTT connection 3350 has been drawn abstractly to illustrate the communication between host computer 3310 and UE 3330 via base station 3320, without explicit reference to any intermediary devices and the precise routing of messages via these devices. Network infrastructure may determine the routing, which it may be configured to hide from UE 3330 or from the service provider operating host computer 3310, or both. While OTT connection 3350 is active, the network infrastructure may take decisions by which it dynamically changes the routing (e.g., on the basis of load balancing consideration or reconfiguration of the network).

There may be a wireless connection 3370 between UE 3330 and base station 3320. The present disclosure improve the performance of OTT services provided to UE 3330 using OTT connection 3350, in which wireless connection 3370 forms the last segment. The present disclosure may improve the spectrum efficiency, and latency, and thereby provide benefits such as reduced user waiting time, better responsiveness and extended battery lifetime.

A measurement procedure may be provided for the purpose of monitoring data rate, latency and other factors on which the present disclosure improve. There may be an optional network functionality for reconfiguring OTT connection 3350 between host computer 3310 and UE 3330, in response to variations in the measurement results. The measurement procedure and/or the network functionality for reconfiguring OTT connection 3350 may be implemented in software 3311 and hardware 3315 of host computer 3310 or in software 3331 and hardware 3335 of UE 3330, or both. Sensors (not shown) may be deployed in or in association with communication devices through which OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of OTT connection 3350 may comprise message format, retransmission settings, preferred routing etc.; the reconfiguring need not affect base station 3320, and it may be unknown or imperceptible to base station 3320. Such procedures and functionalities may be known and practiced in the art. Measurements may involve proprietary UE signaling facilitating host computer 3310's measurements of throughput, propagation times, latency and the like. The measurements may be implemented in that software 3311 and 3331 causes messages to be transmitted, in particular empty or ‘dummy’ messages, using OTT connection 3350 while it monitors propagation times, errors etc.

FIG. 27 illustrates an example of methods implemented in a communication system comprising a host computer, a base station and a user equipment. FIG. 27 is a flowchart illustrating a method implemented in a communication system. The communication system comprises a host computer, a base station and a UE which may be those described with reference to FIG. 25 and FIG. 26. For simplicity of the present disclosure, only drawing references to FIG. 340 will be comprised in this section. In step 3410, the host computer provides user data. In substep 3411 (which may be optional) of step 3410, the host computer provides the user data by executing a host application. In step 3420, the host computer initiates a transmission carrying the user data to the UE. In step 3430 (which may be optional), the base station transmits to the UE the user data which was carried in the transmission that the host computer initiated. In step 3440 (which may also be optional), the UE executes a client application associated with the host application executed by the host computer.

FIG. 28 illustrates methods implemented in a communication system comprising a host computer, a base station and a UE. FIG. 28 is a flowchart illustrating a method implemented in a communication system. The communication system comprises a host computer, a base station and a UE which may be those described with reference to FIG. 25 and FIG. 26. For simplicity of the present disclosure, only drawing references to FIG. 28 will be comprised in this section. In step 3510 of the method, the host computer provides user data. In an optional substep (not shown) the host computer provides the user data by executing a host application. In step 3520, the host computer initiates a transmission carrying the user data to the UE. The transmission may pass via the base station. In step 3530 (which may be optional), the UE receives the user data carried in the transmission.

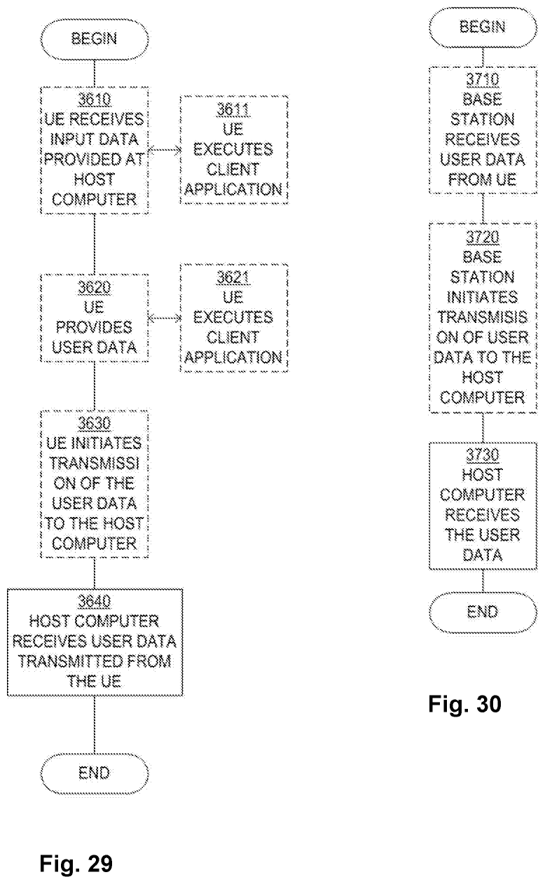

FIG. 29 illustrates methods implemented in a communication system comprising a host computer, a base station and a user equipment. FIG. 29 is a flowchart illustrating a method implemented in a communication system. The communication system comprises a host computer, a first network node 103 and a UE 101 which may be those described with reference to FIG. 25 and FIG. 26. For simplicity of the present disclosure, only drawing references to FIG. 29 will be comprised in this section. In step 3610 (which may be optional), the UE 101 receives input data provided by the host computer. Additionally or alternatively, in step 3620, the UE 101 provides user data. In substep 3621 (which may be optional) of step 3620, the UE provides the user data by executing a client application. In substep 3611 (which may be optional) of step 3610, the UE executes a client application which provides the user data in reaction to the received input data provided by the host computer. In providing the user data, the executed client application may consider user input received from the user. Regardless of the specific manner in which the user data was provided, the UE initiates, in substep 3630 (which may be optional), transmission of the user data to the host computer. In step 3640 of the method, the host computer receives the user data transmitted from the UE.

FIG. 30 illustrates methods implemented in a communication system comprising a host computer, a base station and a user equipment. FIG. 30 is a flowchart illustrating a method implemented in a communication system. The communication system comprises a host computer, a base station and a UE which may be those described with reference to FIG. 25 and FIG. 26. For simplicity of the present disclosure, only drawing references to FIG. 370 will be comprised in this section. In step 3710 (which may be optional), the base station receives user data from the UE. In step 3720 (which may be optional), the base station initiates transmission of the received user data to the host computer. In step 3730 (which may be optional), the host computer receives the user data carried in the transmission initiated by the base station.

The present disclosure may be summarized as follows:

A network node 403 configured to communicate with a UE 401, the network node 403 comprising a radio interface and processing circuitry configured to perform one or more of the actions described herein as performed by the network node 403.

A communication system 400 comprising a host computer comprising:
processing circuitry configured to provide user data; and
a communication interface configured to forward the user data to a cellular network for transmission to a UE 401,
wherein the cellular network comprises a network node 403 having a radio interface and processing circuitry, the base station's processing circuitry configured to perform one or more of the actions described herein as performed by the network node 403.

The communication system may comprise the network node 403.

The communication system may comprise the UE 401, wherein the UE 401 is configured to communicate with the network node 403.

The communication system, wherein:
the processing circuitry of the host computer is configured to execute a host application, thereby providing the user data; and
the UE 401 comprises processing circuitry configured to execute a client application associated with the host application.

A method implemented in a network node 403, comprising one or more of the actions described herein as performed by the network node 403.

A method implemented in a communication system 40 comprising a host computer, a base station and a UE 401, the method comprising:
at the host computer, providing user data; and
at the host computer, initiating a transmission carrying the user data to the UE 401 via a cellular network comprising the first network node 103, wherein the network node 403 performs one or more of the actions described herein as performed by the network node 403.

The method may comprise:
at the network node 403, transmitting the user data.

The user data may be provided at the host computer by executing a host application. The method may comprise:
at the UE 401, executing a client application associated with the host application.

A UE 401 configured to communicate with a network node 403, the UE 401 comprising a radio interface and processing circuitry configured to perform one or more of the actions described herein as performed by the UE 401.

A communication system 400 comprising a host computer comprising:
processing circuitry configured to provide user data; and
a communication interface configured to forward user data to a cellular network for transmission to a UE 401,
wherein the UE comprises a radio interface and processing circuitry, the UE's processing circuitry configured to perform one or more of the actions described herein as performed by the UE 401.

The communication system may comprise the UE 401.

The communication system 400, wherein the cellular network comprises a first network node 103 configured to communicate with the UE 401.

The communication system 400, wherein:
the processing circuitry of the host computer is configured to execute a host application, thereby providing the user data; and
the UE's processing circuitry is configured to execute a client application associated with the host application.

A method implemented in a UE 401, comprising one or more of the actions described herein as performed by the UE 401.

A method implemented in a communication system 400 comprising a host computer, a network node 403 and a UE 401, the method comprising:
at the host computer, providing user data; and
at the host computer, initiating a transmission carrying the user data to the UE 401 via a cellular network comprising the base station, wherein the UE 401 performs one or more of the actions described herein as performed by the UE 401.

The method may comprise:
at the UE 401, receiving the user data from the network node 403.

A UE 401 configured to communicate with a network node 403, the UE 401 comprising a radio interface and processing circuitry configured to perform one or more of the actions described herein as performed by the UE 401.

A communication system 400 comprising a host computer comprising:
a communication interface configured to receive user data originating from a transmission from a UE 401 to a network node 403,
wherein the UE 401 comprises a radio interface and processing circuitry, the UE's processing circuitry configured to: perform one or more of the actions described herein as performed by the UE 401.

The communication system 400 may comprise the UE 401.

The communication system 400 may comprise the network node 403, wherein the network node 403 comprises a radio interface configured to communicate with the UE 401 and a communication interface configured to forward to the host computer the user data carried by a transmission from the UE 401 to the network node 403.

The communication system 400, wherein:
the processing circuitry of the host computer is configured to execute a host application; and
the UE's processing circuitry is configured to execute a client application associated with the host application, thereby providing the user data.

The communication system 400, wherein:
the processing circuitry of the host computer is configured to execute a host application, thereby providing request data; and
the UE's processing circuitry is configured to execute a client application associated with the host application, thereby providing the user data in response to the request data.

A method implemented in a UE 401, comprising one or more of the actions described herein as performed by the UE 401.

The method may comprise:
providing user data; and
forwarding the user data to a host computer via the transmission to the network node 403.

A method implemented in a communication system 400 comprising a host computer, a network node 403 and a UE 401, the method comprising:
at the host computer, receiving user data transmitted to the network node 403 from the UE 401, wherein the UE 401 performs one or more of the actions described herein as performed by the UE 401.

The method may comprise:
at the UE 401, providing the user data to the network node 403.

The method may comprise:
at the UE 401, executing a client application, thereby providing the user data to be transmitted; and
at the host computer, executing a host application associated with the client application.

The method may comprise:
at the UE 401, executing a client application; and
at the UE 401, receiving input data to the client application, the input data being provided at the host computer by executing a host application associated with the client application,
wherein the user data to be transmitted is provided by the client application in response to the input data.

A network node 403 configured to communicate with a UE 401, the network node 403 comprising a radio interface and processing circuitry configured to perform one or more of the actions described herein as performed by the network node 403.

A communication system 400 comprising a host computer comprising a communication interface configured to receive user data originating from a transmission from a UE 401 to a network node 403, wherein the network node 403 comprises a radio interface and processing circuitry, the network node's processing circuitry configured to perform one or more of the actions described herein as performed by the network node 403.

The communication system 400 may comprise the network node 403.

The communication system 400 may comprise the UE 401, wherein the UE 401 is configured to communicate with the network node 403.

The communication system 400 wherein:
the processing circuitry of the host computer is configured to execute a host application;
the UE 401 is configured to execute a client application associated with the host application, thereby providing the user data to be received by the host computer.

A method implemented in a network node 403, comprising one or more of the actions described herein as performed by any of the network node 403.

A method implemented in a communication system comprising a host computer, a network node 403 and a UE 401, the method comprising:
at the host computer, receiving, from the network node 403, user data originating from a transmission which the network node 403 has received from the UE 401,
wherein the UE 401 performs one or more of the actions described herein as performed by the UE 401.

The method may comprise:
at the network node 403, receiving the user data from the UE 401.

The method may comprise:
at the network node 403, initiating a transmission of the received user data to the host computer.

The present disclosure relates to prediction at the UE side of mobility information such as radio conditions of serving and/or neighbour cells (in serving and/or neighbour frequencies), list of cells and/or beams the UE 401 is moving to, and the usage of these predictions as input to one or multiple condition(s) for transmission of a message to the network node 403.

The terms “measurement” or “real/current measurement” is used herein to refer to a radio measurement, such as RRC measurements that may be configured by the network node 403 for the UE 401 in connected state. These measurements may also be called Radio Resource Management (RRM) measurements, since they assist Radio Resource Management decisions taken by the network node 403 and/or L3 measurements, since they are responsibility of the RRC protocol, also called Layer 3 in the Control Plane RAN protocol stack. Having NR as an example, these measurements to be performed by the UE 401 and reported may be one or more the following:
NR measurements;
Inter-RAT measurements of E-UTRA frequencies.

These measurements may be based on different reference signals. In the case of SS/PBCH block(s), these measurements or measurement information may be one or more of the following:
Measurement results per SS/PBCH block;
Measurement results per cell based on SS/PBCH block(s);
SS/PBCH block(s) indexes.

In the case of CSI-RS, these measurements or measurement information may be one or more of the following:
Measurement results per CSI-RS resource;
Measurement results per cell based on CSI-RS resource(s);
CSI-RS resource measurement identifiers.

Each of these measurements may be associated to a measurement quantity, such as RSRP, RSRQ or SINR. For example, the current measurement, also referred to as a real measurement, may be described as the cell level or beam level RSRP based on RS type SSB, for an NR carrier frequency in the NR RAT. Hence, the term “measurement prediction” may be used to refer to a prediction of a radio measurement as one of the measurements described above as a real/current measurement. In other words, the present disclosure refers to a prediction of NR or inter-RAT measurements, prediction of measurement results per RS type, i.e. SS/PBCH block or CSI-RS, prediction of cell measurement or beam measurements, e.g. cell level RSRP, cell level RSRQ, cell level SINR, beam level RSRP, beam level RSRQ, beam level SINR.

These current measurements may be used as input to predictions models so the UE 401 is able to predict mobility information such as radio quality related parameters such as RSRP, RSRQ, SINR in a given frequency in different levels of granularities such as per cell, per beam, per reference signal (RS) type like SSB and/or CSI-RS, list of cells and/or list of beams and/or list of reference signal (RS) type coverage, like SSB identifier coverage or CSI-RS identifier coverage, the UE 401 is moving to, etc.

Even if some parts of the present disclosure is described using NR as an example, the present disclosure is equally applicable to R any system, e.g., in the 6G context, where Artificial Intelligence (AI)/Machine Learning is envisioned to play a more impactful role when it comes to the design of protocols.

All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step.

In general, the usage of “first”, “second”, “third”, “fourth”, and/or “fifth” herein may be understood to be an arbitrary way to denote different elements or entities, and may be understood to not confer a cumulative or chronological character to the nouns they modify, unless otherwise noted, based on context.

The present disclosure is not limited to the above. Various alternatives, modifications and equivalents may be used. Therefore, disclosure herein should not be taken as limiting the scope. A feature may be combined with one or more other features.

The term “at least one of A and B” should be understood to mean “only A, only B, or both A and B.”, where A and B are any parameter, number, indication used herein etc.

The term “comprises/comprising” when used in this specification is taken to specify the presence of stated features, integers, steps or components, but does not preclude the presence or addition of one or more other features, integers, steps, components or groups thereof. It should also be noted that the words “a” or “an” preceding an element do not exclude the presence of a plurality of such elements.

The term “configured to” used herein may also be referred to as “arranged to”, “adapted to”, “capable of” or “operative to”.

1. A method performed by a User Equipment, UE, for handling mobility information in a communications network, the method comprising:
predicting mobility information related to the UE's predicted mobility in the communications network;
determining whether one or multiple conditions are fulfilled for one or multiple cells, wherein at least part of the predicted mobility information being used as input to the one or multiple conditions; and
transmitting a message to a network node when it has been determined that the one or multiple conditions are fulfilled.

2. The method according to claim 1, wherein the message comprises at least one of:
the predicted mobility information; and
current mobility information.

3. The method according to claim 1, wherein the message is a measurement report.

4. The method according to claim 1, wherein the predicted mobility information is associated with an identity comprised in the message.

5. The method according to claim 1, wherein at least one of beam measurement predictions and information derived from beam measurement predictions are further used as input to the one or more conditions.

6. The method according to claim 1, wherein the one or more conditions is configured as an event in a reporting configuration, and wherein the event is at least one of: an A1 event, an A2 event, an A3 event, an A4 event, an A5 event and an A6 event, B1 event, B2 event.

7. The method according to claim 1, wherein the predicted mobility information comprises at least one of:
radio related information;
information related to cells the UE may enter to coverage of;
location information;
positioning;
information related to beams where the UE predicts it is going to be covered by; and
information related to a route the UE is going.

8. The method according to claim 1, wherein the mobility information is predicted using a prediction model.

9. The method according to claim 8, wherein at least one input parameter is used as input to the prediction model, and wherein the at least one input parameter comprises at least one of:
measurements;
UE connection information;
UE mobility history information; and
time information.

10. The method according to claim 8, wherein the prediction model is stored in the UE or received from the network node.

11. The method according to claim 8, wherein the prediction model is selected by the UE from a plurality of candidate prediction models.

12. The method according to claim 8, comprising:
transmitting, to the network node, capability information indicating that the UE is capable of at least one of:
receiving the prediction model from the network node; and
transmitting the message when one or multiple conditions are fulfilled, wherein the predicted mobility information is used as input to the one or multiple conditions.

13. The method according to claim 1, wherein the UE is configured by the network node to at least one of:
to predict the mobility information, and
to transmit the message.

14. A method performed by a network node for handling mobility information in a communications network, the method comprising:
receiving a message from a User Equipment, UE; and
taking mobility decisions for the UE based on the message.

15. The method according to claim 14, wherein the message comprises at least one of:
predicted mobility information related to the UE's mobility in the communications network; and
current mobility information.

16. The method according to claim 14, wherein the message is a measurement report.

17. The method according to claim 15, wherein the predicted mobility information is associated with an identity comprised in the message.

18. The method according to claim 14, comprising:
configuring the UE to at least one of:
predict mobility information; and
transmit the message to network node.

19. The method according to claim 14, comprising:
transmitting information indicating one or multiple prediction models to the UE.

20.-22. (canceled)

23. A User Equipment, UE, for handling mobility information in a communications network, the UE being configured to:
predict mobility information related to the UE's predicted mobility in the communications network;
determine whether one or multiple conditions are fulfilled for one or multiple cells, at least part of the predicted mobility information being used as input to the one or multiple conditions; and
transmit a message to a network node when it has been determined that the one or multiple conditions are fulfilled.

24.-46. (canceled)
